(19) United States
(12) Patent Application Publication
(10) Pub. No.: US 2005/0090397 A1
(43) Pub. Date: Apr. 28, 2005

(54) Herbicides made from substituted aryl ketones

(76) Inventors: Dieter Feucht, Monheim (DE); Peter Dahmen, Neuss (DE); Mark Wilhelm Drewes, Langenfeld (DE); Rolf Pontzen, Leichlingen (DE); Dorothee Hoischen, Dusseldorf (DE); Klaus-Helmut Muller, Dusseldorf (DE); Hans-Georg Schwarz, Langenfeld (DE); Stefan Herrmann, Langenfeld (DE); Kristian Kather, Langenfeld (DE); Otto Schallner, Monheim (DE); Toshio Goto, Tochigi (JP); Shinichi Shirakura, Tochigi (JP)

Correspondence Address: BAYER CROPSCIENCE LP;Patent Department, 100 BAYER ROAD, PITTSBURGH, PA, 15205-9741, US

(21) Appl. No.: 10/488,029

(22) PCT Filed: Aug. 19, 2002
(86) PCT No.: PCT/EP02/09236

(30) Foreign Application Priority Data
Aug. 30, 2001 (DE) 10142334.9

(51) Int. Cl. A01N 37/18

(52) U.S. Cl. 504/149

(57) ABSTRACT

The application relates to compositions having
a) at least one of the compounds of the formula (I) 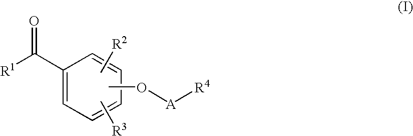
in which A, R¹, R², R³ and R⁴ have the meaning given in the disclosure and b) known herbicides, as stated in the disclosure, and/or c) known safeners, as stated in the disclosure, and to their use for controlling undesirable vegetation.

The invention relates to novel herbicidal active compound combinations comprising, firstly, known substituted aryl ketones and, secondly, one or more herbicidally active compounds and/or a compound which improves crop plant compatibility, which compositions can be used with particularly good results for controlling weeds and various crops of useful plants or else for controlling monocotyledonous or dicotyledonous weeds in the semi- and nonselective field.

Substituted aryl ketones are known as herbicidally active compounds (cf. EP-A-625505, JP-A-11292849, U.S. Pat. Nos. 4,780,127, 5,658,858, 5,804,532, WO-95/16678, WO-00/21924), and/or they are the subject of earlier, not prior published applications (cf. DE-A-10122445 dated 9. May 2001, DE-A-10123887 dated 16. May 2001, DE-A-10124578 dated 21. May 2001, DE-A-10125432 dated 25. May 2001). However, the activity of these compounds is not always entirely satisfactory.

Active compound combinations based on substituted aryl ketones are likewise known (cf. WO-00/25584, WO-00/74488, WO-01/17350, WO-01/28341). However, the properties of these active compound combinations are likewise not entirely satisfactory.

Surprisingly, it has now been found that a number of active compounds from the group of the substituted aryl ketones, when used together with certain herbicidally active compounds, show synergistic effects with respect to the activity against weeds and/or, when applied together with certain compounds which improve crop plant compatibility, can be used particularly advantageously as broadly active combination preparations for the selective control of monocotyledonous and dicotyledonous weeds in crops of useful plants, such as, for example, in cotton, barley, potatoes, maize, rice, soybeans, sunflowers, wheat and sugar cane, but also for controlling monocotyledonous and dicotyledonous weeds in the semi- and nonselective field.

The invention provides herbicidal compositions, characterized by an effective amount of an active compound combination comprising
(a) at least one substituted aryl ketone of the formula (I) 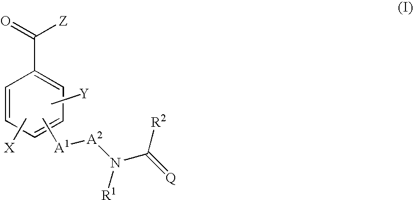
   in which
A¹ represents a single bond or represents O (oxygen),
A² represents a single bond or represents alkanediyl (aokylene), alkenediyl or alkinediyl,
Q represents O (oxygen) or S (sulphur),
R¹ represents hydrogen or represents in each case optionally substituted alkyl, akylthio, alkylsulphinyl, alkylsulphonyl, alkenyl, alkinyl, cycloalkyl, cycloalkylalkyl, aryl or arylalkyl, or represents the grouping —C(Q)-R²,
R² represents hydrogen, amino, cyanoamino, nitroamino, hydroxyamino, hydrazino, or represents in each case optionally substituted alkyl, alkylcarbonyl, alkoxy, alkoxycarbonyl, alkylthio, alkylamino, dialkylamino, alkoxyamino, N-alkyl-alkoxyamino, alkylhydrazino, dialkylhydrazino, alkenyl, alkenyloxy, alkenylamino, alkenyloxyamino, alkinyl, alkinyloxy, alkinylamino, cycloalkyl, cycloalkyloxy, cycloalkylamino, cycloalkylalkyl, cycloalkylalkoxy, cycloalkyl-alkylamino, aryl, arylcarbonyl, aryloxy, aryloxycarbonyl, arylthio, arylamino, arylhydrazino, arylalkyl, arylalkoxy, arylalkylthio, arylalkylamino, heterocyclyl, heterocyclyloxy, heterocyclylthio, heterocyclylamino, heterocyclylalkyl, heterocyclylalkoxy, heterocyclylalkylthio or heterocyclylalkylamino,
X represents hydrogen, nitro, cyano, carboxy, carbamoyl, thiocarbamoyl, halogen, or represents in each case optionally substituted alkyl, alkoxy, alkylthio, alkylsulphinyl, alkylsulphonyl, alkylamino, dialkylamino or dialkylaminosulphonyl,
Y represents hydrogen, nitro, cyano, carboxy, carbamoyl, thiocarbamoyl, halogen, or represents in each case optionally substituted alkyl, alkoxy, alkylthio, alkylsulphinyl, alkylsulphonyl, alkylamino, dialkylamino or dialkylaminosulphonyl, and
Z represents one of the groupings below 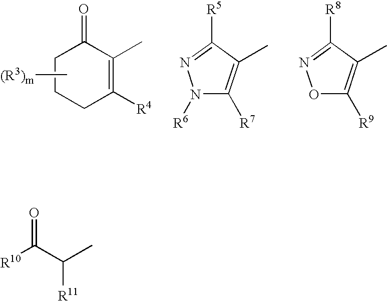
   where
m represents the numbers 0 to 6,
R³ represents hydrogen, halogen or represents in each case optionally substituted alkyl, alkylthio or aryl, or —if m represents 2—optionally also together with a second radical R³ represents oxygen or alkanediyl (alkylene),
R⁴ represents hydroxyl, formyloxy, halogen, or represents in each case optionally substituted alkoxy, alkylthio, alkylsulphinyl, alkylsulphonyl, alkylcarbonyloxy, alkoxycarbonyloxy, alkylaminocarbonyloxy, alkylsulphonyloxy, alkenyloxy, alkinyloxy, aryloxy, arylthio, arylsulphinyl, arylsulphonyl, arylcarbonyloxy, arylcarbonylalkoxy, arylsulphonyloxy, arylalkoxy, arylalkylthio, arylalkylsulphinyl or arylalkylsulphonyl,
R⁵ represents hydrogen, cyano, carbamoyl, thiocarbamoyl, halogen, or represents in each case optionally substituted alkyl, alkoxy, alkylthio, alkylsulphinyl, alkylsulphonyl, alkoxycarbonyl or cycloalkyl,
R⁶ represents hydrogen or represents in each case optionally substituted alkyl, alkenyl, alkinyl, cycloalkyl, cycloalkylalkyl, aryl or arylalkyl,
R⁷ represents hydroxyl, formyloxy, or represents in each case optionally substituted alkoxy, alkylcarbonyloxy, alkoxycarbonyloxy, alkylaminocarbonyloxy, alkylsulphonyloxy, alkenyloxy, alkinyloxy, arylalkoxy, arylcarbonyloxy, arylcarbonylalkoxy or arylsulphonyloxy,
R⁸ represents hydrogen, cyano, carbamoyl, thiocarbamoyl, halogen, or represents in each case optionally substituted alkyl, alkylcarbonyl, alkoxy, alkoxycarbonyl, alkylthio, alkylsulphinyl or alkylsulphonyl,
R⁹ represents hydrogen or represents in each case optionally substituted alkyl or cycloalkyl,
R¹⁰ represents hydrogen or represents in each case optionally substituted alkyl or cycloalkyl, and
R¹¹ represents hydrogen, cyano, carbamoyl, halogen, or represents in each case optionally substituted alkyl, alkoxy, alkoxycarbonyl, alkylthio, alkylsulphinyl or alkylsulphonyl,
including all possible tautomeric forms of the compounds of the general formula (I) and the possible salts or acid or base adducts of the compounds of the general formula (I)
   (“active compounds of group 1”)
   and
(b) one or more compounds from a second group of herbicides comprising the active compounds listed below
4-(2-chloro-phenyl)-N-cyclohexyl-N-ethyl-4,5-dihydro-5-oxo-1H-tetrazol-1-carboxamide (fentrazamide), N-(4-fluoro-phenyl)-N-i-propyl-2-(5-trifluoromethyl-1,3,4-thiadiazol-2-yl-oxy)-acetamide (flufenacet), 2-[2-(3-chloro-phenyl)-oxiranyl-methyl]-2-ethyl-1H-indene-1,3 (2H)-dione (indanofan), 2-chloro-N-(ethoxymethyl)-N-(2-ethyl-6-methyl-phenyl)-acetamide (acetochlor), 5-(2-chloro-4-trifluoromethyl-phenoxy)-2-nitro-benzoic acid sodium salt (acifluorfen-sodium), 2-chloro-6-nitro-3-phenoxy-benzeneamine (aclonifen), 2-chloro-N-(methoxymethyl)-N-(2,6-diethyl-phenyl)-acetamide (alachlor), N-ethyl-N′-i-propyl-6-methylthio-1,3,5-triazine-2,4-diamine (ametryn), 4-amino-N-(1,1-dimethyl-ethyl)-4,5-dihydro-3-(1-methyl-ethyl)-5-oxo-1H-1,2,4-triazole-1-carboxamide. (amicarbazone), N-(4,6-dimethoxy-pyrimidin-2-yl)-N′-(N-methyl-N-methylsulphonyl-sulphamoyl)-urea (amido-sulfuron), 1H-1,2,4-triazol-3-amine (amitrole), S-[2-[(4-chloro-phenyl)-(1-isopropyl)-amino]-2-oxo-ethyl] O,O-dimethyl phosphorodithioate (anilofos), 6-chloro-4-ethylamino-2-isopropylamino-1,3,5-triazine (atrazine), 2-[2,4-dichloro-5-(2-propinyloxy)-phenyl]-5,6,7,8-tetrahydro-1,2,4-triazolo-[4,3-a]-pyridin-3(2H)-one (azafenidin), N-(4,6-dimethoxy-pyrimidin-2-yl)-N′-[1-methyl-4-(2-methyl-2H-tetrazol-5-yl)-1H-pyrazol-5-ylsulphonyl]-urea (azimsulfuron), N-benzyl-2-(4-fluoro-3-trifluoromethyl-phenoxy)-butanamide (beflubutamid), 4-chloro-2-oxo-3(2H)-benzothiazoleacetic acid (benazolin), N-butyl-N-ethyl-2,6-dinitro-4-trifluoromethyl-benzeneamine (benfluralin), 2,3-dihydro-3,3-dimethyl-5-benzofuranyl-ethanesulphonate (benfuresate), N-(4,6-dimethoxy-pyrimidin-2-yl)-N′-(2-methoxycarbonyl-phenylmethylsulphonyl)-urea (bensulfuron-methyl), S-[(4-chloro-phenyl)-methyl] diethylthiocarbamate (benthiocarb, thiobencarb), methyl 2-[2-[4-(3,6-dihydro-3-methyl-2,6-dioxo-4-trifluoromethyl-1(2H)-pyrimidinylphenoxy-methyl]-5-ethyl-phenoxy-propanoate (benzfendizone), 3-(2-chloro-4-methyl-sulphonyl-benzoyl)-4-phenylthio-bicyclo-[3.2.1]-oct-3-en-2-one (benzobicyclon), 2-[[4-(2,4-dichloro-3-methyl-benzoyl)-1,3-dimethyl-1H-pyrazol-5-yl]-oxy]-1-(4-methyl-phenyl)-ethanone (benzofenap), ethyl N-benzoyl-N-(3,4-dichloro-phenyl)-DL-alaninate (benzoylprop-ethyl), 3-i-propyl-1H-2,1,3-benzothiadiazin-4(3H)-one (bentazon), methyl 5-(2,4-dichloro-phenoxy)-2-nitro-benzoate (bifenox), 2,6-bis-(4,6-dimethoxy-pyrimidin-2-yl-oxy)-benzoic acid sodium salt (bispyribac-sodium), 5-bromo-6-methyl-3-(1-methyl-propyl)-2,4(1H,3H)pyrimidinedione (bromacil), 2-bromo-3,3-dimethyl-N-(1-methyl-1-phenyl-ethyl)-butanamide (bromobutide), 3,5-dibromo-4-hydroxy-benzaldehyde O-(2,4-dinitro-phenyl)-oxime (bromo-fenoxim), 3,5-dibromo-4-hydroxy-benzonitrile (bromoxynil), N-butoxymethyl-2-chloro-N-(2,6-diethyl-phenyl)-acetamide (butachlor), [1,1-dimethyl-2-oxo-2-(2-propenyloxy)]-ethyl 2-chloro-5-(3,6-dihydro-3-methyl-2,6-dioxo-4-trifluoro-methyl-1(2H)-pyrimidinyl)-benzoate (butafenacil-allyl), O-ethyl O-(5-methyl-2-nitrophenyl) N-s-butylphosphoramidothioate (butamifos), (Z)-2-chloro-N-[(2-butenyloxy)-methyl]-N-(2,6-diethyl-phenyl)-acetamide (butenachlor), 2-(1-ethoximino-propyl)-3-hydroxy-5-[2,4,6-trimethyl-3-(1-oxo-butyl)-phenyl]-2-cyclohexen-1-one (butroxydim), S-ethyl-bis-(2-methyl-propyl)-thiocarbamate (butylate), N,N-diethyl-3-(2,4,6-trimethyl-phenylsulphonyl)-1H-1,2,4-triazole-1-carboxamide (cafenstrole), 2-[1-[(3-chloro-2-propenyl)-oxy-imino]-propyl]-3-hydroxy-5-(tetrahydro-2H-pyran-4-yl)-2-cyclohexen-1-one (caloxydim, tepraloxydim), 2-(4-chloro-2-fluoro-5-(2-chloro-2-ethoxycarbonyl-ethyl)-phenyl)-4-difluoromethyl-5-methyl-2,4-dihydro-3H-1,2,4-triazol-3-one (carfentrazone-ethyl), 2,4-dichloro-1-(3-methoxy-4-nitro-phenoxy)-benzene (chlomethoxyfen), 3-amino-2,5-dichloro-benzoic acid (chloramben), N-(4-chloro-6-methoxy-pyrimidin-2-yl)-N′-(2-ethoxycarbonyl-phenylsulphonyl)-urea (chlorimuron-ethyl), 1,3,5-trichloro-2-(4-nitro-phenoxy)-benzene (chlornitrofen), N-(4-methoxy-6-methyl-1,3,5-triazin-2-yl)-N′-(2-chloro-phenylsulphonyl)-urea (chlorsulfuron), N′-(3-chloro-4-methyl-phenyl)-N,N-dimethyl-urea (chlortoluron), ethyl 2-chloro-3-[2-chloro-5-(1,3,4,5,6,7-hexahydro-1,3-dioxo-2H-isoindol-2-yl)-phenyl]-2-propanoate (cinidon-ethyl), exo-1-methyl-4-isopropyl-2-(2-methyl-phenyl-methoxy)-7-oxabicyclo-[2.2.1]-heptane (cinmethylin), N-(4,6-dimethoxy-1,3,5-triazin-2-yl)-N′-(2-(2-methoxy-ethoxy)-phenylsulphonyl)-urea (cinosulfuron), 2-[1-[2-(4-chloro-phenoxy)-propoxyaminobutyl]-5-(tetrahydro-2H-thiopyran-3-yl)-1,3-cyclohexanedione (clefoxydim), (E,E)-(+)-2-[1-[[(3-chloro-2-propenyl)-oxy]-imino]-propyl]-3-hydroxy-2-cyclohexen-1-one (clethodim), (R)-(2-propinyl) 2-[4-(5-chloro-3-fluoro-pyridin-2-yl-oxy)-phenoxy-propanoate (clodinafop-propargyl), 2-[(2-chloro-phenyl)-methyl]-4,4-dimethyl-3-isoxazolidinone (clomazone), 2-(2,4-dichloro-3-methyl-phenoxy)-N-phenyl-propanamide (clomeprop), 3,6-dichloro-pyridine-2-carboxylic acid (clopyralid), methyl 3-chloro-2-[(5-ethoxy-7-fluoro[1,2,4]triazolo[1,5-c]pyrimidin-2-yl-sulphonyl)-amino]-benzoate (cloransulam-methyl), N-[(2-chloro-phenyl)-methyl]-N′-(1-methyl-1-phenyl-ethyl)-urea (cumyluron), 2-chloro-4-ethylamino-6-( 1-cyano-1-methyl-ethylamino)-1,3,5-triazine (cyanazine), N-(4,6-dimethoxy-pyrimidin-2-yl)-N′-(2-cyclopropylcarbonyl-phenylsulphonyl)-urea (cyclosulfamuron), 2-(1-ethoximinobutyl)-3-hydroxy-5-(tetrahydro-2H-thiopyran-3-yl)-2-cyclohexen-1-one (cycloxydim), (R)-2-butyl [4-(4-cyano-2-fluoro-phenoxy)-phenoxy]-propanoate (cyhalofop-butyl), 2,4-dichloro-phenoxyacetic acid (2,4-D), 3,6-dichloro-2-methoxy-benzoic acid (dicamba), (R)-2-(2,4-dichloro-phenoxy)-propanoic acid (dichlorprop-P), methyl 2-[4-(2,4-dichloro-phenoxy)-phenoxy]-propanoate (diclofop-methyl), N-(2,6-dichloro-phenyl)-5-ethoxy-7-fluoro-[1,2,4]-triazolo-[1,5-c]-pyrimidine-2-sulphonamide (diclosulam), ethyl N-(chloroacetyl)-N-2,6-(diethylphenyl)-glycinate (diethatyl-ethyl), 1,2-dimethyl-3,5-diphenyl-1H-pyrazolium methylsulphate (difenzoquat), N-(2,4-difluoro-phenyl)-2-(3-trifluoromethyl-phenoxy)-pyridine-3-carboxamide (diflufenican), 2-[1-[(3,5-difluoro-phenyl)-amino-carbonyl-hydrazono]-ethyl]-pyridine-3-carboxylic acid (diflufenzopyr), S-(1-methyl-1-phenyl-ethyl)-1-piperidine carbothioate (dimepiperate), 2-chloro-N-(2,6-dimethyl-phenyl)-N-(2-methoxy-ethyl)-acetamide (dimethachl or), N-(1,2-dimethyl-propyl)-N′-ethyl-6-methylthio-1,3,5-triazine-2,4-diamine (dimethametryn), (S—) 2-chloro-N-(2,4-dimethyl-3-thienyl)-N-(2-methoxy-1-methyl-ethyl)-acetamide (S—) (dimethenamid), 2-amino-4-(1-fluoro-1-methyl-ethyl)-6-(1-methyl-2-(3,5-dimethyl-phenoxy)-ethylamino)-1,3,5-triazine (dimexyflam), N3,N3-diethyl-2,4-dinitro-6-trifluoromethyl-1,3-diamino-benzene (dinitramine), 6,7-dihydro-dipyrido[1,2-a:2′,1′-c]pyrazinediium (diquat), S,S-dimethyl-2-difluoromethyl-4-i-butyl-6-trifluoromethyl-pyridine-3,5-dicarbothioate (dithiopyr), N′-(3,4-dichloro-phenyl)-N,N-dimethyl-urea (diuron), N-(4-methyl-phenyl)-N′-(1-methyl-1-phenyl-ethyl)-urea (dymron, daimuron, dimuron), S-ethyl dipropylthiocarbamate (EPTC), S-(phenylmethyl)-N-ethyl-N-(1,2-dimethyl-propyl)-thiocarbamate (esprocarb), N-ethyl-N-(2-methyl-2-propenyl)-2,6-dinitro-4-trifluoromethyl-benzeneamine (ethalfluralin), (S)-(2-ethoxy-1-methyl-2-oxoethyl) 2-chloro-5-(2-chloro-4-trifluoromethyl-phenoxy)-benzoate (ethoxyfen), N-(4,6-dimethoxy-pyrimidin-2-yl)-N′-(2-ethoxy-phenoxysulphonyl)-urea (ethoxysulfuron), N-(2,3-dichloro-phenyl)-4-ethoxymethoxy-benzamide (etobenzanid), (R)-ethyl-2-[4-(6-chloro-benzoxazol-2-yl-oxy)-phenoxy]-propanoate (fenoxaprop-(P)-ethyl), isopropyl N-benzoyl-N-(3-chloro4-fluro-phenyl)-DL-alaninate (flamprop-isopropyl), isopropyl N-benzoyl-N-(3-chloro-4-fluro-phenyl)-L-alaninate (flamprop-isopropyl-L), methyl N-benzoyl-N-(3-chloro-4-fluoro-phenoxy)-DL-alaninate (flamprop-methyl), N-(2,6-difluoro-phenyl)-8-fluoro-5-methoxy-[1,2,4]-triazolo-[1,5-c]-pyrimidine-2-sulphonamide (florasulam), butyl (R)-2-[4-(5-trifluoromethyl-pyridin-2-yl-oxy)-phenoxy]-propanoate (fluazifop, -butyl, —P-butyl), i-propyl 5-(4-bromo-1-methyl-5-trifluoromethyl-1H-pyrazol-3-yl)-2-chloro-4-fluoro-benzoate (fluazolate), 4,5-dihydro-3-methoxy-4-methyl-5-oxo-N-[(2-trifluoromethoxy-phenyl)-sulphonyl]-1-H-1,2,4-triazole-1-carboxamide sodium salt (flucarbazone-sodium), ethyl [2-chloro-4-fluoro-5-(5-methyl-6-oxo-4-trifluoromethyl-1(6H)-pyriazinyl)-phenoxy]-acetate (flufenpyr), N-(2,6-difluoro-phenyl)-5-methyl-1,2,4-triazolo[1,5-a]-pyrimidine-2-sulphonamide (flumetsulam), pentyl [2-chloro-4-fluoro-5-(1,3,4,5,6,7-hexahydro-1,3-dioxo-2H-isoindol-2-yl)-phenoxy]-acetate (flumiclorac-pentyl), 2-[7-fluoro-3,4-dihydro-3-oxo4-(2-propinyl)-2H-1,4-benzoxazin-6-yl]-4,5,6,7-tetrahydro-1H-isoindole-1,3-dione (flumioxazin), 2-[4-chloro-2-fluoro-5-[(1-methyl-2-propinyl)-oxy]-phenyl]-4,5,6,7-tetrahydro-1H-isoindole-1,3(2H)-dione (flumipropyn), 3-chloro-4-chloromethyl-1-(3-trifluoromethyl-phenyl)-2-pyrrolidinone (fluorochloridone), ethoxycarbonylmethyl 5-(2-chloro-4-trifluoromethyl-phenoxy)-2-nitro-benzoate (fluoroglycofen-ethyl), 1-(4-chloro-3-(2,2,3,3,3-pentafluoro-propoxymethyl)-phenyl)-5-phenyl-1H-1,2,4-triazol-3-carboxamide (flupoxam), 1-isopropyl-2-chloro-5-(3,6-dihydro-3-methyl-2,6-dioxo-4-trifluoromethyl-1(2H)-pyrimidyl)-benzoate (flupropacil), N-(4,6-dimethoxy-pyrimidin-2-yl)-N′-(3-methoxycarbonyl-6-trifluoromethyl-pyridin-2-yl-sulphonyl)-urea sodium salt (flupyrsulfuron-methyl-sodium), 9-hydroxy-9H-fluorene-9-carboxylic acid (flurenol), (4-amino-3,5-dichloro-6-fluoro-pyridin-2-yl-oxy)-acetic acid (-2-butoxy-1-methyl-ethylester, -1-methyl-heptyl ester) (fluroxypyr, -butoxypropyl, -meptyl), 5-methylamino-2-phenyl-4-(3-trifluoromethyl-phenyl)-3(2H)-furanone (flurtamone), methyl-[(2-chloro-4-fluoro-5-(tetrahydro-3-oxo-1H,3H-[1,3,4]-thiadiazolo-[3,4-a]-pyridazin-1-ylidene)-amino-phenyl]-thio-acetate (fluthiacet-methyl), 5-(2-chloro-4-trifluoromethyl-phenoxy)-N-methylsulphonyl-2-nitro-benzamide (fomesafen), 2-[[[[(4,6-dimethoxy-2-pyrimidinyl)-amino]-carbonyl]-amino]-sulphonyl]-4-formylamino-N,N-dimethyl-benzamide (foramsulfuron), 2-amino-4-(hydroxymethylphosphinyl)-butanoic acid (-ammonium salt) (glufosinate (-ammonium)), N-phosphonomethyl-glycine (-isopropylammonium salt), (glyphosate, -isopropylammonium), methyl 3-chloro-5-[[[[(4,6-dimethoxy-2-pyrimidinyl)-amino]-carbonyl]-amino]-sulphonyl]-1-methyl-1H-pyrazole-4-carboxylate (halosulfuron-methyl), (R)-2-[4-(3-chloro-5-trifluoromethyl-pyridin-2-yl-oxy)-phenoxy]-propanoic acid (-methyl ester, -2-ethoxy-ethyl ester, -butyl ester) (haloxyfop, -methyl, -P-methyl, -ethoxyethyl, -butyl), 3-cyclohexyl-6-dimethylamino-1-methyl-1,3,5-triazine-2,4(1H,3H)-dione (hexazinone), N-(2,4-difluoro-phenyl-1,5-dihydro-N-i-propyl-5-oxo-1-[(tetrahydro-2H-pyran-2-yl)-methyl]-4H-1,2,4-triazol-4-carboxamide (HOK-201—cf. WO-98/38176/ U.S. Pat. No. 6,077,814), methyl 2-(4,5-dihydro-4-methyl-4-isopropyl-5-oxo-1H-imidazol-2-yl)-4-methyl-benzoate (imazamethabenz-methyl), 2-(4,5-dihydro-4-methyl-4-isopropyl-5-oxo-1H-imidazol-2-yl)-5-methyl-pyridine-3-carboxylic acid (imazamethapyr), 2-(4,5-dihydro-4-methyl-4-isopropyl-5-oxo-1H-imidazol-2-yl)-5-methoxymethyl-pyridine-3-carboxylic acid (imazamox), 2-(4,5-dihydro-4-methyl-4-isopropyl-5-oxo-1H-imidazol-2-yl)-quinoline-3-carboxylic acid (imazaquin), 2-(4,5-dihydro-4-methyl-4-i-propyl-5-oxo-1H-imidazol-2-yl)-5-ethyl-pyridine-3-carboxylic acid (imazethapyr), N-(4,6-dimethoxy-pyrimidin-2-yl)-N′-(2-chloro-imidazo[1,2-a]-pyridin-3-yl-sulphonyl)-urea (imazosulfuron), N-(4-methoxy-6-methyl-1,3,5-triazin-2-yl)-N′-(5-iodo-2-methoxycarbonyl-phenylsulphonyl)-urea sodium salt (iodosulfuron-methyl-sodium), 4-hydroxy-3,5-diiodo-benzonitrile (ioxynil), N,N-dimethyl-N′-(4-isopropyl-phenyl)-urea (isoproturon), N-(3-(1-ethyl-1-methyl-propyl)-isoxazol-5-yl)-2,6-dimethoxy-benzamide (isoxaben), (4-chloro-2-methylsulphonyl-phenyl)-(5-cyclopropyl-isoxazol-4-yl)-methanone (isoxachlortole), (5-cyclopropyl-isoxazol-4-yl)-(2-methylsulphonyl-4-trifluoromethyl-pheny)-methanone (isoxaflutole), 2-[2-[4-[3,5-dichloro-2-pyridinyl)-oxy]-phenoxy]-1-oxo-propyl]-isoxazolidine (isoxapyrifop), 2-[(2,3-dihydro-5,8-dimethyl-1,1-dioxidospiro[4H-1-benzothiopyran-4,2′-[1,3]-dioxolan]-6-yl)-carbonyl]-1,3-cyclohexanedione potassium salt (ketospiradox), (2-ethoxy-1-methyl-2-oxo-ethyl) 5-(2-chloro-4-trifluoromethyl-phenoxy)-2-nitro-benzoate (lactofen), N′-(3,4-dichloro-phenyl)-N-methoxy-N-methyl-urea (linuron), (4-chloro-2-methyl-phenoxy)-acetic acid (MCPA), 4-(4-chloro-2-methyl-phenoxy)-butyric acid (MCPB), 2-(4-chloro-2-methyl-phenoxy)-propionic acid (mecoprop), 2-(2-benzothiazolyloxy)-N-methyl-N-phenyl-acetamide (mefenacet), methyl 2-[[[[(4,6-dimethoxy-2-pyrimidinyl)-amino]-carbonyl]amino]-sulphonyl]-4-[[(methylsulphonyl)-amino]methyl]-benzoate (mesosulfuron), 2-(4-methylsulphonyl-2-nitro-benzoyl)-1,3-cyclohexanedione (mesotrione), 4-amino-3-methyl-6-phenyl-1,2,4-triazin-5(4H)-one (metamitron), 2-chloro-N-(2,6-dimethyl-phenyl)-N-(1H-pyrazol-1-yl-methyl)-acetamide (metazachlor), N′-(4-(3,4-dihydro-2-methoxy-2,4,4-trimethyl-2H-1-benzopyran-7-yl-oxy)-phenyl)-N-methoxy-N-methyl-urea (metobenzuron), N′-(4-bromo-phenyl)-N-methoxy-N-methylurea (metobromuron), (S)-2-chloro-N-(2-ethyl-6-methyl-phenyl)-N-(2-methoxy-1-methyl-ethyl)-acet-amide (metolachlor, S-metolachlor), N-(2,6-dichloro-3-methyl-phenyl)-5,7-dimethoxy-1,2,4-triazolo[1,5-a]-pyrimidine-2-sulphonamide (metosulam), N′-(3-chloro-4-methoxy-phenyl)-N,N-dimethyl-urea (metoxuron), 4-amino-6-tert-butyl-3-methylthio-1,2,4-triazin-5(4H)-one (metribuzin), N-(4-methoxy-6-methyl-1,3,5-triazin-2-yl)-N′-(2-methoxycarbonyl-phenylsulphonyl)-urea (metsulfuron-methyl), S-ethyl hexahydro-1H-azepin-1-carbothioate (molinate), 2-(2-naphthyloxy)-N-phenyl-propanamide (naproanilide), N-butyl-N′-(3,4-dichloro-phenyl)-N-methyl-urea (neburon), N-(4,6-dimethoxy-pyrimidin-2-yl)-N′-(3-dimethylcarbarnoyl-pyridin-2-yl-sulphonyl)-urea (nicosulfuron), 4-chloro-5-methylamino-2-(3-trifluoromethyl-phenyl)-3(2H)pyridazinone (norflurazon), 4-(7-chloro-2,4-dimethyl-5-benzofuranyl)-2,4-dihydro-2-methyl-5-trifluoromethyl-3H-1,2,4-triazole-3-thione (OK-701—cf. WO-97/093261U.S. Pat. No. 5,759,958), S-(2-chloro-benzyl) N,N-diethyl-thiocarbamate (orbencarb), 4-dipropylamino-3,5-dinitro-benzenesulphonamide (oryzalin), 3-[2,4-dichloro-5-(2-propinyloxy)-phenyl]-5-(t-butyl)-1,3,4-oxadiazol-2(3H)-one (oxadiargyl), 3-[2,4-dichloro-5-(1-methyl-ethoxy)-phenyl]-5-(t-butyl)-1,3,4-oxadiazol-2(3H)-one (oxadiazon), N-(4,6-dimethyl-pyrimidin-2-yl)-N′-(2-oxetan-3-yl-oxycarbonyl-phenylsulphonyl)-urea (oxasulfuron), 3-[1-(3,5-dichloro-phenyl)-1-i-propyl]-2,3-dihydro-6-methyl-5-phenyl-4H-1,3-oxazin-4-one (oxaziclomefone), 2-chloro-1-(3-ethoxy-4-nitro-phenoxy)-4-trifluoromethyl-benzene (oxyfluorfen), 1,1′-dimethyl-4,4′-bipyridinium (paraquat), 1-amino-N-(1-ethyl-propyl)-3,4-dimethyl-2,6-dinitro-benzene (pendimethalin), 4-(t-butyl)-N-(1-ethyl-propyl)-2,6-dinitro-benzeneamine (pendralin), 2-(2,2-difluoro-ethoxy)-N-(5,8-dimethoxy-[1,2,4]-triazolo-[1,5-c]-pyrimidin-2-yl)-6-trifluoromethyl-benzenesulfonamide (penoxsulam), 3-(4-chloro-5-cyclopentyloxy-2-fluoro-phenyl)-5-(1-methyl-ethylidene)-2,4-oxazolidine-dione (pentoxazone), 2-chloro-N-(2-ethoxy-ethyl)-N-(2-methyl-1-phenyl-1-propenyl)-acetamide (pethoxamide), 4-amino-3,5,6-trichloro-pyridine-2-carboxylic acid (picloram), N-(4-fluoro-phenyl)-6-(3-trifluoromethyl-phenoxy)-pyridine-2-carboxamide (picolinafen), S-[2-(2-methyl-1-piperidinyl)-2-oxo-ethyl] O,O-dipropyl phosphorodithioate (piperophos), 2-chloro-N-(2,6-diethyl-phenyl)-N-(2-propoxy-ethyl)-acetamide (pretilachlor), N-(4,6-bis-difluoromethoxy-pyrimidin-2-yl)-N′-(2-methoxycarbonyl-phenylsulphonyl)-urea (primisulfuron-methyl), 1-chloro-N-[2-chloro-4-fluoro-5-[(6S,7aR)-6-fluoro-tetrahydro-1,3-dioxo-1H-pyrrolo[1,2-c]imidazol-2(3H)-yl]-phenyl]-methanesulphonamide (profluazol), 2-[1-[[2-4-chloro-phenoxy)-propoxy]-imino]-butyl]-3-hydroxy-5-(tetrahydro-2H-thiopyran-3-yl)-2-cyclohexen-1-one (profoxydim), 2-chloro-N-isopropyl-N-phenyl-acetamide (propachlor), N-(3,4-dichloro-phenyl)-propanamide (propanil), (R)-[2-[[(1-methyl-ethylidene)-amino]-oxy]-ethyl] 2-[4-(6-chloro-2-quinoxalinyloxy)-phenoxy]-propanoate (propaquizafop), 2-chloro-N-(2-ethyl-6-methyl-phenyl)-N-[(1-methyl-ethoxy)-methyl]-acetamide (propisochlor), methyl 2-[[[(4,5-dihydro-4-methyl-5-oxo-3-propoxy-1H-1,2,4-triazol-1-yl)-carbonyl]-amino]-sulphonyl]-benzoate sodium salt (propoxycarbazone-sodium), S-phenylmethyl-N,N-dipropyl-thiocarbamate (prosulfocarb), N-(4-methoxy-6-methyl-1,3,5-triazin-2-yl)-N′-(2-(3,3,3-trifluoro-propyl)-phenylsulphonyl)-urea (prosulfuron), ethyl [2-chloro-5-(4-chloro-5-difluoromethoxy-1-methyl-1H-pyrazol-3-yl)-4-fluoro-phenoxy]-acetate (pyraflufen-ethyl), 1-(3-chloro-4,5,6,7-tetrahydro-pyrazolo[1,5-a]pyridin-2-yl)-5-(methyl-2-propinylamino)-1H-pyrazole-4-carbonitrile (pyraclonil, pyrazogyl), 4-(2,4-dichloro-benzoyl)-1,3-dimethyl-5-(4-methyl-phenylsulphonyloxy)-pyrazole (pyrazolate), 4-(2,4-dichloro-benzoyl)-1,3-dimethyl-5-(phenylcarbonylmethoxy)-pyrazole (pyrazoxyfen), N-(4,6-dimethoxy-pyrimidin-2-yl)-N′-(4-ethoxycarbonyl-1-methyl-pyrazol-5-yl-sulphonyl)-urea (pyrazosulfuron-ethyl), diphenylmethanone O-[2,6-bis-(4,6-dimethoxy-pyrimidin-2-yl-oxy)-benzoyl]-oxime (pyribenzoxim), O[3-(1,1-dimethyl-ethyl)-phenyl] (6-methoxy-2-pyridinyl)-methylthiocarbamate (pyributicarb), 6-chloro-3-phenyl-4-pyridazinol (pyridafol), O-(6-chloro-3-phenyl-pyridazin-4-yl) S-octyl-thiocarbonate (pyridate), 6-chloro-3-phenyl-pyridazin-4-ol (pyridatol), 7-[(4,6-dimethoxy-2-pyrimidinyl)-thio]-3-methyl-1(3H)-isobenzofuranone (pyriftalid), methyl 2-(4,6-dimethoxy-pyrimidin-2-yl-oxy)-benzoate (pyriminobac-methyl), 2-chloro-6-(4,6-dimethoxy-pyrimidin-2-ylthio)-benzoic acid sodium salt (pyrithiobac-sodium), 3,7-dichloro-quinoline-8-carboxylic acid (quinchlorac), 7-chloro-3-methyl-quinoline-8-carboxylic acid (quinmerac), 2-amino-3-chloro-1,4-naphthalenedione (quinoclamine), 2-[4-(6-chloro-2-quinoxalinyloxy)-phenoxy]-propanoic acid (-ethyl ester, -tetrahydro-2-furanyl-methyl ester) (quizalofop, -ethyl, -P-ethyl, -P-tefuryl), N-(4,6-dimethoxy-pyrimidin-2-yl)-N′-(3-ethylsulphonyl-pyridin-2-yl-sulphonyl)-urea (rimsulfaron), 2-(1-ethoximinobutyl)-5-(2-ethylthiopropyl)-3-hydroxy-2-cyclohexen-1-one (sethoxydim), 6-chloro-2,4-bis-ethylamino-1,3,5-triazine (simazine), 2-(2-chloro-4-methylsulphonyl-benzoyl)-cyclohexane-1,3-dione (sulcotrione), 2-(2,4-dichloro-5-methylsulphonylamino-phenyl)-4-difluoromethyl-5-methyl-2,4-dihydro-3H-1,2,4-triazol-3-one (sulfentrazone), methyl 2-[[[[(4,6-dimethyl-2-pyrimidinyl)-amino]-carbonyl)-amino]-sulphonyl]-benzoate (sulfometuron-methyl), N-phosphonomethyl-glycine-trimethylsulphonium (sulfosate), N-(4,6-dimethoxy-pyrimidin-2-yl)-N′-(2-ethylsulphonyl-imidazo[1,2-a]pyridine-3-sulphonamide (sulfosulfuron), 6-chloro4-ethylamino-2-tert-butylamino-1,3,5-triazine (terbuthylazine), 2-tert-butylamino4-ethylamino-6-methylthio-1,3,5-triazine (terbutryn), 2-chloro-N-(2,6-dimethyl-phenyl)-N-(3-methoxy-2-thienyl-methyl)-acetamide (thenylchlor), methyl 2-difluoromethyl-5-(4,5-dihydro-thiazol-2-yl)-4-(2-methyl-propyl)-6-trifluoromethyl-pyridine-3-carboxylate (thiazopyr), 6-(6,7-dihydro-6,6-dimethyl-3H,5H-pyrrolo[2,1-c]-1,2,4-thiadiazol-3-ylideneamino)-7-fluoro-4-(2-propinyl)-2H-1,4-benzoxazin-3(4H)-one (thidiazimin), N-(4-methoxy-6-methyl-1,3,5-triazin-2-yl)-N′-(2-methoxycarbonyl-thien-3-yl-sulphonyl)-urea (thifensulfuron-methyl), S-(phenylmethyl) bis-(1-methyl-propyl)-carbamothioate (tiocarbazil), 2-(ethoximino-propyl)-3-hydroxy-5-(2,4,6-trimethyl-phenyl)-2-cyclohexen-1-one (tralkoxydim), S-(2,3,3-trichloro-2-propenyl) diisopropylcarbamothioate (triallate), N-(4-methoxy-6-methyl-1,3,5-triazin-2-yl)-N′-[2-(2-chloro-ethoxy)-phenylsulphonyl]-urea (triasulfuron), N-methyl-N-(4-methoxy-6-methyl-1,3,5-triazin-2-yl)-N ′-(2-methoxycarbonyl-phenylsulphonyl)-urea (tribenuron-methyl), (3,5,6-trichloro)-pyridin-2-yl-oxy-acetic acid (triclopyr), 2-(3,5-dichloro-phenyl)-2-(2,2,2-trichloro-ethyl)-oxirane (tridiphane), N-[[(4,6-dimethoxy-2-pyrimidinyl)-amino]-carbonyl]-3-(2,2,2-trifluoro-ethoxy)-2-pyridinesulphonamide sodium salt (trifloxysulfuron), 1-amino-2,6-dinitro-N,N-dipropyl-4-trifluoromethyl-benzene (trifluralin), N-[4-dimethylamino-6-(2,2,2-trifluoro-ethoxy)-1,3,5-triazin-2-yl]-N′-(2-methoxycarbonyl-phenylsulphonyl)-urea (triflusulfuron-methyl), N-(4-methoxy-6-trifluoromethoxy-1,3,5-triazin-2-yl)-N′-(2-trifluoromethyl-phenylsulphonyl)-urea (tritosulfuron), N-[[(4,6-dimethoxy-2-pyrimidinyl)-amino]-carbonyl]-3-(N-methyl-N-methylsulphonyl-amino])-2-pyridinesulphonamide, (cf. WO-92/10660), 4-[4,5-dihydro-4-methyl-5-oxo-(3-trifluoromethyl)-1H-1,2,4-triazol-1-yl]-2-(ethylsulphonylamino)-5-fluoro-benzenecarbothioamide (HWH4991 cf. WO-95/30661), 2-chloro-N-[1-(2,6-dichloro-4-difluoromethyl-phenyl)-4-nitro-1H-pyrazol-5-yl]-propanecarboxamide (SLA5599, cf. EP-A-303153), [2-chloro-3-(4,5-dihydro-3-isoxazolyl)-4-methylsulphonyl-phenyl]-(5-hydrox-1-methyl-1H-pyrazol-4-yl)-methanone (cf WO-96/26206, WO-98/31681), [3-(4,5-dihydro-3-isoxazolyl)-2-methyl-4-methylsulphonyl-phenyl]-(5-hydrox-1-methyl-1H-pyrazol-4-yl)-methanone (cf. WO-96/26206, WO-98/31681), [3-[2-chloro-3-[2,6-dioxo-cyclohexyl)-carbonyl]-6-ethylsulphonyl-phenyl]-5-isoxazolyl]-acetonitrile (cf. WO-01/28341), 2-[2-chloro-4-methylsulphonyl-3-[(2,2,2-trifluoro-ethoxy)-methyl]-benzoyl]-1,3-cyclohexanedione (cf. WO-01/28341), 2-[[5,8-dimethyl-1,1-dioxido-4-(2-pyrimidinyloxy)-3,4-dihydro-2H-thiochromen-6-yl]-carbonyl]-1,3-cyclohexanedione (cf. WO-01/28341)
   (“active compounds of group 2”),
   and/or
(c) a compound which improves crop plant compatibility, from the following group of compounds:
4-dichloroacetyl-1-oxa-4-aza-spiro[4.5]-decane (AD-67), 1-dichloroacetyl-hexahydro-3,3,8a-trimethylpyrrolo[1,2-a]-pyrimidin-6(2H)-one (BAS-145138), 4-dichloroacetyl-3,4-dihydro-3-methyl-2H-1,4-benzoxazine (benoxacor), 1-methyl-hexyl 5-chloro-quinoxalin-8-oxy-acetate (cloquintocet-mexyl, α-(cyanomethoximino)-phenylacetonitrile (cyometrinil), 2,4-dichlorophenoxy acetic acid (2,4-D), 2,2-dichloro-N-(2-oxo-2-(2-propenylamino)-ethyl)-N-(2-propenyl)-acetamide (DKA-24), 2,2-dichloro-N,N-di-2-propenyl acetamide (dichlormid), N-(4-methyl-phenyl)-N′-(1-methyl-1-phenyl-ethyl)-urea (dymron), 4,6-dichloro-2-phenyl-pyrimidine (fenclorim), ethyl 1-(2,4-dichloro-phenyl)-5-trichloro-methyl-1H-1,2,4-triazole-3-carboxylate (fenchlorazol-ethyl), phenylmethyl 2-chloro-4-trifluoromethyl-thiazole-5-carboxylate (flurazole), 4-chloro-N-(1,3-dioxolan-2-yl-methoxy)-α-trifluoro-acetophenone oxime (fluxofenim), 3-dichloroacetyl-5-(2-furanyl)-2,2-dimethyl-oxazolidine (furilazole, MON-13900), ethyl-4,5-dihydro-5,5-diphenyl-3-isoxazolecarboxylate (isoxadifen-ethyl), (4-chloro-2-methyl-phenoxy)-acetic acid (MCPA), (+−)-2-(4-chloro-2-methylphenoxy)-propionic acid (mecoprop), diethyl 1-(2,4-dichlorophenyl)-4,5-dihydro-5-methyl-1H-pyrazole-3,5-dicarboxylate (mefenpyr-diethyl), 2-dichloromethyl-2-metbyl-1,3-dioxolan (MG-191), 1,8-naphthalic anhydride, a-(1,3-dioxolan-2-yl-methoximino)-phenylacetonitrile (oxabetrinil), 2,2-dichloro-N-(1,3-dioxolan-2-yl-methyl)-N-(2-propenyl)-acetamide (PPG-1292), 3-dichloroacetyl-2,2,5-trimethyl-oxazolidine (R-29148), N-cyclopropyl-4-[[(2-methoxy-5-methyl-benzoyl)-amino]-sulphonyl]-benzamide, N-[[(4-methoxyacetyl-amino)-phenyl]-sulphonyl-2-methoxy-benzamide and N-[[(4-methylaminocarbonyl-amino)-phenyl]-sulphonyl-2-methoxy-benzamide (the latter are each known from WO-99/66795), N-(phenylsulphamoyl)benzamide derivatives of the formula (V) 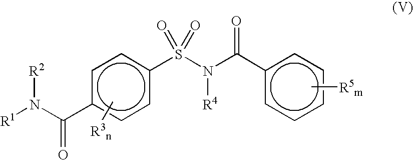
   in which
R¹ represents hydrogen, (C₁-C₆)-alkyl, (C₃-C₆)-cycloalkyl, (C₂-C₆)-alkenyl, (C₅-C₆)-cycloalkenyl, phenyl or 3- to 6-membered heterocyclyl having up to three heteroatoms from the group consisting of nitrogen, oxygen and sulphur, where the six lastmentioned radicals are optionally. substituted by one or more identical or different substituents from the group consisting of halogen, (C₁-C₆)-alkoxy, (C₁-C₆)-haloalkoxy, (C₁-C₂)-alkylsulphinyl, (C₁-C₂)-alkyl-sulphonyl, (C₃-C₆)-cycloalkyl, (C₁-C₄)-alkoxycarbonyl, (C₁-C₄)-alkyl-carbonyl and phenyl and in the case of cyclic radicals, also (C₁-C₄)-alkyl and (C₁-C₄)-haloalkyl;
R² represents hydrogen, (C₁-C₆)-alkyl, (C₂-C₆)-alkenyl, (C₂-C₆)-alkinyl, where the three lastmentioned radicals are optionally substituted by one or more identical or different substituents from the group consisting of halogen, hydroxyl, (C₁-C₄)-alkyl, (C₁-C₄)-alkoxy and (C₁-C₄)-alkylthio;
R³ represents halogen, (C₁-C₄)-haloalkyl, (C₁-C₄)-haloalkoxy, nitro, (C₁-C₄)-alkyl, (C₁-C₄)-alkoxy, (C₁-C₄)-alkylsulphonyl, (C₁-C₄)-alkoxycarbonyl or (C₁-C₄)-alkylcarbonyl;
R⁴ represents hydrogen or methyl;
R⁵ represents halogen; nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulphinyl, (C₁-C₄)-alkylsulphonyl, (C₁-C₄)-alkoxycarbonyl or (C₁-C₄)-alkylcarbonyl;
n represents 0, 1 or 2 and
m represents 1 or 2,
   and their salts, in particular the sodium salts (known from WO-099/16744), N-acylsulphonamide derivatives of the formula (VI) 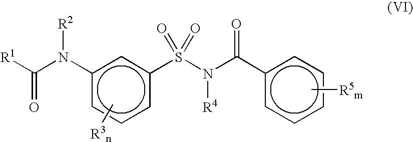
   in which
R¹ represents hydrogen, (C₁-C₆)-alkyl, (C₃-C₆)-cycloalkyl, furanyl or thienyl, where each of the four lastmentioned radicals is unsubstituted or substituted by one or more substituents from the group consisting of halogen (C₁-C₄)-alkyoxy, halogeno-(C₁-C₆)-alkoxy and (C₁-C₄)-alkylthio and, in the case of cyclic radicals, also (C₁-C₄)-alkyl and (C₁-C₄)-halogenoalkyl;
R² is hydrogen or methyl;
R³ is halogen, halogeno-(C₁-C₄)-alkyl, halogeno-(C₁-C₄)-alkoxy, (C₁-C₄)-alkyl, (C₁-C₄)-alkoxy, (C₁-C₄)-alkylsulphonyl, (C₁-C₄)-alkoxycarbonyl, (C₁-C₄)-alkylcarbonyl,
R⁴ is hydrogen, methyl;
R⁵ is halogen, (C₁-C₄)-alkyl, halogeno-(C₁-C₄)-alkyl, halogeno-(C₁-C₄)-alkoxy, (C₃-C₆)-cycloalkyl, phenyl, (C₁-C₄)-alkoxy, cyano, (C₁-C₄)-alkylthio, (C₁-C₄)-alkylsulphinyl, (C₁-C₄)-alkylsulphonyl, (C₁-C₄)-alkoxycarbonyl, (C₁-C₄)-alkylcarbonyl,
n is 0, 1 or 2 and
m is 1 or 2,
   and their alkali metal salts, in particular the sodium salts (known from DE-A1-19 621 522).
   (“active compounds of group 3”).

The compounds involved in the active compound combinations according to the invention contain, if appropriate, one or more asymmetrically substituted carbon atoms and can therefore be present in different enantiomeric (R— or S-configured) and/or diastereomeric forms. The invention relates both to the possible combinations with individual enantiomeric and/or stereoisomeric forms and with mixtures of the stereoisomeric forms of the involved compounds which are possible in each case.

Preferred meanings of the groups listed above in connection with the formula (I) are defined below.
A¹ preferably represents a single bond or O (oxygen).
A² preferably represents a single bond or represents alkanediyl (alkylene), alkenediyl or alkinediyl having in each case up to 6 carbon atoms.
Q preferably represents O (oxygen) or S (sulphur).
R¹ preferably represents hydrogen, represents in each case optionally cyano, halogen-, C₁-C₄-alkoxy-, C₁-C₄-alkylthio-, C₁-C₄-alkylsulphinyl- or C₁-C₄-alkylsulphonyl-substituted alkyl, alkylthio, alkylsulphinyl or alkylsulphonyl having in each case 1 to 6 carbon atoms in the alkyl groups, represents in each case optionally cyano- or halogen-substituted alkenyl or alkinyl having in each case 2 to 6 carbon atoms, represents in each case optionally cyano-, halogen- or C₁-C₄-alkyl-substituted cycloalkyl or cycloalkylalkyl having in each case 3 to 6 carbon atoms in the cycloalkyl group and, if appropriate, 1 to 4 carbon atoms in the alkyl moiety, represents in each case optionally nitro-, cyano-, halogen-, C₁-C₄-alkyl-, C₁-C₄-halogenoalkyl-, C₁-C₄-alkoxy- or C₁-C₄-halogenoalkoxy-substituted aryl or arylalkyl having in each case 6 or 10 carbon atoms in the aryl group and, if appropriate, 1 to 4 carbon atoms in the alkyl moiety, or represents the grouping —C(O)R², —C(S)R².
R² preferably represents hydrogen, amino, cyanoamino, nitroamino, hydroxyamino, hydrazino, represents C₁-C₄-alkyl-carbonyl, represents C₁-C₄-alkoxy-carbonyl, represents in each case optionally cyano-, halogen-, C₁-C₄-alkoxy-, C₁-C₄-alkylthio-, C₁-C₄-alkylsulphinyl- or C₁-C₄-alkylsulphonyl-substituted alkyl, alkoxy, alkylthio, alkylamino, alkoxyamino or alkylhydrazino having in each case 1 to 6 carbon atoms in the alkyl groups, represents dialkylamino, N-alkyl-alkoxyamino or dialkylhydrazino having in each case 1 to 4 carbon atoms in the alkyl groups, represents in each case optionally halogen-substituted alkenyl, alkenyloxy, alkenylamino, alkenyloxyamino, alkinyl, alkinyloxy or alkinylamino having in each case 2 to 6 carbon atoms, represents in each case optionally cyano-, halogen- or C₁-C₄-alkyl-substituted cycloalkyl, cycloalkyloxy, cycloalkylamino, cycloalkylalkyl, cycloalkylalkoxy or cycloalkylalkylamino having in each case 3 to 6 carbon atoms in the cycloalkyl group and, if appropriate, 1 to 4 carbon atoms in the alkyl moiety, represents in each case optionally nitro-, cyano-, halogen-, C₁-C₄-alkyl-, C₁-C₄-halogenoalkyl-, C₁-C₄-alkoxy-, C₁-C₄-halogenoalkoxy- or C₁-C₄-alkoxy-carbonyl-substituted aryl, arylcarbonyl, aryloxy, aryloxycarbonyl, arylthio, arylamino, arylhydrazino, arylalkyl, arylalkoxy, arylalkylthio or arylalkylamino having in each case 6 or 10 carbon atoms in the aryl group and, if appropriate, 1 to 4 carbon atoms in the alkyl moiety, or represents in each case optionally nitro-, cyano-, halogen-, C₁-C₄-alkyl-, C₁-C₄-halogenoalkyl-, C₁-C₄-alkoxy-, C₁-C₄-halogenoalkoxy-, C₁-C₄-alkylthio-, C₁-C₄-halogenoalkylthio-, C₁-C₄-alkoxy-carbonyl-, C₃-C₆-cycloalkyl- or C₃-C₆-cycloalkyl-C₁-C₄-alkyl-substituted monocyclic or bicyclic heterocyclyl, heterocyclyloxy, heterocyclylthio, heterocyclylamino, heterocyclylalkyl, heterocyclylalkoxy, heterocyclylalkylthio or heterocyclylalkylamino, where the heterocyclyl group contains in each case up to 10 carbon atoms and additionally at least one heteroatom selected from the group consisting of nitrogen (N) (but at most 5 N atoms), oxygen (O) (but at most 2 O atoms), sulphur (S) (but at most 2 S atoms), SO or SO₂ and optionally additionally a group selected from oxo (C═O), thioxo (C═S), imino (C═NH), cyanoimino (C═N—CN), nitroimino (C═N—NO₂).
X preferably represents hydrogen, nitro, cyano, carboxyl, carbamoyl, thiocarbamoyl, halogen, or represents in each case optionally cyano-, halogen-, C₁-C₄-alkoxy-, C₁-C₄-alkylthio-, C₁-C₄-alkylsulphinyl- or C₁-C₄-alkylsulphonyl-substituted alkyl, alkoxy, alkylthio, alkylsulphinyl, alkylsulphonyl, alkylamino, dialkylamino or dialkylaminosulphonyl having in each case 1 to 6 carbon atoms in the alkyl groups.
Y preferably represents hydrogen, nitro, cyano, carboxy, carbamoyl, thiocarbamoyl, halogen, or represents in each case optionally cyano-, halogen-, C₁-C₄-alkoxy-, C₁-C₄-alkylthio-, C₁-C₄-alkylsulphinyl- or C₁-C₄-alkylsulphonyl-substituted alkyl, alkoxy, alkylthio, alkylsulphinyl, alkylsulphonyl, alkylamino, dialkylamino or dialkylaminosulphonyl having in each case 1 to 6 carbon atoms in the alkyl groups.
Z preferably represents one of the groupings below 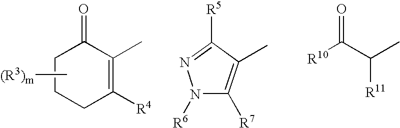
m preferably represents the numbers 0 to 3.
R³ preferably represents hydrogen, halogen, represents in each case optionally cyano-, halogen-, C₁-C₄-alkoxy-, C₁-C₄-alkylthio-, C₁-C₄-alkylsulphinyl- or C₁-C₄-alkylsulphonyl-substituted alkyl or alkylthio having in each case 1 to 6 carbon atoms, or represents phenyl, or —if m represents 2— optionally also together with a second radical R³ represents oxygen or alkanediyl (alkylene) having 3 to 5 carbon atoms.
R⁴ preferably represents hydroxyl, formyloxy, halogen, represents in each case optionally cyano-, halogen-, C₁-C₄-alkoxy-, C₁-C₄-alkylthio-, C₁-C₄-alkylsulphinyl- or C₁-C₄-alkylsulphonyl-substituted alkoxy, alkylthio, alkylsulphinyl, alkylsulphonyl, alkylcarbonyloxy, alkoxycarbonyloxy, alkylaminocarbonyloxy or alkylsulphonyloxy having in each case 1 to 6 carbon atoms, represents in each case optionally halogen-substituted alkenyloxy or alkinyloxy having in each case 3 to 6 carbon atoms, represents in each case optionally nitro-, cyano-, halogen-, C₁-C₄-alkyl-, C₁-C₄-halogenoalkyl-, C₁-C₄-alkoxy-, C₁-C₄-halogenoalkoxy-, C₁-C₄-alkylthio-, C₁-C₄-halogenoalkylthio-, C₁-C₄-alkylsulphinyl-, C₁-C₄-halogenoalkylsulphinyl-, C₁-C₄-alkylsulphonyl- or C₁-C₄-halogenoalkylsulphonyl-substituted aryloxy, arylthio, arylsulphinyl, arylsulphonyl, arylcarbonyloxy, arylcarbonylalkoxy, arylsulphonyloxy, arylalkoxy, arylalkylthio, arylalkylsulphinyl or arylalkylsulphonyl having. in each case 6 or 10 carbon atoms in the aryl group and, if appropriate, 1 to 4 carbon atoms in the alkyl moiety.
R⁵ preferably represents hydrogen, cyano, carbamoyl, thiocarbamoyl, halogen, represents in each case optionally cyano-, halogen-, C₁-C₄-alkoxy-, C₁-C₄-alkylthio-, C₁-C₄-alkylsulphinyl- or C₁-C₄-alkylsulphonyl-substituted alkyl, alkoxy, alkylthio, alkylsulphinyl, alkylsulphonyl or alkoxycarbonyl having in each case 1 to 6 carbon atoms in the alkyl groups or represents optionally cyano-, halogen- or C₁-C₄-alkyl-substituted cycloalkyl having 3 to 6 carbon atoms.
R⁶ preferably represents hydrogen, represents optionally cyano-, halogen-, C₁-C₄-alkoxy-, C₁-C₄-alkylthio-, C₁-C₄-alkylsulphinyl- or C₁-C₄-alkylsulphonyl-substituted alkyl having 1 to 6 carbon atoms, represents in each case optionally cyano- or halogen-substituted alkenyl or alkinyl having in each case 3 to 6 carbon atoms, represents in each case optionally cyano-, halogen- or C₁-C₄-alkyl-substitated cycloalkyl or cycloalkylalkyl having in each case 3 to 6 carbon atoms in the cycloalkyl group and, if appropriate, 1 to 4 carbon atoms in the alkyl moiety, or represents in each case optionally nitro-, cyano-, halogen-, C₁-C₄-alkyl-, C₁-C₄-halogenoalkyl-, C₁-C₄-alkoxy-, C₁-C₄-halogenoalkoxy-, C₁-C₄-alkylthio-, C₁-C₄-halogenoalkylthio-, C₁-C₄-alkylsulphinyl-, C₁-C₄-halogenoalkylsulphinyl-, C₁-C₄-alkylsulphonyl- or C₁-C₄-halogenoalkylsulphonyl-substituted aryl or arylalkyl having in each case 6 or 10 carbon atoms in the aryl group and, if appropriate, 1 to 4 carbon atoms in the alkyl moiety.
R⁷ preferably represents hydroxyl, formyloxy, represents in each case optionally cyano-, halogen- or C₁-C₄-alkoxy-substituted alkoxy, alkylcarbonyloxy, alkoxycarbonyloxy, alkylaminocarbonyloxy or alkylsulphonyloxy having in each case 1 to 6 carbon atoms in the alkyl groups, represents in each case optionally cyano- or halogen-substituted alkenyloxy or alkinyloxy having in each case 3 to 6 carbon atoms, or represents in each case optionally nitro-, cyano-, halogen-, C₁-C₄-alkyl-, C₁-C₄-halogenoalkyl-, C₁-C₄-alkoxy-, C₁-C₄-halogenoalkoxy-, C₁-C₄-alkylthio-, C₁-C₄-halogenoalkylthio-, C₁-C₄-alkylsulphinyl-, C₁-C₄-halogenoalkylsulphinyl-, C₁-C₄-alkylsulphonyl or C₁-C₄-halogenoalkylsulphonyl-substituted arylalkoxy, arylcarbonyloxy, arylcarbonylalkoxy or arylsulphonyloxy having in each case 6 or 10 carbon atoms in the aryl group and, if appropriate, 1 to 4 carbon atoms in the alkyl moiety.
R⁸ preferably represents hydrogen, cyano, carbamoyl, thiocarbamoyl, halogen, or represents in each case optionally cyano-, halogen- or C₁-C₄-alkoxy-substituted alkyl, alkylcarbonyl, alkoxy, alkoxycarbonyl, alkylthio, alkylsulphinyl or alkylsulphonyl having in each case 1 to 6 carbon atoms in the alkyl groups.
R⁹ preferably represents hydrogen, represents optionally cyano-, halogen- or C₁-C₄-alkoxy-substituted alkyl, or represents optionally cyano-, halogen- or C₁-C₄-alkyl-substituted cycloalkyl having 3 to 6 carbon atoms.
R¹⁰ preferably represents hydrogen, represents optionally cyano-, halogen- or C₁-C₄-alkoxy-substituted alkyl, or represents optionally cyano-, halogen- or C₁-C₄-alkyl-substituted cycloalkyl having 3 to 6 carbon atoms.
R¹¹ preferably represents hydrogen, cyano, carbamoyl, halogen, or represents in each case optionally cyano-, halogen- or C₁-C₄-alkoxy-substituted alkyl, alkoxy, alkoxycarbonyl, alkylthio, alkylsulphinyl or alkylsulphonyl having in each case 1 to 6 carbon atoms in the alkyl groups.
A¹ represents a single bond or O (oxygen).
A² particularly preferably represents a single bond or represents methylene (—CH₂—), ethane-1,1-diyl (—CH(CH₃)—), ethane-1,2-diyl (dimethylene, —CH₂CH₂—), propane-1,1-diyl (—CH(C₂H₅)—), propane-1,2-diyl (FCH(CH₃)CH₂—), propane-1,3-diyl (—CH₂CH₂CH₂—), butane-1,3-diyl (—CH(CH₃)CH₂CH₂—), butane-1,4-diyl (—CH₂CH₂CH₂CH₂—), ethenediyl, propenediyl, butenediyl, ethinediyl, propinediyl or butinediyl.
R¹ particularly preferably represents hydrogen, represents in each case optionally cyano-, fluorine-, chlorine-, bromine-, methoxy-, ethoxy-, n- or i-propoxy-, methylthio-, ethylthio-, n- or i-propylthio-, methylsulphinyl-, ethylsulphinyl-, n- or i-propylsulphinyl-, methylsulphonyl- or ethylsulphonyl-substituted methyl, ethyl, n- or i-propyl, n-, i-, s- or t-butyl, n-, i-, s- or t-pentyl, methylthio, ethylthio, n- or i-propylthio, n-, i-, s- or t-butylthio, methylsulphinyl, ethylsulphinyl, n- or i-propylsulphinyl, methylsulphonyl or ethylsulphonyl, represents in each case optionally fluorine-, chlorine- and/or bromine-substituted ethenyl, propenyl, butenyl, pentenyl, ethinyl, propinyl, butinyl or pentinyl, represents in each case optionally cyano-, fluorine-, chlorine-, bromine-, methyl-, ethyl- or propyl-substituted cyclopropyl, cyclobutyl, cyclopentyl, cyclohexyl, cyclopropylmethyl, cyclobutylmethyl, cyclopentylmethyl or cyclohexylmethyl, or represents in each case optionally nitro-, cyano-, fluorine-, chlorine-, bromine-, methyl-, ethyl-, n- or i-propyl-, nl-, i-, s- or t-butyl-, trifluoromethyl-, methoxy-, ethoxy-, n- or i-propoxy-, difluoromethoxy- or trifluoromethoxy-substituted phenyl, naphthyl, phenylmethyl, phenylethyl, naphthylmethyl or naphthylethyl or represents the groupings —C(O)—R², —C(S)—R².
R² particularly preferably represents hydrogen, amino, cyanoamino, nitroamino, hydroxyamino, hydrazino, represents in each case optionally cyano-, fluorine-, chlorine-, methoxy-, ethoxy-, n- or i-propoxy-, methylthio-, ethylthio-, n- or i-propylthio-, methylsulphinyl-, ethylsulphinyl-, n- or i-propylsulphinyl-, methylsulphonyl- or ethylsulphonyl-substituted methyl, ethyl, n- or i-propyl, n-, i-, s- or t-butyl, n-, i-, s- or t-pentyl, methoxy, ethoxy, n- or i-propoxy, n-, i-, s- or t-butoxy, methylthio, ethylthio, n- or i-propylthio, n-, i-, s- or t-butylthio, methylamino, ethylamino, n- or i-propylamino, n-, i-, s- or t-butylamino, methoxyamino, ethoxyamino, n- or i-propoxyamino, n-, i-, s- or t-butoxyamino, methylhydrazino, ethylhydrazino, n- or i-propylhydrazino, n-, i-, s- or t-butylhydrazino, represents dimethylamino, diethylamino, N-methylmethoxyamino, dimethylhydrazino or diethylhydrazino, represents in each case optionally fluorine, chlorine and/or bromine-substituted ethenyl, propenyl, butenyl, pentenyl, ethinyl, propinyl, butinyl, pentinyl, propenyloxy, butenyloxy, pentenyloxy, propenylthio, butenylthio, pentenylthio, propenylamino, butenylamino, pentenylamino, propenyloxyamino, butenyloxyamino, pentenyloxyamino, ethinyl, propinyl, butinyl, pentinyl, propinyloxy, butinyloxy, pentinyloxy, propinylamino, butinylamino or pentinylamino, represents in each case optionally cyano-, fluorine-, chlorine-, bromine-, methyl-, ethyl- or propyl-substituted cyclopropyl, cyclobutyl, cyclopentyl, cyclohexyl, cyclopropyloxy, cyclobutyloxy, cyclopentyloxy, cyclohexyloxy, cyclopropylamino, cyclobutylamino, cyclopentylamino, cyclohexylamino, cyclopropylmethyl, cyclobutylmethyl, cyclopentylmethyl, cyclohexylmethyl, cyclopropylmethoxy, cyclobutylmethoxy, cyclopentylmethoxy, cyclohexylmethoxy, cyclopropylmethylamino, cyclobutylmetbylamino, cyclopentylmethylamino or cyclohexylmethylamino, represents in each case optionally nitro-, cyano-, fluorine-, chlorine-, bromine-, methyl-, ethyl-, n- or i-propyl, n-, i-, s- or t-butyl-, trifluoromethyl-, methoxy-, ethoxy-, n- or i-propoxy-, difluoromethoxy-, trifluoromethoxy-, methoxycarbonyl-, ethoxycarbonyl-, n- or i-propoxycarbonyl-substituted phenyl, phenylcarbonyl, phenoxy, phenoxycarbonyl, phenylthio, phenylamino, phenylhydrazino, naphthyl, naphthyloxy, naphtylthio, naphthylamino, phenylmethyl, phenylethyl, phenylmethoxy, phenylethoxy, phenylmethylthio, phenylethylthio, phenylmethylamino, phenylethylamino, naphthylmethyl, naphthylethyl, naphthylmethoxy, naphthylethoxy, naphthylmethylamino or naphthylethylamino, or represents in each case optionally nitro-, cyano-, fluorine-, chlorine-, bromine-, methyl-, ethyl-, n- or i-propyl-, n-, i-, s- or t-butyl-, difluoromethyl-, trifluoromethyl-, dichloromethyl-, trichloromethyl-, chlorodifluoromethyl-, fluorodichloromethyl-, methoxy-, ethoxy-, n- or i-propoxy-, n-, i-, s- or t-butoxy-, difluoromethoxy-, trifluoromethoxy-, methylthio-, ethylthio-, n- or i-propylthio-, n-, i-, s- or t-butylthio-, difluoromethylthio-, trifluoromethylthio-, methoxycarbonyl-, ethoxycarbonyl-, n- or i-propoxycarbonyl-, cyclopropyl-, cyclobutyl-, cyclopentyl-, cyclohexyl-, cyclopropylmethyl-, cyclobutylmethyl-, cyclopentylmethyl- or cyclohexylmethyl-substituted monocyclic or bicyclic heterocyclyl, heterocyclyloxy, heterocyclylamino, heterocyclylalkyl, heterocyclylalkoxy or heterocyclylalkylamino from the group consisting of furyl, tetrahydrofuryl, furyloxy, tetrahydrofuryloxy, furylamino, tetrahydrofurylamino, furylmethyl, tetrahydrofurylmethyl, furylmethoxy, tetrahydrofurylmethoxy, flirylmethylamino, tetrahydrofurylmethylamino, thienyl, thienylmethyl, pyrrolidinyl, pyrrolidinylamino, oxopyrrolidinyl, pyrrolyl, indolyl, pyrrolylmethyl, pyrazolyl, pyrazolyloxy, pyrazolylamino, pyrazolylmethyl, imidazolyl, imidazolylmethyl, 2-oxo-1,3-diaza-cyclopentyl, oxazolyl, dihydrooxazolyl (oxazolinyl), isoxazolyl, dihydroisoxazolyl (isoxazolinyl), tetrahydroisoxazolyl (isoxazolidinyl), oxazolylmethyl, thiazolyl, dihydrothiazolyl (thiazolinyl), tetrahydrothiazolyl (thiazolidinyl), thiazolylmethyl, thiazolidinyl, oxothiazolidinyl, cyanoiminothiazolidinyl, oxotriazolinyl, oxotetrazolinyl, piperidinyl, piperidinylamino, oxopiperidinyl, 2-oxo-1,3-diaza-cyclohexyl, 2-oxo-1-aza-cycloheptyl, 2-oxo-1,3-diazacycloheptyl, morpholinyl, morpholinylamino, piperazinyl, pyridinyl, pyridinyloxy, pyridinylamino, pyridinylmethyl, pyridinylmethoxy, pyrimidinyl, pyrimidinyloxy, pyrimidinylmethyl, pyrimidinylmethoxy.
X particularly preferably represents hydrogen, nitro, cyano, carboxyl, carbamoyl, thiocarbamoyl, fluorine, chlorine, bromine, iodine, or represents in each case optionally cyano-, fluorine-, chlorine-, methoxy-, ethoxy-, methylthio-, ethylthio-, methylsulphinyl-, ethylsulphinyl-, methylsulphonyl- or ethylsulphonyl-substituted methyl, ethyl, n- or i-propyl, n-, i-, s- or t-butyl, methoxy, ethoxy, n- or i-propoxy, n-, i-, s- or t-butoxy, methylthio, ethylthio, n- or i-propylthio, n-, i-, s- or t-butylthio, methylsulphinyl, ethylsulphinyl, n- or i-propylsulphinyl, methylsulphonyl, ethylsulphonyl, . n- or i-propylsulphonyl, methylamino, ethylamino, n- or i-propylamino, n-, i-, s- or t-butylamino, dimethylamino, diethylamino, dimethylaminosulphonyl or diethylaminosulphonyl.
Y particularly preferably represents hydrogen, nitro, cyano, carboxyl, carbamoyl, thiocarbamoyl, fluorine, chlorine, bromine, iodine, or represents in each case optionally cyano-, fluorine-, chlorine-, methoxy-, ethoxy-, methylthio-, ethylthio-, methylsulphinyl-, ethylsulphinyl-, methylsulphonyl- or ethylsulphonyl-substituted methyl, ethyl, n- or i-propyl, n-, i-, s- or t-butyl, methoxy, ethoxy, n- or i-propoxy, n-, i-, s- or t-butoxy, methylthio, ethylthio, n- or i-propylthio, n-, i-, s- or t-butylthio, methylsulphinyl, ethylsulphinyl, n- or i-propylsulphinyl, methylsulphonyl, ethylsulphonyl, n- or i-propylsulphonyl, methylamino, ethylamino, n- or i-propylamino, n-, i-, s- or t-butylamino, dimethylamino, diethylamino, dimethylaminosulphonyl or diethylaminosulphonyl.
m particularly preferably represents the numbers 0, 1 or 2.
R³ particularly preferably represents hydrogen, fluorine, chlorine or bromine, represents in each case optionally cyano-, fluorine-, chlorine-, methoxy-, ethoxy-, n- or i-propoxy-, methylthio-, ethylthio-, n- or i-propylthio-, methylsulphinyl-, ethylsulphinyl-, methylsulphonyl- or ethylsulphonyl-substituted methyl, ethyl, n- or i-propyl, n-, i-, s- or t-butyl, methylthio, ethylthio, n- or i-propylthio, n-, i-, s-. or t-butylthio, or represents phenyl, or —if m represents 2—optionally also together with a second radical R³ represents oxygen, propane-1,3-diyl or butane-1,4-diyl.
R⁴ particularly preferably represents hydroxyl, formyloxy, fluorine or chlorine, represents in each case optionally cyano-, fluorine-, chlorine-, methoxy-, ethoxy-, n- or i-propoxy-, methylthio-, ethylthio-, n- or i-propylthio-, methylsulphinyl-, ethylsulphinyl-, methylsulphonyl- or ethylsulphonyl-substituted methoxy, ethoxy, n- or i-propoxy, methylthio, ethylthio, n- or i-propylthio, methylsulphinyl, ethylsulphinyl, methylsulphonyl, ethylsulphonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulphonyloxy, ethylsulphonyloxy, n- or i-propylsulphonyloxy, represents in each case optionally fluorine-, chlorine- and/or bromine-substituted propenyloxy, butenyloxy, propinyloxy or butinyloxy, represents in each case optionally nitro-, cyano-, fluorine-, chlorine-, bromine-, methyl-, ethyl-, n- or i-propyl-, n-, i-, s- or t-butyl-, trifluoromethyl-, methoxy-, ethoxy-, n- or i-propoxy-, difluoromethoxy-, trifluoromethoxy-, methylthio-, ethylthio-, n- or i-propylthio-, difluoromethylthio-, trifluoromethylthio-, methylsulphinyl-, ethylsulphinyl-, trifluoromethylsulphinyl-, methylsulphonyl-, ethylsulphonyl- or trifluoromethylsulphonyl-substituted phenyloxy, phenylthio, phenylsulphinyl, phenylsulphonyl, phenylcarbonyloxy, phenylcarbonylalkoxy, phenylsulphonyloxy, phenylmethoxy, phenylmethylthio, phenylmethylsulphinyl or phenylmethylsulphonyl.
R⁵ particularly preferably represents hydrogen, cyano, carbamoyl, thiocarbamoyl, fluorine, chlorine or bromine, represents in each case optionally cyano-, fluorine-, chlorine-, methoxy-, ethoxy-, n- or i-propoxy-, methylthio-, ethylthio-, n- or i-propylthio-, methylsulphinyl-, ethylsulphinyl-, methylsulphonyl- or ethylsulpbonyl-substituted methyl, ethyl, n- or i-propyl, n-, i-, s- or t-butyl, methoxy, ethoxy, n- or i-propoxy, methylthio, ethylthio, n- or i-propylthio, methylsulphinyl, ethylsulphinyl, methylsulphonyl, ethylsulphonyl, methoxycarbonyl, ethoxycarbonyl, n- or i-propoxycarbonyl, or represents in each case optionally cyano-, fluorine-, chlorine-, methyl- or ethyl-substituted cyclopropyl, cyclobutyl, cyclopentyl or cyclohexyl.
R⁶ particularly preferably represents hydrogen, represents in each case optionally cyano-, fluorine-, chlorine-, methoxy-, ethoxy-, n- or i-propoxy-, methylthio-, ethylthio-, n- or i-propylthio-, methylsulphinyl-, ethylsulphinyl-, methylsulphonyl- or ethylsulphonyl-substituted methyl, ethyl, n- or i-propyl, n-, i-, s- or t-butyl, represents in each case optionally cyano-, fluorine-, chlorine- or bromine-substituted propenyl, butenyl, propinyl or butinyl, represents in each case optionally by cyano-, fluorine-, chlorine-, methyl- or ethyl-substituted cyclopropyl, cyclobutyl, cyclopentyl, cyclohexyl, cyclopropylmethyl, cyclobutylmethyl, cyclopentylmethyl or cyclohexylmethyl, or represents in each case optionally nitro-, cyano-, fluorine-, chlorine-, bromine-, methyl-, ethyl-, n- or i-propyl-, n-, i-, s- or t-butyl-, trifluoromethyl-, methoxy-, ethoxy-, n- or i-propoxy-, difluoromethoxy-, trifluoromethoxy-, methylthio-, ethylthio-, n- or i-propylthio-, n-, i-, s- or t-butylthiomethylthio-, ethylthio-, n- or i-propylthio-, difluoromethylthio-, trifluoromethylthio-, methylsulphinyl-, ethylsulphinyl-, trifluoromethylsulphinyl-, methylsulphonyl-, ethylsulphonyl- or trifluoromethylsulphonyl-substituted phenyl or phenylmethyl.
R⁷ particularly preferably represents hydroxyl, formyloxy, represents in each case optionally cyano-, fluorine-, chlorine-, methoxy-, ethoxy, n- or i-propoxy-substituted methoxy, ethoxy, n- or i-propoxy, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulphonyloxy, ethylsulphonyloxy, n- or i-propylsulphonyloxy, represents in each case optionally cyano-, fluorine-, chlorine- or bromine-substituted propenyloxy, butenyloxy, propinyloxy or butinyloxy, or represents in each case optionally nitro-, cyano-, fluorine-, chlorine-, bromine-, methyl-, ethyl-, n- or i-propyl-, n-, i-, s- or t-butyl-, trifluoromethyl-, methoxy-, ethoxy-, n- or i-propoxy-, difluoromethoxy-, trifluoromethoxy-, methylthio-, ethylthio-, n- or i-propylthio-, difluoromethylthio-, trifluoromethylthio-, methylsulphinyl-, ethylsulphinyl-, trifluoromethylsulphinyl-, methylsulphonyl-, ethylsulphonyl- or trifluoromethyl-sulphonyl-substituted phenylmethoxy, phenylcarbonyloxy, phenylcarbonylmethoxy or phenylsulphonyloxy.
R⁸ particularly preferably represents hydrogen, cyano, carbamoyl, thiocarbamoyl, fluorine, chlorine or bromine, or represents in each case optionally cyano-, fluorine-, chlorine-, methoxy-, ethoxy-, n- or i-propoxy-substituted methyl, ethyl, n- or i-propyl, n-, i-, s- or t-butyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulphinyl, ethylsulphinyl, methylsulphonyl or ethylsulphonyl.
R⁹ particularly preferably represents hydrogen, represents in each case optionally cyano-, fluorine-, chlorine-, methoxy-, ethoxy-, n- or i-propoxy-substituted methyl, ethyl, n- or i-propyl, n-, i-, s- or t-butyl, or represents in each case optionally cyano-, fluorine-, chlorine-, methyl- or ethyl-substituted cyclopropyl, cyclobutyl, cyclopentyl or cyclohexyl.
R¹⁰ particularly preferably represents hydrogen, represents in each case optionally cyano-, fluorine-, chlorine-, methoxy-, ethoxy-, n- or i-propoxy-substituted methyl, ethyl, n- or i-propyl, n-, i-, s- or t-butyl, or represents in each case optionally cyano-, fluorine-, chlorine-, methyl- or ethyl-substituted cyclopropyl, cyclobutyl, cyclopentyl or cyclohexyl.
R¹¹ particularly preferably represents hydrogen, cyano, carbamoyl, fluorine, chlorine or bromine, or represents in each case optionally cyano-, fluorine-, chlorine-, methoxy-, ethoxy-, n- or i-propoxy-substituted methyl, ethyl, n- or i-propyl, n-, i-, s- or t-butyl, methoxy, ethoxy, n- or i-propoxy, methoxycarbonyl, ethoxycarbonyl, n- or i-propoxycarbonyl, methylthio, ethylthio, n- or i-propylthio, methylsulphinyl, ethylsulphinyl, methylsulphonyl or ethylsulphonyl.
A² very particularly preferably represents a single bond, represents methylene (—CH₂—) or represents ethane-1,2-diyl (dimethylene, —CH₂CH₂—).
R¹ very particularly preferably represents hydrogen, represents in each case optionally cyano-, fluorine-, chlorine-, methoxy-, ethoxy-, methylthio-, ethylthio-, methylsulphinyl-, ethylsulphinyl-, methylsulphonyl- or ethylsulphonyl-substituted methyl, ethyl, n- or i-propyl, n- or i-butyl, methylthio, ethylthio, n- or i-propylthio, represents in each case optionally fluorine- and/or chlorine-substituted propenyl, butenyl, ethinyl, propinyl or butinyl, represents in each case optionally cyano-, fluorine-, chlorine- or methyl-substituted cyclopropyl, cyclobutyl, cyclopentyl, cyclohexyl, cyclopropylmethyl, cyclobutylmethyl, cyclopentylmethyl or cyclohexylmethyl, or represents in each case optionally nitro-, cyano-, fluorine-, chlorine-, bromine-, methyl-, ethyl-, n- or i-propyl, n-, i-, s- or t-butyl-, trifluoromethyl-, methoxy-, ethoxy-, n- or i-propoxy-, difluoromethoxy- or trifluoromethoxy-substituted phenyl, phenylmethyl or phenylethyl, or represents the groupings —C(O)—R², —C(S)—R².
R² very particularly preferably represents hydrogen, amino, hydroxyamino, hydrazino, represents in each case optionally cyano-, fluorine-, chlorine-, methoxy-, ethoxy-, n- or i-propoxy-, methylthio-, ethylthio-, n- or i-propylthio-, methylsulphinyl-, ethylsulphinyl-, methylsulphonyl- or ethylsulphonyl-substituted methyl, ethyl, n- or i-propyl, n-, i-, s- or t-butyl, methoxy, ethoxy, n- or i-propoxy, methylthio, ethylthio, n- or i-propylthio, methylamino, ethylamino, n- or i-propylamino, methoxyamino, ethoxyamino, n- or i-propoxyamino, represents dimethylamino, represents N-methyl-methoxyamino, represents dimethylhydrazino, represents in each case optionally fluorine- and/or chlorine-substituted ethenyl, propenyl, butenyl, propenyloxy, butenyloxy, propenylthio, butenylthio, propenylamino, butenylamino, ethinyl, propinyl, butinyl, propinyloxy, butinyloxy, propinylamino or butinylamino, represents in each case optionally cyano-, fluorine-, chlorine- or methyl-substituted cyclopropyl, cyclobutyl, cyclopentyl, cyclohexyl, cyclopropylmethyl, cyclobutylmethyl, cyclopentylmethyl or cyclohexylmethyl, represents in each case optionally nitro-, cyano-, fluorine-, chlorine-, bromine-, methyl-, ethyl-, n- or i-propyl-, n-, i-, s- or t-butyl, trifluoromethyl-, methoxy-, ethoxy-, n- or i-propoxy-, difluoromethoxy-, trifluoromethoxy-, methoxycarbonyl-, ethoxycarbonyl-, n- or i-propoxycarbonyl-substituted phenyl, phenylamino, phenylmethyl or phenylethyl, or represents in each case optionally nitro-, cyano-, fluorine-, chlorine-, bromine-, methyl-, ethyl-, n- or i-propyl-, n-, i-, s- or t-butyl-, difluoromethyl-, trifluoromethyl-, dichloromethyl-, trichloromethyl-, chlorodifluoromethyl-, fluorodichloromethyl-, methoxy-, ethoxy-, n- or i-propoxy-, difluoromethoxy-, trifluoromethoxy-, methylthio-, ethylthio-, n- or i-propylthio-, difluoromethylthio-, trifluoromethylthio-, methoxycarbonyl-, ethoxycarbonyl-, n- or i-propoxycarbonyl-, cyclopropyl-, cyclobutyl-, cyclopentyl-, cyclohexyl-, cyclopropylmethyl-, cyclobutylmethyl-, cyclopentylmethyl- or cyclohexylmethyl-substituted monocyclic or bicyclic heterocyclyl or heterocyclylalkyl from the group consisting of furyl, tetrahydrofuryl, furyloxy, tetrahydrofrryloxy, furylamino, tetrahydrofurylamino, furylmethyl, tetrahydrofurylmethyl, furylmethoxy, tetrahydrofurylmethoxy, furylmethylamino, tetrahydrofurylmethylamino, thienyl, thienylmethyl, pyrrolidinyl, pyrrolidinylamino, oxopyrrolidinyl, pyrrolyl, indolyl, pyrrolylmethyl, pyrazolyl, pyrazolyloxy, pyrazolylamino, pyrazolylmethyl, imidazolyl, imidazolylmethyl, 2-oxo-1,3-diaza-cyclopentyl, oxazolyl, dihydrooxazolyl (oxazolinyl), isoxazolyl, dihydroisoxazolyl (isoxazolinyl), tetrahydroisoxazolyl (isoxazolidinyl), oxazolylmethyl, thiazolyl, dihydrothiazolyl (thiazolinyl), tetrahydrothiazolyl (thiazolidinyl), thiazolylmethyl, thiazolidinyl, oxothiazolidinyl, cyanoiminothiazolidinyl, oxotriazolinyl, oxotetrazolinyl, piperidinyl, piperidinylamino, oxopiperidinyl, 2-oxo-1,3-diaza-cyclohexyl, 2-oxo-1-aza-cycloheptyl, -2-oxo-1,3-diazacycloheptyl, morpholinyl, morpholinylamino, piperazinyl, pyridinyl, pyridinyloxy, pyridinylamino, pyridinylmethyl, pyridinylmethoxy, pyrimidinyl, pyrimidinyloxy, pyrimidinylmethyl, pyrimidinylmethoxy.
X very particularly preferably represents hydrogen, nitro, cyano, fluorine, chlorine, bromine, iodine, methyl, ethyl, n- or i-propyl, difluoromethyl, trifluoromethyl, dichloromethyl, trichloromethyl, methoxymethyl, methylthiomethyl, methylsulphinylmethyl, methylsulphonylmethyl, methoxy, ethoxy, difluoromethoxy, trifluoromethoxy, methylthio, ethylthio, methylsulphinyl, ethylsulphinyl, methylsulphonyl, ethylsulphonyl or dimethylaminosulphonyl.
Y very particularly preferably represents hydrogen, nitro, cyano, fluorine, chlorine, bromine, iodine, methyl, ethyl, difluorbmethyl, trifluoromethyl, dichloromethyl, trichloromethyl, methoxymethyl, methylthiomethyl, methylsulphinylmethyl, methylsulphonylmethyl, methoxy, ethoxy, difluoromethoxy, trifluoromethoxy, methylthio, ethylthio, methylsulphinyl, ethylsulphinyl, methylsulphonyl, ethylsulphonyl or dimethylaminosulphonyl.
m very particularly preferably represents the numbers 0 or 1.
R³ very particularly preferably represents hydrogen, represents in each case optionally fluorine- and/or chlorine-substituted methyl, ethyl, n- or i-propyl, methylthio, ethylthio, n- or i-propylthio, or represents phenyl, or —if m represents 2—optionally also together with a second radical R³ represents oxygen, propane-1,3-diyl or butane-1,4-diyl.
R⁴ very particularly preferably represents hydroxyl, represents formyloxy, represents in each case optionally fluorine- and/or chlorine-substituted methoxy, ethoxy, n- or i-propoxy, methylthio, ethylthio, n- or i-propylthio, methylsulphinyl, ethylsulphinyl, methylsulphonyl, ethylsulphonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulphonyloxy, ethylsulphonyloxy, n- or i-propylsulphonyloxy, represents in each case optionally fluorine- and/or chlorine-substituted propenyloxy, butenyloxy, propinyloxy or butinyloxy, represents in each case optionally nitro-, cyano-, fluorine-, chlorine-, bromine-, methyl-, ethyl-, n- or i-propyl-, trifluoromethyl-, methoxy-, ethoxy-, n- or i-propoxy-, difluoromethoxy- or trifluoromethoxy-substituted phenyloxy, phenylthio, phenylsulphinyl, phenylsulphonyl, phenylcarbonyloxy, phenylcarbonylmethoxy, phenylsulphonyloxy, phenylmethoxy, phenylmethylthio, phenylmethylsulphinyl or phenylmethylsulphonyl.
R⁵ very particularly preferably represents hydrogen, cyano, fluorine, chlorine, represents in each case optionally fluorine- and/or chlorine-substituted methyl, ethyl, n- or i-propyl, methoxy, ethoxy, n- or i-propoxy, methylthio, ethylthio, n- or i-propylthio, methylsulphinyl, ethylsulphinyl, methylsulphonyl, ethylsulphonyl, methoxycarbonyl, ethoxycarbonyl, n- or i-propoxycarbonyl, or represents optionally cyano-, fluorine-, chlorine- or methyl-substituted cyclopropyl.
R⁶ very particularly preferably represents hydrogen, represents in each case optionally cyano-, fluorine-, chlorine-, methoxy- or ethoxy-substituted methyl, ethyl, n- or i-propyl, n-, i-, s- or t-butyl, represents in each case optionally fluorine- or chlorine-substituted propenyl, butenyl, propinyl or butinyl, represents in each case optionally by fluorine-, chlorine- or methyl-substituted cyclopropyl, cyclobutyl, cyclopentyl or cyclohexyl, or represents in each case optionally fluorine-, chlorine-, bromine-, methyl-, ethyl-, n- or i-propyl-, trifluoromethyl-, methoxy-, - ethoxy-, n- or i-propoxy-, difluoromethoxy- or trifluoromethoxy-substituted phenyl or phenylmethyl.
R⁷ very particularly preferably represents hydroxyl, represents formyloxy, represents in each case optionally cyano-, fluorine-, chlorine-, methoxy-, ethoxy-, n- or i-propoxy-substituted methoxy, ethoxy, n- or i-propoxy, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulphonyloxy, ethylsulphonyloxy, n- or i-propylsulphonyloxy, represents in each case optionally fluorine- and/or chlorine-substituted propenyloxy, butenyloxy, propinyloxy or butinyloxy, or represents in each case optionally nitro-, cyano-, fluorine-, chlorine-, bromine-, methyl-, ethyl-, n- or i-propyl-, trifluoromethyl-, methoxy-, ethoxy-, n- or i-propoxy-, difluoromethoxy- or trifluoromethoxy-substituted phenylmethoxy, phenylcarbonyloxy, phenylcarbonylmethoxy or phenylsulphonyloxy.
R⁸ very particularly preferably represents hydrogen, cyano, fluorine, chlorine, bromine, or represents in each case optionally fluorine-, chlorine-, methoxy- or ethoxy-substituted methyl, ethyl, n- or i-propyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulphinyl, ethylsulphinyl, methylsulphonyl or ethylsulphonyl.
R⁹ very particularly preferably represents hydrogen, represents in each case optionally fluorine-, chlorine-, methoxy- or ethoxy-substituted methyl, ethyl, n- or i-propyl, or represents optionally fluorine-, chlorine- or methyl-substituted cyclopropyl.
R¹⁰ very particularly preferably represents hydrogen, represents in each case optionally fluorine-, chlorine-, methoxy- or ethoxy-substituted methyl, ethyl, n- or i-propyl, or represents optionally fluorine-, chlorine- or methyl-substituted cyclopropyl.
R¹¹ very particularly preferably represents hydrogen, cyano, fluorine, chlorine, bromine, or represents in each case optionally fluorine-, chlorine-, methoxy- or ethoxy-substituted methyl, ethyl, n- or i-propyl, methoxy, ethoxy, n- or i-propoxy, methoxycarbonyl, ethoxycarbonyl, n- or i-propoxycarbonyl, methylthio, ethylthio, n- or i-propylthio, methylsulphinyl, ethylsulphinyl, methylsulphonyl or ethylsulphonyl.

The compounds of the formulae (I-A) to (I-C) are active compound components from group 1 which are particularly emphasized:

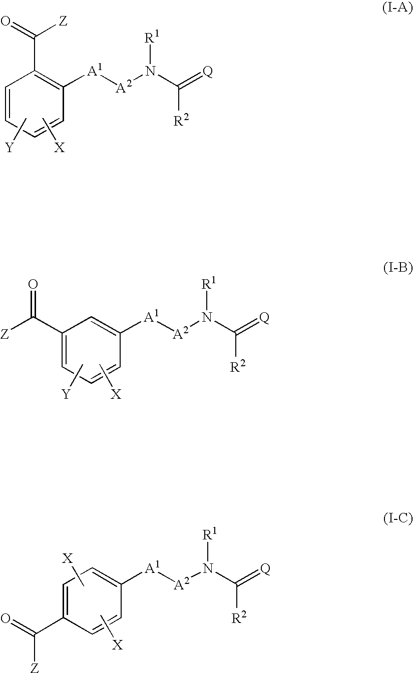

Here, A¹, A², Q, R¹, R², X, Y and Z in each case have the meanings given above as being preferred, particularly preferred or very particularly preferred.

Very particularly emphasized active compound components of group 1 are furthermore the compounds of the general formulae (I-A1) to (I-A4), (I-B1) to (I-B4) and (I-C1) to (I-C₄): 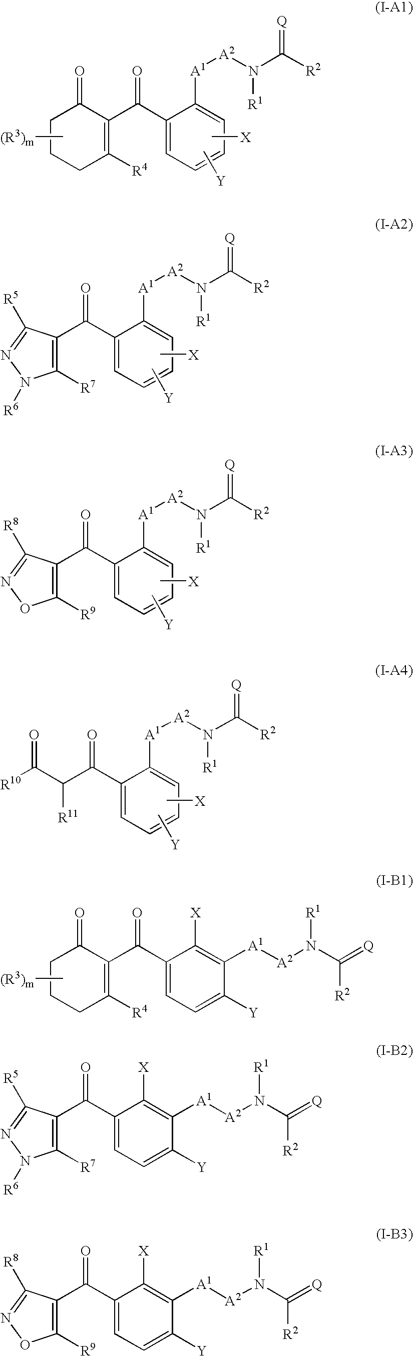 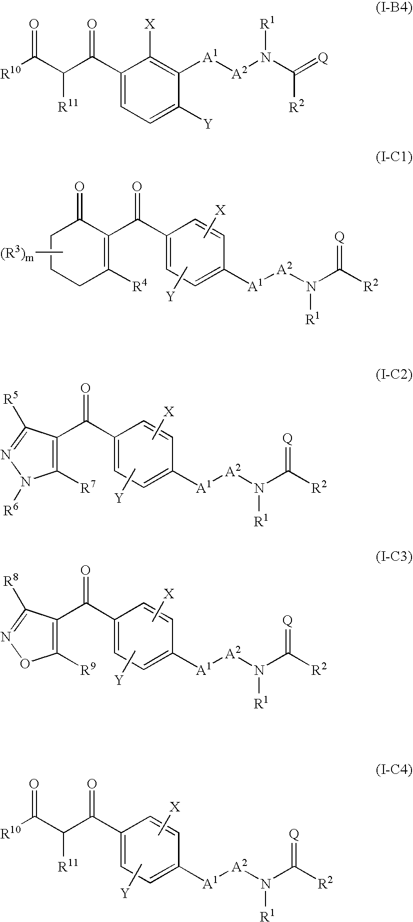
here, m, A¹, A²,Q, R¹, R², R³, R⁴, R⁵, R⁶, R⁷, R⁸, R⁹, R¹⁰, R¹¹, X and Y each have the meanings given above as being preferred or as being very particularly preferred.

Very particular emphasis is given to the compounds of the formulae (I), (I-1), (I-2), (I-3), (I-A1) to (I-A4), (I-B1) to (I-B4) and (I-C1) to (I-C₄), in which A¹ represents oxygen and A² represents ethane-1,2-diyl.

Very particular emphasis is furthermore given to the compounds of the formulae (I), (I-1), (I-2), (I-3), (I-A1) to (I-A4), (I-B1) to (I-B4) and (I-C1) to (I-C₄) in which A¹ and A² together represent methylene.

Very particular emphasis is furthermore given to the compounds of the formula (I), (I-1), (I-2), (I-3), (I-A1) to (I-A4), (I-B1) to (I-B4) and (I-C1) to (I-C₄) in which A¹ and A²together represent a single bond.

Very particular emphasis is furthermore given to the compounds of the formula (I), (I-1), (I-2), (I-3), (I-A1), (I-A2), (I-A4), (I-B1), (I-B2), (I-B4), (I-C1), (I-C2) and (I-C₄) in which A¹ and A² represent a single bond, R¹ represents hydrogen and R² represents N-methyl-methoxyamino.

Examples of compounds of the formula (I) which are very particularly preferred active compound components of group 1 according to the invention are listed in table 1 below. Here, in each case only one of the possible tautomers is shown.

TABLE 1

| | |
|---|---|
| | (I) |
| 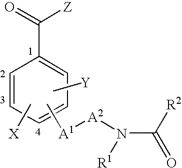 | |

Examples of the active compound components of the formula (I)

| | | | | (position) |
|---|---|---|---|---|
| Example No. | Z | (position) X | (position) Y | 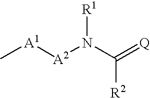 |
| I-1 | 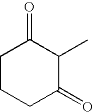 | (2) Cl | (4) Cl | 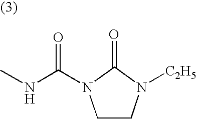 |
| I-2 | 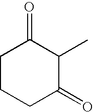 | (2) Cl | (4) Cl | 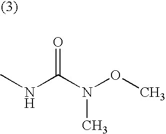 |
| I-3 | 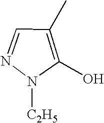 | (2) Cl | (4) Cl | 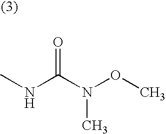 |
| I-4 | 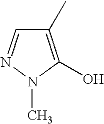 | (2) Cl | (4) Cl | 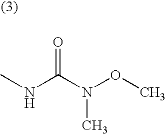 |
| I-5 | 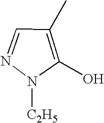 | (2) Cl | (4) Cl | 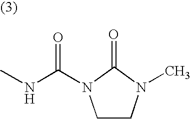 |
| I-6 | 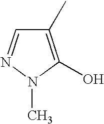 | (2) Cl | (4) Cl | 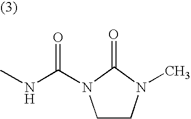 |
| I-7 | 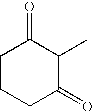 | (2) Cl | (4) Cl | 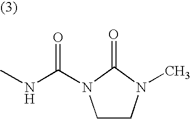 |
| I-8 | 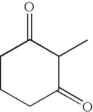 | (2) Cl | (4) Cl | 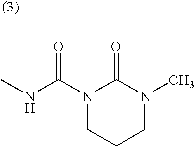 |
| I-9 | 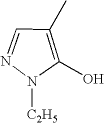 | (2) Cl | (4) Cl | 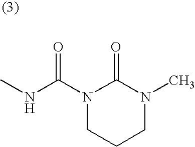 |
| I-10 | 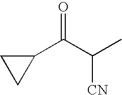 | (2) Cl | (4) Cl | 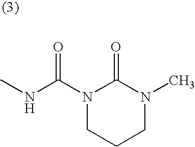 |
| I-11 | 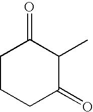 | (2) Cl | (4) Cl | 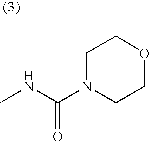 |
| I-12 | 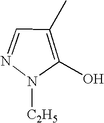 | (2) Cl | (4) Cl | 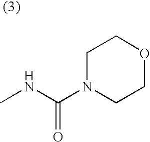 |
| I-13 | 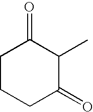 | (2) Cl | (4) Cl | 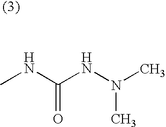 |
| I-14 | 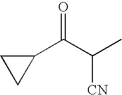 | (2) Cl | (4) Cl | 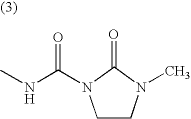 |
| I-15 | 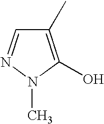 | (2) Cl | (4) Cl | 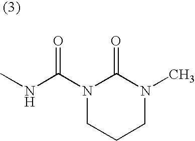 |
| I-16 | 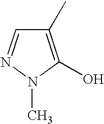 | (2) Cl | (4) Cl | 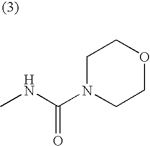 |
| I-17 | 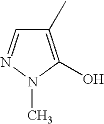 | (2) Cl | (4) Cl | 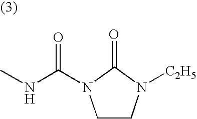 |
| I-18 | 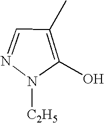 | (2) Cl | (4) Cl | 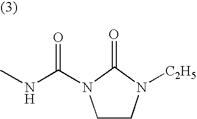 |
| I-19 | 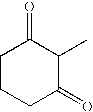 | (2) Cl | (4) Cl | 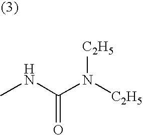 |
| I-20 | 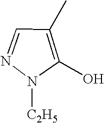 | (2) Cl | (4) Cl | 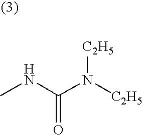 |
| I-21 | 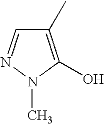 | (2) Cl | (4) Cl | 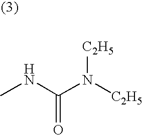 |
| I-22 | 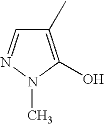 | (2) Cl | (4) Cl | 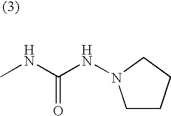 |
| I-23 | 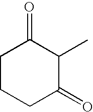 | (2) Cl | (4) Cl | 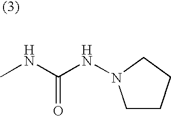 |
| I-24 | 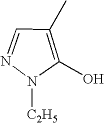 | (2) Cl | (4) Cl | 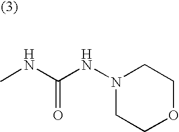 |
| I-25 | 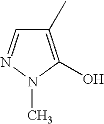 | (2) Cl | (4) Cl | 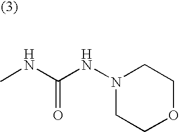 |
| I-26 | 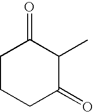 | (2) Cl | (4) Cl | 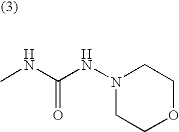 |
| I-27 | 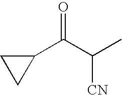 | (2) Cl | (4) Cl | 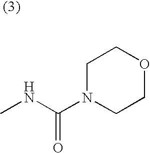 |
| I-28 | 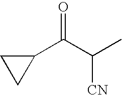 | (2) Cl | (4) Cl | 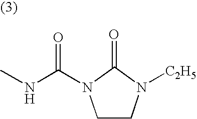 |
| I-29 | 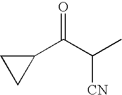 | (2) Cl | (4) Cl | 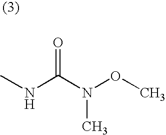 |
| I-30 | 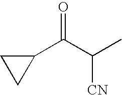 | (2) Cl | (4) Cl | 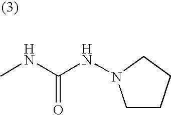 |
| I-31 | 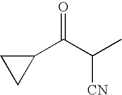 | (2) Cl | (4) Cl | 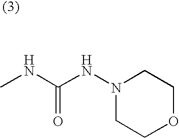 |
| I-32 | 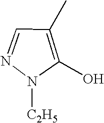 | (2) Cl | (4) Cl | 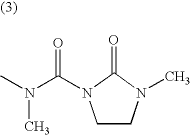 |
| I-33 | 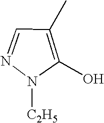 | (2) Cl | (4) Cl | 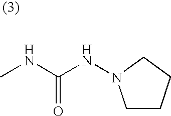 |
| I-34 | 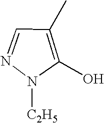 | (2) Cl | (4) Cl | 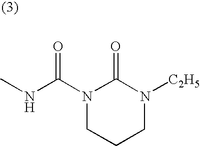 |
| I-35 | 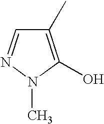 | (2) Cl | (4) Cl | 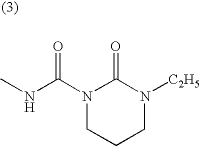 |
| I-36 | 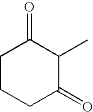 | (2) Cl | (4) Cl | 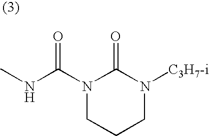 |
| I-37 | 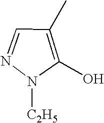 | (2) Cl | (4) Cl | 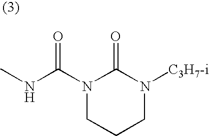 |
| I-38 | 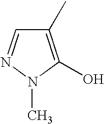 | (2) Cl | (4) Cl | 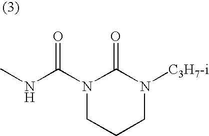 |
| I-39 | 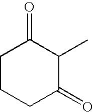 | (2) Cl | (4) Cl | 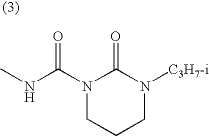 |
| I-40 | 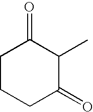 | (2) Cl | (4) Cl | 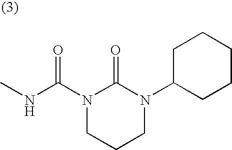 |
| I-41 | 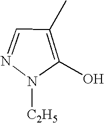 | (2) Cl | (4) Cl | 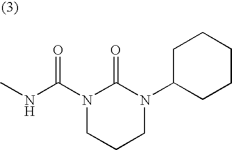 |
| I-42 | 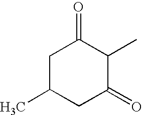 | (2) Cl | (4) Cl | 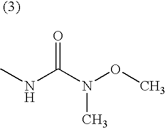 |
| I-43 | 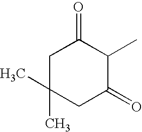 | (2) Cl | (4) Cl | 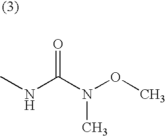 |
| I-44 | 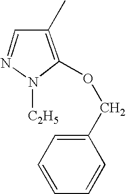 | (2) Cl | (4) Cl | 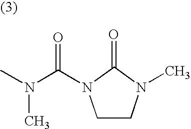 |
| I-45 | 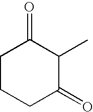 | (4) CF₃ | — | 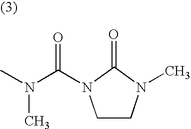 |
| I-46 | 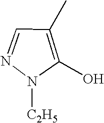 | (4) CF₃ | — | 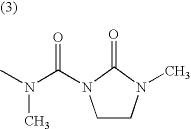 |
| I-47 | 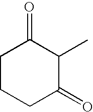 | (2) Cl | (4) Cl | 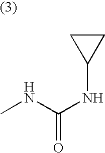 |
| I-48 | 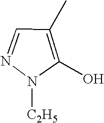 | (2) Cl | (4) Cl | 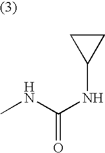 |
| I-49 | 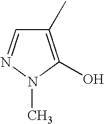 | (2) Cl | (4) Cl | 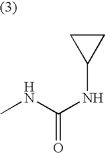 |
| I-50 | 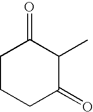 | (2) Cl | (4) Cl | 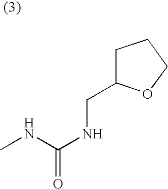 |
| I-51 | 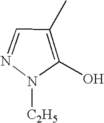 | (2) Cl | (4) Cl | 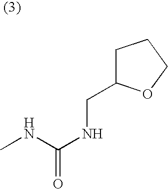 |
| I-52 | 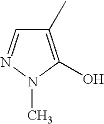 | (2) Cl | (4) Cl | 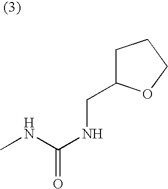 |
| I-53 | 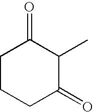 | (2) Cl | (4) Cl | 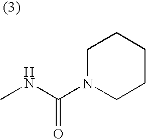 |
| I-54 | 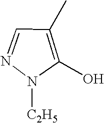 | (2) Cl | (4) Cl | 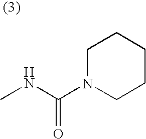 |
| I-55 | 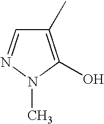 | (2) Cl | (4) Cl | 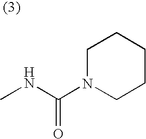 |
| I-56 | 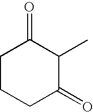 | (2) Cl | (4) Cl | 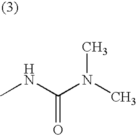 |
| I-57 | 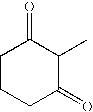 | (2) Cl | (4) Cl | 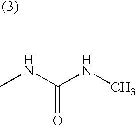 |
| I-58 | 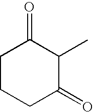 | (2) Cl | (4) Cl | 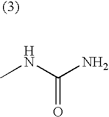 |
| I-59 | 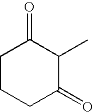 | (2) Cl | (4) Cl | 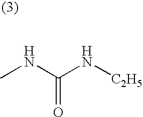 |
| I-60 | 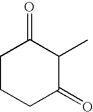 | (2) Cl | (4) Cl | 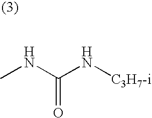 |
| I-61 | 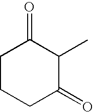 | (2) Cl | (4) Cl | 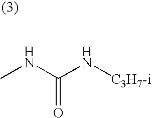 |
| I-62 | 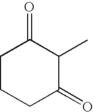 | (2) Cl | (4) Cl | 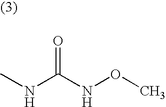 |
| I-63 | 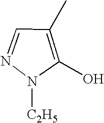 | (2) Cl | (4) Cl | 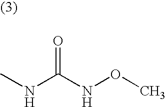 |
| I-64 | 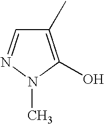 | (2) Cl | (4) Cl | 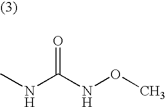 |
| I-65 | 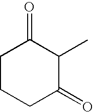 | (2) Cl | (4) Cl | 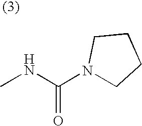 |
| I-66 | 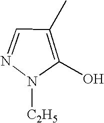 | (2) Cl | (4) Cl | 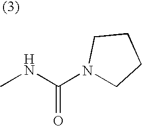 |
| I-67 | 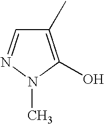 | (2) Cl | (4) Cl | 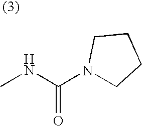 |
| I-68 | 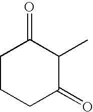 | (2) OCH₃ | — | 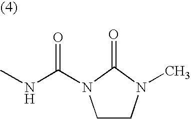 |
| I-69 | 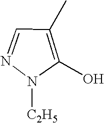 | (2) OCH₃ | — | 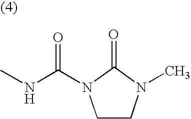 |
| I-70 | 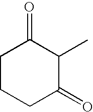 | (2) Cl | (4) Cl | 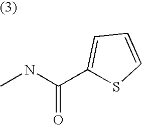 |
| I-71 | 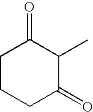 | (2) Cl | (4) Cl | 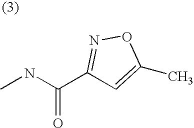 |
| I-72 | 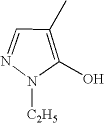 | (2) Cl | (4) Cl | 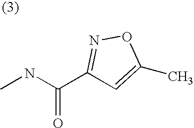 |
| I-73 | 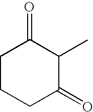 | (2) Cl | (4) SO₂CH₃ | 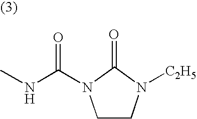 |
| I-74 | 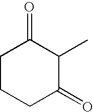 | (2) Cl | (4) SO₂CH₃ | 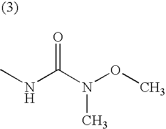 |
| I-75 | 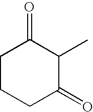 | (2) Cl | (4) SO₂CH₃ | 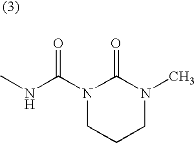 |
| I-76 | 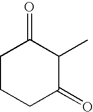 | (2) Cl | (4) SO₂CH₃ | 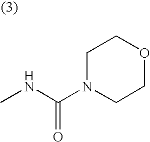 |
| I-77 | 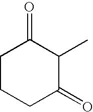 | (2) Cl | (4) SO₂CH₃ | 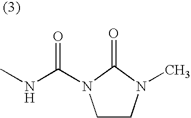 |
| I-78 | 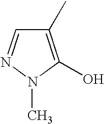 | (2) NO₂ | — | 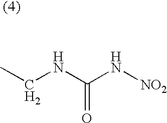 |
| I-79 | 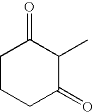 | (2) Cl | (4) Cl | 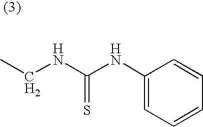 |
| I-80 | 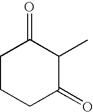 | (2) Cl | (4) Cl | 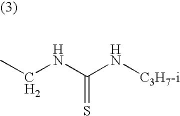 |
| I-81 | 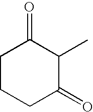 | (2) Cl | (4) Cl | 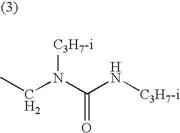 |
| I-82 | 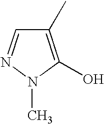 | (2) Cl | (4) Cl | 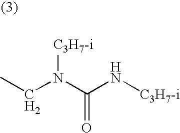 |
| I-83 | 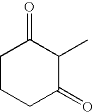 | (2) Cl | (4) Cl | 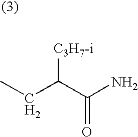 |
| I-84 | 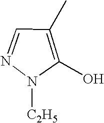 | (2) Cl | (4) Cl | 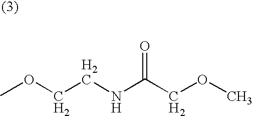 |
| I-85 | 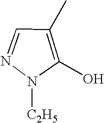 | (2) Cl | (4) Cl | 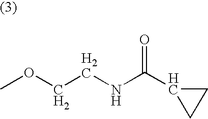 |
| I-86 | 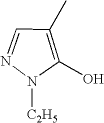 | (2) Cl | (4) Cl | 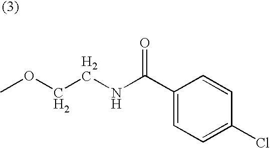 |
| I-87 | 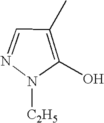 | (2) Cl | (4) Cl | 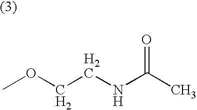 |
| I-88 | 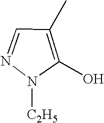 | (2) Cl | (4) Cl | 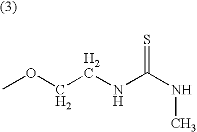 |
| I-89 | 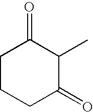 | (2) Cl | (4) Cl | 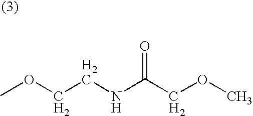 |
| I-90 | 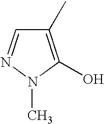 | (2) Cl | (4) Cl | 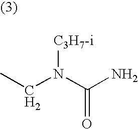 |
| I-91 | 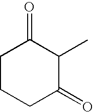 | (2) NO₂ | — | 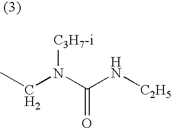 |
| I-92 | 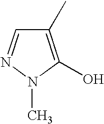 | (2) NO₂ | — | 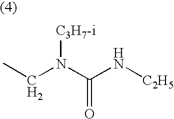 |
| I-93 | 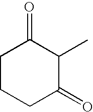 | (2) Cl | (4) Cl | 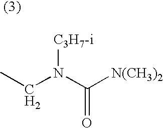 |
| I-94 | 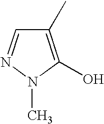 | (2) Cl | (4) Cl | 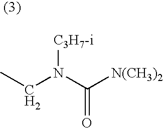 |
| I-95 | 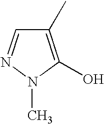 | (2) Cl | (4) Cl | 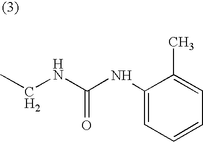 |
| I-96 | 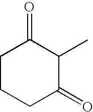 | (2) Cl | (4) Cl | 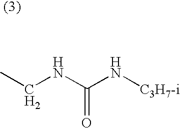 |
| I-97 | 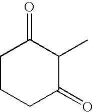 | (2) Cl | (4) Cl | 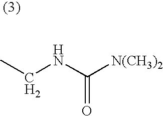 |
| I-98 | 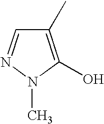 | (2) Cl | (4) Cl | 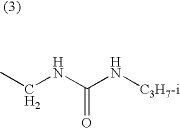 |
| I-99 | 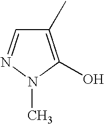 | (2) Cl | (4) Cl | 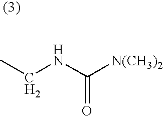 |
| I-100 | 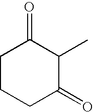 | (2) Cl | (4) Cl | 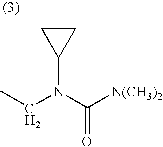 |
| I-101 | 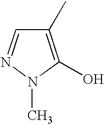 | (2) Cl | (4) Cl | 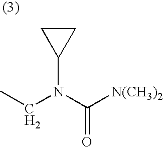 |
| I-102 | 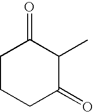 | (2) NO₂ | — | 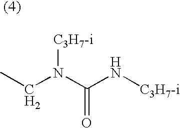 |
| I-103 | 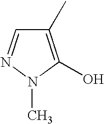 | (2) NO₂ | — | 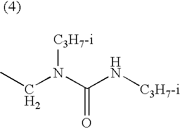 |
| I-104 | 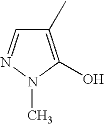 | (2) NO₂ | — | 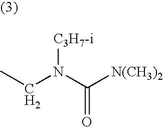 |
| I-105 | 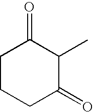 | (2) NO₂ | — | 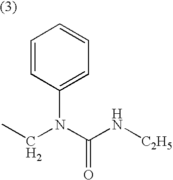 |
| I-106 | 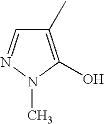 | (2) NO₂ | — | 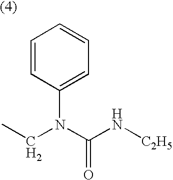 |
| I-107 | 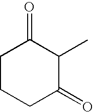 | (2) NO₂ | — | 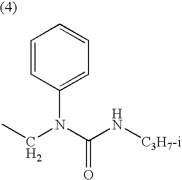 |
| I-108 | 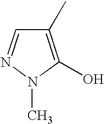 | (2) NO₂ | — | 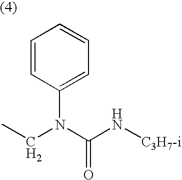 |

The compound N′-[2,6-dichloro-3-[(2,6-dioxo-cyclohexyl)-carbonyl]-phenyl]-N-methoxy-N-methyl-urea (Example I-2 in Table 1) is particularly emphasized as the mixing component of the formula (I).

The compound N′-[2,6-dichloro-3-[(1-ethyl-5-hydroxy-1H-pyrazol-4-yl)-carbonyl]-phenyl]-N-methoxy-N-methyl-urea (Example I-3 in Table 1) is likewise particularly emphasized as the mixing component of the formula (I).

The compound N′-[2,6-dichloro-3-[(5-hydroxy-1-methyl-1H-pyrazol-4-yl)-carbonyl]-phenyl]-N-methoxy-N-methyl-urea (Example I-4 in Table 1) is likewise particularly emphasized as the mixing component of the formula (I).

The compound N-[2,6-dichloro-3-[(2,6-dioxo-cyclohexyl)-carbonyl]-phenyl]-3-methyl-2-oxo-1-imidazolidine-carboxamide (Example I-7 in Table 1) is likewise particularly emphasized as the mixing component of the formula (I).

The compound N-[2,6-dichloro-3-[(2,6-dioxo-cyclohexyl)-carbonyl]-phenyl]-3-methyl-2-oxo-tetrahydro-1(2H)-pyrimidine-carboxamide (Example I-8 in Table 1) is likewise particularly emphasized as the mixing component of the formula (I).

The compound N-[2,6-dichloro-3-[(2,6-dioxo-cyclohexyl)-carbonyl]-phenyl]-4-morpholine-carboxamide (Example I-11 in Table 1) is likewise particularly emphasized as the mixing component of the formula (I).

The compound N′-[2,6-dichloro-3-(2-cyano-3-cyclopropyl-3-oxo-propanoyl)-phenyl]-N-methoxy-N-methyl-urea (Example I-29 in Table 1) is likewise particularly emphasized as the mixing component of the formula (I).

The compound N-[2,6-dichloro-3-[(2,6-dioxo-cyclohexyl)-carbonyl]-phenyl]-pyrrolidone-1-carboxamide (Example I-65 in Table 1) is likewise particularly emphasized as the mixing component of the formula (I).

The compounds of the formula (I) are described in the patent applications listed above for the substituted aryl ketones.

The novel substituted aryl ketones of the formula (I) are obtained when
(a) amino compounds of the general formula (II) 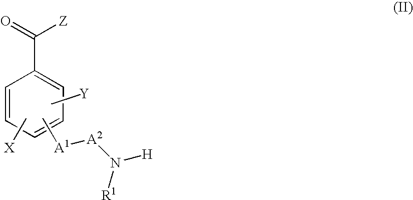
   in which
A¹ , A², R¹, X, Y and Z have the meaning given above,
   are reacted with compounds of the general formula (III) 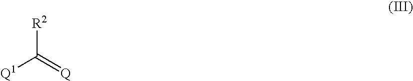
   in which
Q and R² have the meaning give above and
Q¹ represents halogen, alkoxy, alkylthio, aryloxy or arylthio, preferably chlorine, bromine, methoxy, ethoxy, methylthio, ethylthio, phenyloxy or phenylthio,
or, if appropriate, with corresponding iso(thio)cyanates,
if appropriate in the presence of one or more reaction auxiliaries, such as, for example, potassium carbonate or triethylamine, and, if appropriate, in the presence of one or more diluents, such as, for example, acetonitrile, N,N-dimethyl-formamide or methanol, at temperatures between 0° C. and 150° C (cf. the Preparation Examples),
   or when
(b) carboxylic acids of the general formula (IV) 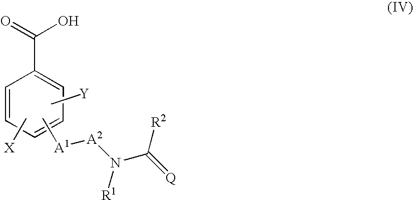
   in which
A¹, A², Q, R¹, R², X and Y have the meaning given above
or reactive derivatives thereof, such as, for example, corresponding acid halides, acid cyanides or esters
   are reacted with compounds of the general formula (V)
   H-Z (V)
   in which
Z has the meaning given above,
if appropriate in the presence of a dehydrating agent, such as, for example, dicyclohexylcarbodiimide, and, if appropriate, in the presence of one or more reaction auxiliaries, such as, for example, triethylamine and trimethylsilyl cyanide, and, if appropriate, in the presence of one or more diluents, such as, for example, acetonitrile, at temperatures between 0° C. and 150° C. (cf. the Preparation Examples),
and subsequent reactions within the scope of the above definition of substituents (for example substitution, oxidation or reduction reactions) are carried but, if appropriate, by customary methods on the resulting compounds of the general formula (I) for conversion into other compounds of the general formula (I) following process (a) or (b).

According to their chemical structure, the active compounds of Group 2 can be assigned to the following classes of active compounds:
amides (for example isoxaben, picolinafen, propanil), arylheterocycles (for example azafenidin, benzfendizone, butafenacil-allyl, carfentrazone-ethyl, cinidon-ethyl, fluazolate, flumiclorac-pentyl, flumioxazin, flupropacil, fluthiacet-methyl, oxadiazon, oxadiargyl, profluazol, pyraflufen-ethyl, pyridate, pyridafol, sulfentrazone, thidiazimin, 4-[4,5-dihydro-4-methyl-5-oxo-(3-trifluoromethyl)-1H-1,2,4-triazol-1-yl]-2-[(ethylsulphonyl)amino]-5-fluoro-benzenecarbothioamide), aryloxyphenoxypropionates (for example clodinafop-propargyl, cyhalofop-butyl, diclofop-methyl, fenoxaprop-P-ethyl, fluazifop-P-butyl, haloxyfop-R-methyl, quizalofop-P-ethyl), carboxylic acid derivatives (for example clopyralid, dicamba, fluroxypyr,. picloram, triclopyr), benzothiadiazoles (for example bentazon), chloroacetamides (for example acetochlor, alachlor, butachlor, (S—) dimethenamid, metazachlor, metolachlor, pretilachlor, propachlor, propisochlor), cyclohexanediones (for example butroxydim, clefoxydim, cycloxydim, sethoxydim, tralkoxydim), dinitroanilines (for example benfluralin, ethalfluralin, oryzalin, pendimethalin, trifluralin), diphenyl ethers (for example acifluorfen-sodium, aclonifen, bifenox, fluoroglycofen-ethyl, fomesafen, lactofen, oxyfluorfen), ureas (for example chlortoluron, diuron, isoproturon, linuron, metobromuron, metoxuron), imidazolinones (for example imazamethabenz-methyl, imazamox, imazaquin, imazethapyr), isoxazoles (for example isoxaflutole), nicotinanilides (for example diflufenican), nitriles (for example bromoxynil, ioxynil), organophosphorus compounds (for example glufosinate-ammonium, glypbosate-isopropylammonium, sulfosate), oxyacetamides (for example flufenacet, mefenacet), phenoxycarboxylic acid derivatives (for example 2,4-D, dichlorprop-P, MCPA, MCPB, mecoprop), pyrazoles (for example pyrazolate, pyrazoxyfen), pyridazinones (for example norflurazon), pyridines (for example dithiopyr, thiazopyr), pyrimidinyl(thio)benzoates (for example bispyribac, pyribenzoxim, pyrithiobac, pyriminobac), sulphonylureas (for example amidosulfuron, azimsulfuron, bensulfuron-methyl, chlorimuron-ethyl, chlorsulfuron, cinosulfuron, cyclosulfamuron, ethoxysulfuron, flupyrsulfuron-methyl-sodium, foramsulfuron, iodosulfuron-methyl-sodium, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuronmethyl, trifloxysulfuron, triflusulfuron-methyl, tritosulfuron), tetrazolinones (for example fentrazamide), thiocarbamates (for example butylate, dimepiperate, EPTC, esprocarb, molinate, orbencarb, prosulfocarb, triallate), triazines (for example ametryn, atrazine, cyanazine, dimexyflam, simazine, terbuthylazine, terbutryn), triazinones (for example hexazinone, metamitron, metribuzin), triazoles (for example amitrole), triazolinones (for example amicarbazone, flucarbazone-sodium, propoxycarbazone-sodium) triazolopyrimidines (for example cloransulam-methyl, diclosulam, florasulam, flumetsulam, metosulam), triketones (for example mesotrione, sulcotrione), uracils (for example bromacil).

Mixing components from the active compounds of Group 2 which are particularly emphasized are:
acetochlor, alachlor, amicarbazone, amidosulfuron, anilofos, atrazine, azimsulfuron, benfuresate, bensulfuron-methyl, bentazone, benthiocarb (thiobencarb), benzobicyclon, benzofenap, bifenox, bispyribac-sodium, bromobutide, butachlor, butamifos, butenachlor, cafenstrole, carfentrazone-ethyl, chlomethoxyfen, chlomitrofen, cinmethylin, cinosulfuron, clefoxydim, clodinafop-propargyl, clomazone, clomeprop, cumyluron, cyanazine, cyclosulfamuron, cyhalofop-butyl, 2,4-D, dichlorprop-P, diethatyl-ethyl, dimepiperate, dimethametryn, dimethenamid, S-dimethenamid, dithiopyr, dymron (daimuron, dimuron), esprocarb, ethoxysulfuron, etobenzanid, fenoxaprop-(P)-ethyl, fentrazamide, fluazifop-P-butyl, flucarbazonesodium, flufenacet, flumetsulam, halosulfuron-methyl, haloxyfop-P-methyl, HOK-201, imazamox, imazaquin, imazethapyr, imazosulfuron, indanofan, isoxaflutole, MCPA, mefenacet, mesosulfuron, mesotrione, metolachlor, S-metolachlor, metosulam, metsulfuron-methyl, metribuzin, molinate, naproanilide, nicosulfuron, OK-701, oxadiargyl, oxadiazon, oxaziclomefone, oxyfluorfen, pendimethalin, pentoxazone, piperophos, pretilachlor, profoxydim, propanil, propoxycarbazone-sodium, pyraclonil, pyrazolate, pyrazosulfuron-ethyl, pyrazoxyfen, pyribenzoxim, pyributicarb, pyriftalid, pyriminobac-methyl, qinclorac, quinoclamine, simazine, simetryn, sulcotrione, terbuthylazine, thenylchlor, thifensulfuron-methyl, tiocarbazil, tritosulfuron.

The compositions according to the invention preferably comprise one or two active compounds from group 1 and additionally 1, 2, 3 or 4 active compounds from group 2 and/or one active compound from group 3.

The compositions according to the invention particularly preferably comprise one active compound from group 1 and additionally 1, 2 or 3 active compounds from group 2 and/or one active compound from group 3.

The compositions according to the invention very particularly preferably comprise one active compound from group 1 and additionally 1, 2 or 3 active compounds from group 2 and/or one active compound from group 3.

Examples of combinations according to the invention of in each case one active compound from group 1 and additionally 1, 2 or 3 active compounds from group 2 and/or one active compound from group 3—are listed below in Table 2. Here, the names of the active compounds of the formula (I) (active compounds of group 1) are in each case taken from Table 1.

TABLE 2
Examples of combinations comprising one active
compound from group 1 and 1, 2 or 3 active
compounds from group 2 and/or one compound
from group 3

| Active compound | |
|---|---|
| from group 1 | Active compound from group 2 and/or 3 |
| (I-2) | acetochlor |
| (I-2) | acetochlor + dichlormid |
| (I-2) | acetochlor + furilazole |
| (I-2) | acetochlor + R-29148 |
| (I-2) | alachlor |
| (I-2) | amicarbazone |
| (I-2) | amidosulfuron |
| (I-2) | anilofos |
| (I-2) | anilofos + 2,4-D |
| (I-2) | anilofos + propanil |
| (I-2) | anilofos + quinoclamine |
| (I-2) | atrazine |
| (I-2) | azimsulfuron |
| (I-2) | azimsulfuron + dymron |
| (I-2) | azimsulfuron + anilofos |
| (I-2) | azimsulfuron + benfuresate |
| (I-2) | azimsulfuron + bensulfuron |
| (I-2) | azimsulfuron + butachlor |
| (I-2) | azimsulfuron + cafenstrole |
| (I-2) | azimsulfuron + cyhalofop-butyl |
| (I-2) | azimsulfuron + dimepiperate |
| (I-2) | azimsulfuron + esprocarb |
| (I-2) | azimsulfuron + mefenacet |
| (I-2) | azimsulfuron + indanofan |
| (I-2) | azimsulfuron + oxaziclomefone |
| (I-2) | azimsulfuron + pretilachlor |
| (I-2) | azimsulfuron + thenylchlor |
| (I-2) | azimsulfuron + anilofos + dymron |
| (I-2) | azimsulfuron + benfuresate + dymron |
| (I-2) | azimsulfuron + bensulfuron + cafenstrole |
| (I-2) | azimsulfuron + bensulfuron + cyhalofop-butyl |
| (I-2) | azimsulfuron + bensulfuron + dymron |
| (I-2) | azimsulfuron + bensulfuron + dimethametryn |
| (I-2) | azimsulfuron + bensulfuron + indanofan |
| (I-2) | azimsulfuron + bensulfuron + pretilachlor |
| (I-2) | azimsulfuron + bensulfuron + thenylchlor |
| (I-2) | azimsulfuron + butachlor + dymron |
| (I-2) | azimsulfuron + cafenstrole + dymron |
| (I-2) | azimsulfuron + cyhalofop-butyl + dymron |
| (I-2) | azimsulfuron + mefenacet + dymron |
| (I-2) | azimsulfuron + oxaziclomefone + dymron |
| (I-2) | azimsulfuron + pretilachlor + dymron |
| (I-2) | benfuresate |
| (I-2) | bensulfuron-methyl |
| (I-2) | bensulfuron-methyl + dymron |
| (I-2) | bensulfuron-methyl + anilofos |
| (I-2) | bensulfuron-methyl + benfuresate |
| (I-2) | bensulfuron-methyl + butachlor |
| (I-2) | bensulfuron-methyl + cafenstrole |
| (I-2) | bensulfuron-methyl + cyhalofop-butyl |
| (I-2) | bensulfuron-methyl + dimepiperate |
| (I-2) | bensulfuron-methyl + dithiopyr |
| (I-2) | bensulfuron-methyl + esprocarb |
| (I-2) | bensulfuron-methyl + indanofan |
| (I-2) | bensulfuron-methyl + mefenacet |
| (I-2) | bensulfuron-methyl + metsulfuron-methyl |
| (I-2) | bensulfuron-methyl + molinate |
| (I-2) | bensulfuron-methyl + oxaziclomefone |
| (I-2) | bensulfuron-methyl + pretilachlor |
| (I-2) | bensulfuron-methyl + pyributicarb |
| (I-2) | bensulfuron-methyl + quinclorac |
| (I-2) | bensulfuron-methyl + thenylchlor |
| (I-2) | bensulfuron-methyl + anilofos + dymron |
| (I-2) | bensulfuron-methyl + benfuresate + dymron |
| (I-2) | bensulfuron-methyl + butachlor + dymron |
| (I-2) | bensulfuron-methyl + benfuresate + dimepiperate |
| (I-2) | bensulfuron-methyl + benfuresate + pretilachlor |
| (I-2) | bensulfuron-methyl + cafenstrole + dymron |
| (I-2) | bensulfuron-methyl + cafenstrole + cyhalofop-butyl |
| (I-2) | bensulfuron-methyl + cyhalofop-butyl + dymron |
| (I-2) | bensulfuron-methyl + cyhalofop-butyl + thenylchlor |
| (I-2) | bensulfuron-methyl + dithiopyr + quinclorac |
| (I-2) | bensulfuron-methyl + mefenacet + dymron |
| (I-2) | bensulfuron-methyl + mefenacet + benthiocarb |
| (I-2) | bensulfuron-methyl + mefenacet + molinate |
| (I-2) | bensulfuron-methyl + oxaziclomefone + dymron |
| (I-2) | bensulfuron-methyl + pretilachlor + dymron |
| (I-2) | bensulfuron-methyl + pyributicarb + dymron |
| (I-2) | bentazone |
| (I-2) | bentazone + quinclorac |
| (I-2) | benthiocarb (thiobencarb) |
| (I-2) | benthiocarb + chlornitrofen |
| (I-2) | benthiocarb + propanil |
| (I-2) | benthiocarb + simetryn |
| (I-2) | benzobicyclon |
| (I-2) | benzofenap |
| (I-2) | benzofenap + thenylchlor + cumyluron |
| (I-2) | bifenox |
| (I-2) | bifenox + pretilachlor |
| (I-2) | bifenox + thenylchlor |
| (I-2) | bispyribac-sodium |
| (I-2) | bispyribac-sodium + benthiocarb |
| (I-2) | bromobutide |
| (I-2) | bromobutide + pyrazoxyfen |
| (I-2) | bromobutide + benzofenap + pyributicarb |
| (I-2) | bromobutide + bifenox + pyrazolate |
| (I-2) | bromobutide + pyrazoxyfen + thenylchlor |
| (I-2) | butachlor |
| (I-2) | butachlor + chlomethoxyfen |
| (I-2) | butachlor + oxadiazon |
| (I-2) | butachlor + propanil |
| (I-2) | butachlor + pyrazolate |
| (I-2) | butamifos |
| (I-2) | butamifos + bromobutide |
| (I-2) | butenachlor |
| (I-2) | cafenstrole |
| (I-2) | cafenstrole + dymron |
| (I-2) | cafenstrole + cyhalofop-butyl + dymron |
| (I-2) | carfentrazone-ethyl |
| (I-2) | chlomethoxyfen |
| (I-2) | chlornitrofen |
| (I-2) | chlornitrofen + dymron |
| (I-2) | cinmethylin |
| (I-2) | cinmethylin + 2,4-D |
| (I-2) | cinosulfuron |
| (I-2) | cinosulfuron + dymron |
| (I-2) | cinosulfuron + anilofos |
| (I-2) | cinosulfuron + benfuresate |
| (I-2) | cinosulfuron + butachlor |
| (I-2) | cinosulfuron + cafenstrole + dymron |
| (I-2) | cinosulfuron + cyhalofop-butyl |
| (I-2) | cinosulfuron + dimepiperate |
| (I-2) | cinosulfuron + esprocarb |
| (I-2) | cinosulfuron + mefenacet |
| (I-2) | cinosulfuron + mefenacet + dymron |
| (I-2) | cinosulfuron + molinate |
| (I-2) | cinosulfuron + oxaziclomefone |
| (I-2) | cinosulfuron + pretilachlor |
| (I-2) | cinosulfuron + pretilachlor + dymron |
| (I-2) | cinosulfuron + pretilachlor + fenclorim |
| (I-2) | cinosulfuron + pretilachlor + quinclorac |
| (I-2) | cinosulfuron + pyriftalid |
| (I-2) | clefoxydim |
| (I-2) | clodinafop-propargyl |
| (I-2) | clodinafop-propargyl + cloquintocet-mexyl |
| (I-2) | clomazone |
| (I-2) | clomazone + propanil |
| (I-2) | clomeprop |
| (I-2) | clomeprop + pretilachlor |
| (I-2) | cumyluron |
| (I-2) | cyanazine |
| (I-2) | cyclosulfamuron |
| (I-2) | cyclosulfamuron + dymron |
| (I-2) | cyclosulfamuron + anilofos |
| (I-2) | cyclosulfamuron + benfuresate |
| (I-2) | cyclosulfamuron + butachlor |
| (I-2) | cyclosulfamuron + cafenstrole + dymron |
| (I-2) | cyclosulfamuron + cyhalofop-butyl |
| (I-2) | cyclosulfamuron + dimepiperate |
| (I-2) | cyclosulfamuron + esprocarb |
| (I-2) | cyclosulfamuron + mefenacet |
| (I-2) | cyclosulfamuron + mefenacet + dymron |
| (I-2) | cyclosulfamuron + oxaziclomefone |
| (I-2) | cyclosulfamuron + pentoxazone |
| (I-2) | cyclosulfamuron + pretilachlor |
| (I-2) | cyclosulfamuron + quinclorac |
| (I-2) | cyhalofop-butyl |
| (I-2) | cyhalofop-butyl + bentazon |
| (I-2) | 2,4-D |
| (I-2) | dichlorprop-P |
| (I-2) | diethatyl-ethyl |
| (I-2) | dimepiperate |
| (I-2) | dimethametryn |
| (I-2) | dimethametryn + piperophos |
| (I-2) | dimethenamid |
| (I-2) | S-dimethenamid |
| (I-2) | dithiopyr |
| (I-2) | dymron |
| (I-2) | esprocarb |
| (I-2) | ethoxysulfuron |
| (I-2) | ethoxysulfuron + dymron |
| (I-2) | ethoxysulfuron + anilofos |
| (I-2) | ethoxysulfuron + anilofos + dymron |
| (I-2) | ethoxysulfuron + benfuresate |
| (I-2) | ethoxysulfuron + anilofos + benfuresate |
| (I-2) | ethoxysulfuron + benfuresate + dymron |
| (I-2) | ethoxysulfuron + butachlor |
| (I-2) | ethoxysulfuron + cafenstrole |
| (I-2) | ethoxysulfuron + cafenstrole + dymron |
| (I-2) | ethoxysulfuron + cyhalofop-butyl |
| (I-2) | ethoxysulfuron + dimepiperate |
| (I-2) | ethoxysulfuron + esprocarb |
| (I-2) | ethoxysulfuron + mefenacet |
| (I-2) | ethoxysulfuron + mefenacet + dymron |
| (I-2) | ethoxysulfuron + oxaziclomefone |
| (I-2) | ethoxysulfuron + pretilachlor + dymron |
| (I-2) | ethoxysulfuron + pretilachlor + pyrazolate |
| (I-2) | etobenzanid |
| (I-2) | fenoxaprop-(P)-ethyl |
| (I-2) | fenoxaprop-(P)-ethyl + fenclorim |
| (I-2) | fenoxaprop-(P)-ethyl + isoxadifen-ethyl |
| (I-2) | fenoxaprop-(P)-ethyl + mefenpyr-diethyl |
| (I-2) | fentrazamide |
| (I-2) | fentrazamide + pentoxazone |
| (I-2) | fentrazamide + bispyribac-sodium |
| (I-2) | fentrazamide + bromobutide |
| (I-2) | fentrazamide + benzofenap |
| (I-2) | fentrazamide + clomeprop |
| (I-2) | fentrazamide + dymron |
| (I-2) | fentrazamide + flufenacet |
| (I-2) | fentrazamide + oxaziclomefone |
| (I-2) | fentrazamide + propanil |
| (I-2) | fentrazamide + pyribenzoxim |
| (I-2) | fentrazamide + pyriminobac-methyl |
| (I-2) | fentrazamide + quinoclamine |
| (I-2) | fentrazamide + azimsulfuron |
| (I-2) | fentrazamide + azimsulfuron + dymron |
| (I-2) | fentrazamide + azimsulfuron + bensulfuron-methyl |
| (I-2) | fentrazamide + bensulfuron-methyl |
| (I-2) | fentrazamide + bensulfuron-methyl + dymron |
| (I-2) | fentrazamide + cinosulfuron |
| (I-2) | fentrazamide + cinosulfuron + dymron |
| (I-2) | fentrazamide + cyclosulfamuron |
| (I-2) | fentrazamide + cyclosulfamuron + dymron |
| (I-2) | fentrazamide + ethoxysulfuron |
| (I-2) | fentrazamide + ethoxysulfuron + dymron |
| (I-2) | fentrazamide + imazosulfuron |
| (I-2) | fentrazamide + imazosulfuron + dymron |
| (I-2) | fentrazamide + pyrazosulfuron-ethyl |
| (I-2) | fentrazamide + pyrazosulfuron-ethyl + dymron |
| (I-2) | fluazifop-P-butyl |
| (I-2) | flucarbazone-sodium |
| (I-2) | flucarbazone-sodium + fenclorim |
| (I-2) | flucarbazone-sodium + isoxadifen-ethyl |
| (I-2) | flucarbazone-sodium + mefenpyr-diethyl |
| (I-2) | flufenacet |
| (I-2) | flufenacet + 2,4-D |
| (I-2) | flufenacet + diflufenican |
| (I-2) | flufenacet + metosulam |
| (I-2) | flufenacet + propanil |
| (I-2) | flufenacet + dichlormid |
| (I-2) | flufenacet + furilazole |
| (I-2) | flufenacet + R-29148 |
| (I-2) | flufenacet + fenclorim |
| (I-2) | flufenacet + isoxadifen-ethyl |
| (I-2) | flufenacet + mefenpyr-diethyl |
| (I-2) | flumetsulam |
| (I-2) | halosulfuron-methyl |
| (I-2) | halosulfuron-methyl + cafenstrole + cyhalofop-butyl |
| (I-2) | halosulfuron-methyl + cafenstrole + dymron |
| (I-2) | halosulfuron-methyl + cyhalofop-butyl + dymron |
| (I-2) | haloxyfop-P-methyl |
| (I-2) | HOK-201 |
| (I-2) | imazamox |
| (I-2) | imazaquin |
| (I-2) | imazethapyr |
| (I-2) | imazosulfuron |
| (I-2) | imazosulfuron + dymron |
| (I-2) | imazosulfuron + anilofos |
| (I-2) | imazosulfuron + benfuresate |
| (I-2) | imazosulfuron + butachlor |
| (I-2) | imazosulfuron + cafenstrole + dymron |
| (I-2) | imazosulfuron + cyhalofop-butyl |
| (I-2) | imazosulfuron + dimepiperate |
| (I-2) | imazosulfuron + dimethametryn |
| (I-2) | imazosulfuron + dimethametryn + pretilachlor |
| (I-2) | imazosulfuron + esprocarb + dymron |
| (I-2) | imazosulfuron + etobenzanid + dymron |
| (I-2) | imazosulfuron + mefenacet + dymron |
| (I-2) | imazosulfuron + oxaziclomefone |
| (I-2) | imazosulfuron + pentoxazone + dymron |
| (I-2) | imazosulfuron + pretilachlor + dymron |
| (I-2) | imazosulfuron + pyributicarb + dymron |
| (I-2) | indanofan |
| (I-2) | isoxaflutole |
| (I-2) | MCPA |
| (I-2) | mefenacet |
| (I-2) | mefenacet + molinate |
| (I-2) | mefenacet + quinoclamine |
| (I-2) | mefenacet + bromobutide + naproanilide |
| (I-2) | mesosulfuron |
| (I-2) | mesosulfuron + dymron |
| (I-2) | mesosulfuron + anilofos |
| (I-2) | mesosulfuron + benfuresate |
| (I-2) | mesosulfuron + cafenstrole + dymron |
| (I-2) | mesosulfuron + cyhalofop-butyl |
| (I-2) | mesosulfuron + dimepiperate |
| (I-2) | mesosulfuron + esprocarb |
| (I-2) | mesosulfuron + mefenacet |
| (I-2) | mesosulfuron + mefenacet + dymron |
| (I-2) | mesosulfuron + oxaziclomefone |
| (I-2) | mesosulfuron + pretilachlor |
| (I-2) | mesosulfuron + pyributicarb |
| (I-2) | mesotrione |
| (I-2) | metolachlor |
| (I-2) | metolachlor + benoxacor |
| (I-2) | S-metolachlor |
| (I-2) | S-metolachlor + benoxacor |
| (I-2) | metosulam |
| (I-2) | metsulfuron-methyl |
| (I-2) | metribuzin |
| (I-2) | molinate |
| (I-2) | molinate + propanil |
| (I-2) | molinate + simetryn |
| (I-2) | naproanilide |
| (I-2) | nicosulfuron |
| (I-2) | OK-701 |
| (I-2) | oxadiargyl |
| (I-2) | oxadiargyl + propanil |
| (I-2) | oxadiazon |
| (I-2) | oxaziclomefone |
| (I-2) | oxyfluorfen |
| (I-2) | pendimethalin |
| (I-2) | pentoxazone |
| (I-2) | pentoxazone + cumyluron |
| (I-2) | piperophos |
| (I-2) | piperophos + 2,4-D |
| (I-2) | pretilachlor |
| (I-2) | pretilachlor + dimethametryn |
| (I-2) | pretilachlor + dymron |
| (I-2) | pretilachlor + dimethametryn + dymron |
| (I-2) | pretilachlor + fenclorim |
| (I-2) | profoxydim |
| (I-2) | propanil |
| (I-2) | propoxycarbazone-sodium |
| (I-2) | pyraclonil |
| (I-2) | pyrazolate |
| (I-2) | pyrazolate + butachlor |
| (I-2) | pyrazolate + pretilachlor |
| (I-2) | pyrazosulfuron-ethyl |
| (I-2) | pyrazosulfuron-ethyl + dymron |
| (I-2) | pyrazosulfuron-ethyl + indanofan |
| (I-2) | pyrazosulfuron-ethyl + etobenzanid |
| (I-2) | pyrazosulfuron-ethyl + esprocarb |
| (I-2) | pyrazosulfuron-ethyl + esprocarb + dimethametryn |
| (I-2) | pyrazosulfuron-ethyl + esprocarb + pretilachlor |
| (I-2) | pyrazosulfuron-ethyl + mefenacet |
| (I-2) | pyrazosulfuron-ethyl + molinate |
| (I-2) | pyrazosulfuron-ethyl + pentoxazone |
| (I-2) | pyrazosulfuron-ethyl + anilofos + dymron |
| (I-2) | pyrazosulfuron-ethyl + benfuresate + dymron |
| (I-2) | pyrazosulfuron-ethyl + butachlor + dymron |
| (I-2) | pyrazosulfuron-ethyl + cafenstrole |
| (I-2) | pyrazosulfuron-ethyl + cafenstrole + cyhalofop-butyl |
| (I-2) | pyrazosulfuron-ethyl + dimepiperate + dymron |
| (I-2) | pyrazosulfuron-ethyl + dithiopyr + esprocarb |
| (I-2) | pyrazosulfuron-ethyl + mefenacet + dymron |
| (I-2) | pyrazosulfuron-ethyl + oxaziclomefone + dymron |
| (I-2) | pyrazosulfuron-ethyl + pretilachlor |
| (I-2) | pyrazosulfuron-ethyl + pretilachlor + quinclorac |
| (I-2) | pyrazosulfuron-ethyl + thenylchlor |
| (I-2) | pyrazoxyfen |
| (I-2) | pyribenzoxim |
| (I-2) | pyributicarb |
| (I-2) | pyributicarb + pretilachlor |
| (I-2) | pyriftalid |
| (I-2) | pyriminobac-methyl |
| (I-2) | quinclorac |
| (I-2) | quinoclamine |
| (I-2) | simazine |
| (I-2) | simetryn |
| (I-2) | sulcotrione |
| (I-2) | terbuthylazine |
| (I-2) | thenylchlor |
| (I-2) | thifensulfuron-methyl |
| (I-2) | tiocarbazil |
| (I-2) | tritosulfuron |
| (I-3) | acetochlor |
| (I-3) | acetochlor + dichlormid |
| (I-3) | acetochlor + furilazole |
| (I-3) | acetochlor + R-29148 |
| (I-3) | alachlor |
| (I-3) | amicarbazone |
| (I-3) | amidosulfuron |
| (I-3) | anilofos |
| (I-3) | anilofos + 2,4-D |
| (I-3) | anilofos + propanil |
| (I-3) | anilofos + quinoclamine |
| (I-3) | atrazine |
| (I-3) | azimsulfuron |
| (I-3) | azimsulfuron + dymron |
| (I-3) | azimsulfuron + anilofos |
| (I-3) | azimsulfuron + benfuresate |
| (I-3) | azimsulfuron + bensulfuron |
| (I-3) | azimsulfuron + butachlor |
| (I-3) | azimsulfuron + cafenstrole |
| (I-3) | azimsulfuron + cyhalofop-butyl |
| (I-3) | azimsulfuron + dimepiperate |
| (I-3) | azimsulfuron + esprocarb |
| (I-3) | azimsulfuron + mefenacet |
| (I-3) | azimsulfuron + indanofan |
| (I-3) | azimsulfuron + oxaziclomefone |
| (I-3) | azimsulfuron + pretilachlor |
| (I-3) | azimsulfuron + thenylchlor |
| (I-3) | azimsulfuron + anilofos + dymron |
| (I-3) | azimsulfuron + benfuresate + dymron |
| (I-3) | azimsulfuron + bensulfuron + cafenstrole |
| (I-3) | azimsulfuron + bensulfuron + cyhalofop-butyl |
| (I-3) | azimsulfuron + bensulfuron + dymron |
| (I-3) | azimsulfuron + bensulfuron + dimethametryn |
| (I-3) | azimsulfuron + bensulfuron + indanofan |
| (I-3) | azimsulfuron + bensulfuron + pretilachlor |
| (I-3) | azimsulfuron + bensulfuron + thenylchlor |
| (I-3) | azimsulfuron + butachlor + dymron |
| (I-3) | azimsulfuron + cafenstrole + dymron |
| (I-3) | azimsulfuron + cyhalofop-butyl + dymron |
| (I-3) | azimsulfuron + mefenacet + dymron |
| (I-3) | azimsulfuron + oxaziclomefone + dymron |
| (I-3) | azimsulfuron + pretilachlor + dymron |
| (I-3) | benfuresate |
| (I-3) | bensulfuron-methyl |
| (I-3) | bensulfuron-methyl + dymron |
| (I-3) | bensulfuron-methyl + anilofos |
| (I-3) | bensulfuron-methyl + benfuresate |
| (I-3) | bensulfuron-methyl + butachlor |
| (I-3) | bensulfuron-methyl + cafenstrole |
| (I-3) | bensulfuron-methyl + cyhalofop-butyl |
| (I-3) | bensulfuron-methyl + dimepiperate |
| (I-3) | bensulfuron-methyl + dithiopyr |
| (I-3) | bensulfuron-methyl + esprocarb |
| (I-3) | bensulfuron-methyl + indanofan |
| (I-3) | bensulfuron-methyl + mefenacet |
| (I-3) | bensulfuron-methyl + metsulfuron-methyl |
| (I-3) | bensulfuron-methyl + molinate |
| (I-3) | bensulfuron-methyl + oxaziclomefone |
| (I-3) | bensulfuron-methyl + pretilachlor |
| (I-3) | bensulfuron-methyl + pyributicarb |
| (I-3) | bensulfuron-methyl + quinclorac |
| (I-3) | bensulfuron-methyl + thenylchlor |
| (I-3) | bensulfuron-methyl + anilofos + dymron |
| (I-3) | bensulfuron-methyl + benfuresate + dymron |
| (I-3) | bensulfuron-methyl + butachlor + dymron |
| (I-3) | bensulfuron-methyl + benfuresate + dimepiperate |
| (I-3) | bensulfuron-methyl + benfuresate + pretilachlor |
| (I-3) | bensulfuron-methyl + cafenstrole + dymron |
| (I-3) | bensulfuron-methyl + cafenstrole + cyhalofop-butyl |
| (I-3) | bensulfuron-methyl + cyhalofop-butyl + dymron |
| (I-3) | bensulfuron-methyl + cyhalofop-butyl + thenylchlor |
| (I-3) | bensulfuron-methyl + dithiopyr + quinclorac |
| (I-3) | bensulfuron-methyl + mefenacet + dymron |
| (I-3) | bensulfuron-methyl + mefenacet + benthiocarb |
| (I-3) | bensulfuron-methyl + mefenacet + molinate |
| (I-3) | bensulfuron-methyl + oxaziclomefone + dymron |
| (I-3) | bensulfuron-methyl + pretilachlor + dymron |
| (I-3) | bensulfuron-methyl + pyributicarb + dymron |
| (I-3) | bentazone |
| (I-3) | bentazone + quinclorac |
| (I-3) | benthiocarb (thiobencarb) |
| (I-3) | benthiocarb + chlornitrofen |
| (I-3) | benthiocarb + propanil |
| (I-3) | benthiocarb + simetryn |
| (I-3) | benzobicyclon |
| (I-3) | benzofenap |
| (I-3) | benzofenap + thenylchlor + cumyluron |
| (I-3) | bifenox |
| (I-3) | bifenox + pretilachlor |
| (I-3) | bifenox + thenylchlor |
| (I-3) | bispyribac-sodium |
| (I-3) | bispyribac-sodium + benthiocarb |
| (I-3) | bromobutide |
| (I-3) | bromobutide + pyrazoxyfen |
| (I-3) | bromobutide + benzofenap + pyributicarb |
| (I-3) | bromobutide + bifenox + pyrazolate |
| (I-3) | bromobutide + pyrazoxyfen + thenylchlor |
| (I-3) | butachlor |
| (I-3) | butachlor + chlomethoxyfen |
| (I-3) | butachlor + oxadiazon |
| (I-3) | butachlor + propanil |
| (I-3) | butachlor + pyrazolate |
| (I-3) | butamifos |
| (I-3) | butamifos + bromobutide |
| (I-3) | butenachlor |
| (I-3) | cafenstrole |
| (I-3) | cafenstrole + dymron |
| (I-3) | cafenstrole + cyhalofop-butyl + dymron |
| (I-3) | carfentrazone-ethyl |
| (I-3) | chlomethoxyfen |
| (I-3) | chlornitrofen |
| (I-3) | chlornitrofen + dymron |
| (I-3) | cinmethylin |
| (I-3) | cinmethylin + 2,4-D |
| (I-3) | cinosulfuron |
| (I-3) | cinosulfuron + dymron |
| (I-3) | cinosulfuron + anilofos |
| (I-3) | cinosulfuron + benfuresate |
| (I-3) | cinosulfuron + butachlor |
| (I-3) | cinosulfuron + cafenstrole + dymron |
| (I-3) | cinosulfuron + cyhalofop-butyl |
| (I-3) | cinosulfuron + dimepiperate |
| (I-3) | cinosulfuron + esprocarb |
| (I-3) | cinosulfuron + mefenacet |
| (I-3) | cinosulfuron + mefenacet + dymron |
| (I-3) | cinosulfuron + molinate |
| (I-3) | cinosulfuron + oxaziclomefone |
| (I-3) | cinosulfuron + pretilachlor |
| (I-3) | cinosulfuron + pretilachlor + dymron |
| (I-3) | cinosulfuron + pretilachlor + fenclorim |
| (I-3) | cinosulfuron + pretilachlor + quinclorac |
| (I-3) | cinosulfuron + pyriftalid |
| (I-3) | clefoxydim |
| (I-3) | clodinafop-propargyl |
| (I-3) | clodinafop-propargyl + cloquintocet-mexyl |
| (I-3) | clomazone |
| (I-3) | clomazone + propanil |
| (I-3) | clomeprop |
| (I-3) | clomeprop + pretilachlor |
| (I-3) | cumyluron |
| (I-3) | cyanazine |
| (I-3) | cyclosulfamuron |
| (I-3) | cyclosulfamuron + dymron |
| (I-3) | cyclosulfamuron + anilofos |
| (I-3) | cyclosulfamuron + benfuresate |
| (I-3) | cyclosulfamuron + butachlor |
| (I-3) | cyclosulfamuron + cafenstrole + dymron |
| (I-3) | cyclosulfamuron + cyhalofop-butyl |
| (I-3) | cyclosulfamuron + dimepiperate |
| (I-3) | cyclosulfamuron + esprocarb |
| (I-3) | cyclosulfamuron + mefenacet |
| (I-3) | cyclosulfamuron + mefenacet + dymron |
| (I-3) | cyclosulfamuron + oxaziclomefone |
| (I-3) | cyclosulfamuron + pentoxazone |
| (I-3) | cyclosulfamuron + pretilachlor |
| (I-3) | cyclosulfamuron + quinclorac |
| (I-3) | cyhalofop-butyl |
| (I-3) | cyhalofop-butyl + bentazon |
| (I-3) | 2,4-D |
| (I-3) | dichlorprop-P |
| (I-3) | diethatyl-ethyl |
| (I-3) | dimepiperate |
| (I-3) | dimethametryn |
| (I-3) | dimethametryn + piperophos |
| (I-3) | dimethenamid |
| (I-3) | S-dimethenamid |
| (I-3) | dithiopyr |
| (I-3) | dymron |
| (I-3) | esprocarb |
| (I-3) | ethoxysulfuron |
| (I-3) | ethoxysulfuron + dymron |
| (I-3) | ethoxysulfuron + anilofos |
| (I-3) | ethoxysulfuron + anilofos + dymron |
| (I-3) | ethoxysulfuron + benfuresate |
| (I-3) | ethoxysulfuron + anilofos + benfuresate |
| (I-3) | ethoxysulfuron + benfuresate + dymron |
| (I-3) | ethoxysulfuron + butachlor |
| (I-3) | ethoxysulfuron + cafenstrole |
| (I-3) | ethoxysulfuron + cafenstrole + dymron |
| (I-3) | ethoxysulfuron + cyhalofop-butyl |
| (I-3) | ethoxysulfuron + dimepiperate |
| (I-3) | ethoxysulfuron + esprocarb |
| (I-3) | ethoxysulfuron + mefenacet |
| (I-3) | ethoxysulfuron + mefenacet + dymron |
| (I-3) | ethoxysulfuron + oxaziclomefone |
| (I-3) | ethoxysulfuron + pretilachlor + dymron |
| (I-3) | ethoxysulfuron + pretilachlor + pyrazolate |
| (I-3) | etobenzanid |
| (I-3) | fenoxaprop-(P)-ethyl |
| (I-3) | fenoxaprop-(P)-ethyl + fenclorim |
| (I-3) | fenoxaprop-(P)-ethyl + isoxadifen-ethyl |
| (I-3) | fenoxaprop-(P)-ethyl + mefenpyr-diethyl |
| (I-3) | fentrazamide |
| (I-3) | fentrazamide + pentoxazone |
| (I-3) | fentrazamide + bispyribac-sodium |
| (I-3) | fentrazamide + bromobutide |
| (I-3) | fentrazamide + benzofenap |
| (I-3) | fentrazamide + clomeprop |
| (I-3) | fentrazamide + dymron |
| (I-3) | fentrazamide + flufenacet |
| (I-3) | fentrazamide + oxaziclomefone |
| (I-3) | fentrazamide + propanil |
| (I-3) | fentrazamide + pyribenzoxim |
| (I-3) | fentrazamide + pyriminobac-methyl |
| (I-3) | fentrazamide + quinoclamine |
| (I-3) | fentrazamide + azimsulfuron |
| (I-3) | fentrazamide + azimsulfuron + dymron |
| (I-3) | fentrazamide + azimsulfuron + bensulfuron-methyl |
| (I-3) | fentrazamide + bensulfuron-methyl |
| (I-3) | fentrazamide + bensulfuron-methyl + dymron |
| (I-3) | fentrazamide + cinosulfuron |
| (I-3) | fentrazamide + cinosulfuron + dymron |
| (I-3) | fentrazamide + cyclosulfamuron |
| (I-3) | fentrazamide + cyclosulfamuron + dymron |
| (I-3) | fentrazamide + ethoxysulfuron |
| (I-3) | fentrazamide + ethoxysulfuron + dymron |
| (I-3) | fentrazamide + imazosulfuron |
| (I-3) | fentrazamide + imazosulfuron + dymron |
| (I-3) | fentrazamide + pyrazosulfuron-ethyl |
| (I-3) | fentrazamide + pyrazosulfuron-ethyl + dymron |
| (I-3) | fluazifop-P-butyl |
| (I-3) | flucarbazone-sodium |
| (I-3) | flucarbazone-sodium + fenclorim |
| (I-3) | flucarbazone-sodium + isoxadifen-ethyl |
| (I-3) | flucarbazone-sodium + mefenpyr-diethyl |
| (I-3) | flufenacet |
| (I-3) | flufenacet + 2,4-D |
| (I-3) | flufenacet + diflufenican |
| (I-3) | flufenacet + metosulam |
| (I-3) | flufenacet + propanil |
| (I-3) | flufenacet + dichlormid |
| (I-3) | flufenacet + furilazole |
| (I-3) | flufenacet + R-29148 |
| (I-3) | flufenacet + fenclorim |
| (I-3) | flufenacet + isoxadifen-ethyl |
| (I-3) | flufenacet + mefenpyr-diethyl |
| (I-3) | flumetsulam |
| (I-3) | halosulfuron-methyl |
| (I-3) | halosulfuron-methyl + cafenstrole + cyhalofop-butyl |
| (I-3) | halosulfuron-methyl + cafenstrole + dymron |
| (I-3) | halosulfuron-methyl + cyhalofop-butyl + dymron |
| (I-3) | haloxyfop-P-methyl |
| (I-3) | HOK-201 |
| (I-3) | imazamox |
| (I-3) | imazaquin |
| (I-3) | imazethapyr |
| (I-3) | imazosulfuron |
| (I-3) | imazosulfuron + dymron |
| (I-3) | imazosulfuron + anilofos |
| (I-3) | imazosulfuron + benfuresate |
| (I-3) | imazosulfuron + butachlor |
| (I-3) | imazosulfuron + cafenstrole + dymron |
| (I-3) | imazosulfuron + cyhalofop-butyl |
| (I-3) | imazosulfuron + dimepiperate |
| (I-3) | imazosulfuron + dimethametryn |
| (I-3) | imazosulfuron + dimethametryn + pretilachlor |
| (I-3) | imazosulfuron + esprocarb + dymron |
| (I-3) | imazosulfuron + etobenzanid + dymron |
| (I-3) | imazosulfuron + mefenacet + dymron |
| (I-3) | imazosulfuron + oxaziclomefone |
| (I-3) | imazosulfuron + pentoxazone + dymron |
| (I-3) | imazosulfuron + pretilachlor + dymron |
| (I-3) | imazosulfuron + pyributicarb + dymron |
| (I-3) | indanofan |
| (I-3) | isoxaflutole |
| (I-3) | MCPA |
| (I-3) | mefenacet |
| (I-3) | mefenacet + molinate |
| (I-3) | mefenacet + quinoclamine |
| (I-3) | mefenacet + bromobutide + naproanilide |
| (I-3) | mesosulfuron |
| (I-3) | mesosulfuron + dymron |
| (I-3) | mesosulfuron + anilofos |
| (I-3) | mesosulfuron + benfuresate |
| (I-3) | mesosulfuron + cafenstrole + dymron |
| (I-3) | mesosulfuron + cyhalofop-butyl |
| (I-3) | mesosulfuron + dimepiperate |
| (I-3) | mesosulfuron + esprocarb |
| (I-3) | mesosulfuron + mefenacet |
| (I-3) | mesosulfuron + mefenacet + dymron |
| (I-3) | mesosulfuron + oxaziclomefone |
| (I-3) | mesosulfuron + pretilachlor |
| (I-3) | mesosulfuron + pyributicarb |
| (I-3) | mesotrione |
| (I-3) | metolachlor |
| (I-3) | metolachlor + benoxacor |
| (I-3) | S-metolachlor |
| (I-3) | S-metolachlor + benoxacor |
| (I-3) | metosulam |
| (I-3) | metsulfuron-methyl |
| (I-3) | metribuzin |
| (I-3) | molinate |
| (I-3) | molinate + propanil |
| (I-3) | molinate + simetryn |
| (I-3) | naproanilide |
| (I-3) | nicosulfuron |
| (I-3) | OK-701 |
| (I-3) | oxadiargyl |
| (I-3) | oxadiargyl + propanil |
| (I-3) | oxadiazon |
| (I-3) | oxaziclomefone |
| (I-3) | oxyfluorfen |
| (I-3) | pendimethalin |
| (I-3) | pentoxazone |
| (I-3) | pentoxazone + cumyluron |
| (I-3) | piperophos |
| (I-3) | piperophos + 2,4-D |
| (I-3) | pretilachlor |
| (I-3) | pretilachlor + dimethametryn |
| (I-3) | pretilachlor + dymron |
| (I-3) | pretilachlor + dimethametryn + dymron |
| (I-3) | pretilachlor + fenclorim |
| (I-3) | profoxydim |
| (I-3) | propanil |
| (I-3) | propoxycarbazone-sodium |
| (I-3) | pyraclonil |
| (I-3) | pyrazolate |
| (I-3) | pyrazolate + butachlor |
| (I-3) | pyrazolate + pretilachlor |
| (I-3) | pyrazosulfuron-ethyl |
| (I-3) | pyrazosulfuron-ethyl + dymron |
| (I-3) | pyrazosulfuron-ethyl + indanofan |
| (I-3) | pyrazosulfuron-ethyl + etobenzanid |
| (I-3) | pyrazosulfuron-ethyl + esprocarb |
| (I-3) | pyrazosulfuron-ethyl + esprocarb + dimethametryn |
| (I-3) | pyrazosulfuron-ethyl + esprocarb + pretilachlor |
| (I-3) | pyrazosulfuron-ethyl + mefenacet |
| (I-3) | pyrazosulfuron-ethyl + molinate |
| (I-3) | pyrazosulfuron-ethyl + pentoxazone |
| (I-3) | pyrazosulfuron-ethyl + anilofos + dymron |
| (I-3) | pyrazosulfuron-ethyl + benfuresate + dymron |
| (I-3) | pyrazosulfuron-ethyl + butachlor + dymron |
| (I-3) | pyrazosulfuron-ethyl + cafenstrole |
| (I-3) | pyrazosulfuron-ethyl + cafenstrole + cyhalofop-butyl |
| (I-3) | pyrazosulfuron-ethyl + dimepiperate + dymron |
| (I-3) | pyrazosulfuron-ethyl + dithiopyr + esprocarb |
| (I-3) | pyrazosulfuron-ethyl + mefenacet + dymron |
| (I-3) | pyrazosulfuron-ethyl + oxaziclomefone + dymron |
| (I-3) | pyrazosulfuron-ethyl + pretilachlor |
| (I-3) | pyrazosulfuron-ethyl + pretilachlor + quinclorac |
| (I-3) | pyrazosulfuron-ethyl + thenylchlor |
| (I-3) | pyrazoxyfen |
| (I-3) | pyribenzoxim |
| (I-3) | pyributicarb |
| (I-3) | pyributicarb + pretilachlor |
| (I-3) | pyriftalid |
| (I-3) | pyriminobac-methyl |
| (I-3) | quinclorac |
| (I-3) | quinoclamine |
| (I-3) | simazine |
| (I-3) | simetryn |
| (I-3) | sulcotrione |
| (I-3) | terbuthylazine |
| (I-3) | thenylchlor |
| (I-3) | thifensulfuron-methyl |
| (I-3) | tiocarbazil |
| (I-3) | tritosulfuron |
| (I-7) | acetochlor |
| (I-7) | acetochlor + dichlormid |
| (I-7) | acetochlor + furilazole |
| (I-7) | acetochlor + R-29148 |
| (I-7) | alachlor |
| (I-7) | amicarbazone |
| (I-7) | amidosulfuron |
| (I-7) | anilofos |
| (I-7) | anilofos + 2,4-D |
| (I-7) | anilofos + propanil |
| (I-7) | anilofos + quinoclamine |
| (I-7) | atrazine |
| (I-7) | azimsulfuron |
| (I-7) | azimsulfuron + dymron |
| (I-7) | azimsulfuron + anilofos |
| (I-7) | azimsulfuron + benfuresate |
| (I-7) | azimsulfuron + bensulfuron |
| (I-7) | azimsulfuron + butachlor |
| (I-7) | azimsulfuron + cafenstrole |
| (I-7) | azimsulfuron + cyhalofop-butyl |
| (I-7) | azimsulfuron + dimepiperate |
| (I-7) | azimsulfuron + esprocarb |
| (I-7) | azimsulfuron + mefenacet |
| (I-7) | azimsulfuron + indanofan |
| (I-7) | azimsulfuron + oxaziclomefone |
| (I-7) | azimsulfuron + pretilachlor |
| (I-7) | azimsulfuron + thenylchlor |
| (I-7) | azimsulfuron + anilofos + dymron |
| (I-7) | azimsulfuron + benfuresate + dymron |
| (I-7) | azimsulfuron + bensulfuron + cafenstrole |
| (I-7) | azimsulfuron + bensulfuron + cyhalofop-butyl |
| (I-7) | azimsulfuron + bensulfuron + dymron |
| (I-7) | azimsulfuron + bensulfuron + dimethametryn |
| (I-7) | azimsulfuron + bensulfuron + indanofan |
| (I-7) | azimsulfuron + bensulfuron + pretilachlor |
| (I-7) | azimsulfuron + bensulfuron + thenylchlor |
| (I-7) | azimsulfuron + butachlor + dymron |
| (I-7) | azimsulfuron + cafenstrole + dymron |
| (I-7) | azimsulfuron + cyhalofop-butyl + dymron |
| (I-7) | azimsulfuron + mefenacet + dymron |
| (I-7) | azimsulfuron + oxaziclomefone + dymron |
| (I-7) | azimsulfuron + pretilachlor + dymron |
| (I-7) | benfuresate |
| (I-7) | bensulfuron-methyl |
| (I-7) | bensulfuron-methyl + dymron |
| (I-7) | bensulfuron-methyl + anilofos |
| (I-7) | bensulfuron-methyl + benfuresate |
| (I-7) | bensulfuron-methyl + butachlor |
| (I-7) | bensulfuron-methyl + cafenstrole |
| (I-7) | bensulfuron-methyl + cyhalofop-butyl |
| (I-7) | bensulfuron-methyl + dimepiperate |
| (I-7) | bensulfuron-methyl + dithiopyr |
| (I-7) | bensulfuron-methyl + esprocarb |
| (I-7) | bensulfuron-methyl + indanofan |
| (I-7) | bensulfuron-methyl + mefenacet |
| (I-7) | bensulfuron-methyl + metsulfuron-methyl |
| (I-7) | bensulfuron-methyl + molinate |
| (I-7) | bensulfuron-methyl + oxaziclomefone |
| (I-7) | bensulfuron-methyl + pretilachlor |
| (I-7) | bensulfuron-methyl + pyributicarb |
| (I-7) | bensulfuron-methyl + quinclorac |
| (I-7) | bensulfuron-methyl + thenylchlor |
| (I-7) | bensulfuron-methyl + anilofos + dymron |
| (I-7) | bensulfuron-methyl + benfuresate + dymron |
| (I-7) | bensulfuron-methyl + butachlor + dymron |
| (I-7) | bensulfuron-methyl + benfuresate + dimepiperate |
| (I-7) | bensulfuron-methyl + benfuresate + pretilachlor |
| (I-7) | bensulfuron-methyl + cafenstrole + dymron |
| (I-7) | bensulfuron-methyl + cafenstrole + cyhalofop-butyl |
| (I-7) | bensulfuron-methyl + cyhalofop-butyl + dymron |
| (I-7) | bensulfuron-methyl + cyhalofop-butyl + thenylchlor |
| (I-7) | bensulfuron-methyl + dithiopyr + quinclorac |
| (I-7) | bensulfuron-methyl + mefenacet + dymron |
| (I-7) | bensulfuron-methyl + mefenacet + benthiocarb |
| (I-7) | bensulfuron-methyl + mefenacet + molinate |
| (I-7) | bensulfuron-methyl + oxaziclomefone + dymron |
| (I-7) | bensulfuron-methyl + pretilachlor + dymron |
| (I-7) | bensulfuron-methyl + pyributicarb + dymron |
| (I-7) | bentazone |
| (I-7) | bentazone + quinclorac |
| (I-7) | benthiocarb (thiobencarb) |
| (I-7) | benthiocarb + chlornitrofen |
| (I-7) | benthiocarb + propanil |
| (I-7) | benthiocarb + simetryn |
| (I-7) | benzobicyclon |
| (I-7) | benzofenap |
| (I-7) | benzofenap + thenylchlor + cumyluron |
| (I-7) | bifenox |
| (I-7) | bifenox + pretilachlor |
| (I-7) | bifenox + thenylchlor |
| (I-7) | bispyribac-sodium |
| (I-7) | bispyribac-sodium + benthiocarb |
| (I-7) | bromobutide |
| (I-7) | bromobutide + pyrazoxyfen |
| (I-7) | bromobutide + benzofenap + pyributicarb |
| (I-7) | bromobutide + bifenox + pyrazolate |
| (I-7) | bromobutide + pyrazoxyfen + thenylchlor |
| (I-7) | butachlor |
| (I-7) | butachlor + chlomethoxyfen |
| (I-7) | butachlor + oxadiazon |
| (I-7) | butachlor + propanil |
| (I-7) | butachlor + pyrazolate |
| (I-7) | butamifos |
| (I-7) | butamifos + bromobutide |
| (I-7) | butenachlor |
| (I-7) | cafenstrole |
| (I-7) | cafenstrole + dymron |
| (I-7) | cafenstrole + cyhalofop-butyl + dymron |
| (I-7) | carfentrazone-ethyl |
| (I-7) | chlomethoxyfen |
| (I-7) | chlornitrofen |
| (I-7) | chlornitrofen + dymron |
| (I-7) | cinmethylin |
| (I-7) | cinmethylin + 2,4-D |
| (I-7) | cinosulfuron |
| (I-7) | cinosulfuron + dymron |
| (I-7) | cinosulfuron + anilofos |
| (I-7) | cinosulfuron + benfuresate |
| (I-7) | cinosulfuron + butachlor |
| (I-7) | cinosulfuron + cafenstrole + dymron |
| (I-7) | cinosulfuron + cyhalofop-butyl |
| (I-7) | cinosulfuron + dimepiperate |
| (I-7) | cinosulfuron + esprocarb |
| (I-7) | cinosulfuron + mefenacet |
| (I-7) | cinosulfuron + mefenacet + dymron |
| (I-7) | cinosulfuron + molinate |
| (I-7) | cinosulfuron + oxaziclomefone |
| (I-7) | cinosulfuron + pretilachlor |
| (I-7) | cinosulfuron + pretilachlor + dymron |
| (I-7) | cinosulfuron + pretilachlor + fenclorim |
| (I-7) | cinosulfuron + pretilachlor + quinclorac |
| (I-7) | cinosulfuron + pyriftalid |
| (I-7) | clefoxydim |
| (I-7) | clodinafop-propargyl |
| (I-7) | clodinafop-propargyl + cloquintocet-mexyl |
| (I-7) | clomazone |
| (I-7) | clomazone + propanil |
| (I-7) | clomeprop |
| (I-7) | clomeprop + pretilachlor |
| (I-7) | cumyluron |
| (I-7) | cyanazine |
| (I-7) | cyclosulfamuron |
| (I-7) | cyclosulfamuron + dymron |
| (I-7) | cyclosulfamuron + anilofos |
| (I-7) | cyclosulfamuron + benfuresate |
| (I-7) | cyclosulfamuron + butachlor |
| (I-7) | cyclosulfamuron + cafenstrole + dymron |
| (I-7) | cyclosulfamuron + cyhalofop-butyl |
| (I-7) | cyclosulfamuron + dimepiperate |
| (I-7) | cyclosulfamuron + esprocarb |
| (I-7) | cyclosulfamuron + mefenacet |
| (I-7) | cyclosulfamuron + mefenacet + dymron |
| (I-7) | cyclosulfamuron + oxaziclomefone |
| (I-7) | cyclosulfamuron + pentoxazone |
| (I-7) | cyclosulfamuron + pretilachlor |
| (I-7) | cyclosulfamuron + quinclorac |
| (I-7) | cyhalofop-butyl |
| (I-7) | cyhalofop-butyl + bentazon |
| (I-7) | 2,4-D |
| (I-7) | dichlorprop-P |
| (I-7) | diethatyl-ethyl |
| (I-7) | dimepiperate |
| (I-7) | dimethametryn |
| (I-7) | dimethametryn + piperophos |
| (I-7) | dimethenamid |
| (I-7) | S-dimethenamid |
| (I-7) | dithiopyr |
| (I-7) | dymron |
| (I-7) | esprocarb |
| (I-7) | ethoxysulfuron |
| (I-7) | ethoxysulfuron + dymron |
| (I-7) | ethoxysulfuron + anilofos |
| (I-7) | ethoxysulfuron + anilofos + dymron |
| (I-7) | ethoxysulfuron + benfuresate |
| (I-7) | ethoxysulfuron + anilofos + benfuresate |
| (I-7) | ethoxysulfuron + benfuresate + dymron |
| (I-7) | ethoxysulfuron + butachlor |
| (I-7) | ethoxysulfuron + cafenstrole |
| (I-7) | ethoxysulfuron + cafenstrole + dymron |
| (I-7) | ethoxysulfuron + cyhalofop-butyl |
| (I-7) | ethoxysulfuron + dimepiperate |
| (I-7) | ethoxysulfuron + esprocarb |
| (I-7) | ethoxysulfuron + mefenacet |
| (I-7) | ethoxysulfuron + mefenacet + dymron |
| (I-7) | ethoxysulfuron + oxaziclomefone |
| (I-7) | ethoxysulfuron + pretilachlor + dymron |
| (I-7) | ethoxysulfuron + pretilachlor + pyrazolate |
| (I-7) | etobenzanid |
| (I-7) | fenoxaprop-(P)-ethyl |
| (I-7) | fenoxaprop-(P)-ethyl + fenclorim |
| (I-7) | fenoxaprop-(P)-ethyl + isoxadifen-ethyl |
| (I-7) | fenoxaprop-(P)-ethyl + mefenpyr-diethyl |
| (I-7) | fentrazamide |
| (I-7) | fentrazamide + pentoxazone |
| (I-7) | fentrazamide + bispyribac-sodium |
| (I-7) | fentrazamide + bromobutide |
| (I-7) | fentrazamide + benzofenap |
| (I-7) | fentrazamide + clomeprop |
| (I-7) | fentrazamide + dymron |
| (I-7) | fentrazamide + flufenacet |
| (I-7) | fentrazamide + oxaziclomefone |
| (I-7) | fentrazamide + propanil |
| (I-7) | fentrazamide + pyribenzoxim |
| (I-7) | fentrazamide + pyriminobac-methyl |
| (I-7) | fentrazamide + quinoclamine |
| (I-7) | fentrazamide + azimsulfuron |
| (I-7) | fentrazamide + azimsulfuron + dymron |
| (I-7) | fentrazamide + azimsulfuron + bensulfuron-methyl |
| (I-7) | fentrazamide + bensulfuron-methyl |
| (I-7) | fentrazamide + bensulfuron-methyl + dymron |
| (I-7) | fentrazamide + cinosulfuron |
| (I-7) | fentrazamide + cinosulfuron + dymron |
| (I-7) | fentrazamide + cyclosulfamuron |
| (I-7) | fentrazamide + cyclosulfamuron + dymron |
| (I-7) | fentrazamide + ethoxysulfuron |
| (I-7) | fentrazamide + ethoxysulfuron + dymron |
| (I-7) | fentrazamide + imazosulfuron |
| (I-7) | fentrazamide + imazosulfuron + dymron |
| (I-7) | fentrazamide + pyrazosulfuron-ethyl |
| (I-7) | fentrazamide + pyrazosulfuron-ethyl + dymron |
| (I-7) | fluazifop-P-butyl |
| (I-7) | flucarbazone-sodium |
| (I-7) | flucarbazone-sodium + fenclorim |
| (I-7) | flucarbazone-sodium + isoxadifen-ethyl |
| (I-7) | flucarbazone-sodium + mefenpyr-diethyl |
| (I-7) | flufenacet |
| (I-7) | flufenacet + 2,4-D |
| (I-7) | flufenacet + diflufenican |
| (I-7) | flufenacet + metosulam |
| (I-7) | flufenacet + propanil |
| (I-7) | flufenacet + dichlormid |
| (I-7) | flufenacet + furilazole |
| (I-7) | flufenacet + R-29148 |
| (I-7) | flufenacet + fenclorim |
| (I-7) | flufenacet + isoxadifen-ethyl |
| (I-7) | flufenacet + mefenpyr-diethyl |
| (I-7) | flumetsulam |
| (I-7) | halosulfuron-methyl |
| (I-7) | halosulfuron-methyl + cafenstrole + cyhalofop-butyl |
| (I-7) | halosulfuron-methyl + cafenstrole + dymron |
| (I-7) | halosulfuron-methyl + cyhalofop-butyl + dymron |
| (I-7) | haloxyfop-P-methyl |
| (I-7) | HOK-201 |
| (I-7) | imazamox |
| (I-7) | imazaquin |
| (I-7) | imazethapyr |
| (I-7) | imazosulfuron |
| (I-7) | imazosulfuron + dymron |
| (I-7) | imazosulfuron + anilofos |
| (I-7) | imazosulfuron + benfuresate |
| (I-7) | imazosulfuron + butachlor |
| (I-7) | imazosulfuron + cafenstrole + dymron |
| (I-7) | imazosulfuron + cyhalofop-butyl |
| (I-7) | imazosulfuron + dimepiperate |
| (I-7) | imazosulfuron + dimethametryn |
| (I-7) | imazosulfuron + dimethametryn + pretilachlor |
| (I-7) | imazosulfuron + esprocarb + dymron |
| (I-7) | imazosulfuron + etobenzanid + dymron |
| (I-7) | imazosulfuron + mefenacet + dymron |
| (I-7) | imazosulfuron + oxaziclomefone |
| (I-7) | imazosulfuron + pentoxazone + dymron |
| (I-7) | imazosulfuron + pretilachlor + dymron |
| (I-7) | imazosulfuron + pyributicarb + dymron |
| (I-7) | indanofan |
| (I-7) | isoxaflutole |
| (I-7) | MCPA |
| (I-7) | mefenacet |
| (I-7) | mefenacet + molinate |
| (I-7) | mefenacet + quinoclamine |
| (I-7) | mefenacet + bromobutide + naproanilide |
| (I-7) | mesosulfuron |
| (I-7) | mesosulfuron + dymron |
| (I-7) | mesosulfuron + anilofos |
| (I-7) | mesosulfuron + benfuresate |
| (I-7) | mesosulfuron + cafenstrole + dymron |
| (I-7) | mesosulfuron + cyhalofop-butyl |
| (I-7) | mesosulfuron + dimepiperate |
| (I-7) | mesosulfuron + esprocarb |
| (I-7) | mesosulfuron + mefenacet |
| (I-7) | mesosulfuron + mefenacet + dymron |
| (I-7) | mesosulfuron + oxaziclomefone |
| (I-7) | mesosulfuron + pretilachlor |
| (I-7) | mesosulfuron + pyributicarb |
| (I-7) | mesotrione |
| (I-7) | metolachlor |
| (I-7) | metolachlor + benoxacor |
| (I-7) | S-metolachlor |
| (I-7) | S-metolachlor + benoxacor |
| (I-7) | metosulam |
| (I-7) | metsulfuron-methyl |
| (I-7) | metribuzin |
| (I-7) | molinate |
| (I-7) | molinate + propanil |
| (I-7) | molinate + simetryn |
| (I-7) | naproanilide |
| (I-7) | nicosulfuron |
| (I-7) | OK-701 |
| (I-7) | oxadiargyl |
| (I-7) | oxadiargyl + propanil |
| (I-7) | oxadiazon |
| (I-7) | oxaziclomefone |
| (I-7) | oxyfluorfen |
| (I-7) | pendimethalin |
| (I-7) | pentoxazone |
| (I-7) | pentoxazone + cumyluron |
| (I-7) | piperophos |
| (I-7) | piperophos + 2,4-D |
| (I-7) | pretilachlor |
| (I-7) | pretilachlor + dimethametryn |
| (I-7) | pretilachlor + dymron |
| (I-7) | pretilachlor + dimethametryn + dymron |
| (I-7) | pretilachlor + fenclorim |
| (I-7) | profoxydim |
| (I-7) | propanil |
| (I-7) | propoxycarbazone-sodium |
| (I-7) | pyraclonil |
| (I-7) | pyrazolate |
| (I-7) | pyrazolate + butachlor |
| (I-7) | pyrazolate + pretilachlor |
| (I-7) | pyrazosulfuron-ethyl |
| (I-7) | pyrazosulfuron-ethyl + dymron |
| (I-7) | pyrazosulfuron-ethyl + indanofan |
| (I-7) | pyrazosulfuron-ethyl + etobenzanid |
| (I-7) | pyrazosulfuron-ethyl + esprocarb |
| (I-7) | pyrazosulfuron-ethyl + esprocarb + dimethametryn |
| (I-7) | pyrazosulfuron-ethyl + esprocarb + pretilachlor |
| (I-7) | pyrazosulfuron-ethyl + mefenacet |
| (I-7) | pyrazosulfuron-ethyl + molinate |
| (I-7) | pyrazosulfuron-ethyl + pentoxazone |
| (I-7) | pyrazosulfuron-ethyl + anilofos + dymron |
| (I-7) | pyrazosulfuron-ethyl + benfuresate + dymron |
| (I-7) | pyrazosulfuron-ethyl + butachlor + dymron |
| (I-7) | pyrazosulfuron-ethyl + cafenstrole |
| (I-7) | pyrazosulfuron-ethyl + cafenstrole + cyhalofop-butyl |
| (I-7) | pyrazosulfuron-ethyl + dimepiperate + dymron |
| (I-7) | pyrazosulfuron-ethyl + dithiopyr + esprocarb |
| (I-7) | pyrazosulfuron-ethyl + mefenacet + dymron |
| (I-7) | pyrazosulfuron-ethyl + oxaziclomefone + dymron |
| (I-7) | pyrazosulfuron-ethyl + pretilachlor |
| (I-7) | pyrazosulfuron-ethyl + pretilachlor + quinclorac |
| (I-7) | pyrazosulfuron-ethyl + thenylchlor |
| (I-7) | pyrazoxyfen |
| (I-7) | pyribenzoxim |
| (I-7) | pyributicarb |
| (I-7) | pyributicarb + pretilachlor |
| (I-7) | pyriftalid |
| (I-7) | pyriminobac-methyl |
| (I-7) | quinclorac |
| (I-7) | quinoclamine |
| (I-7) | simazine |
| (I-7) | simetryn |
| (I-7) | sulcotrione |
| (I-7) | terbuthylazine |
| (I-7) | thenylchlor |
| (I-7) | thifensulfuron-methyl |
| (I-7) | tiocarbazil |
| (I-7) | tritosulfuron |
| (I-8) | acetochlor |
| (I-8) | acetochlor + dichlormid |
| (I-8) | acetochlor + furilazole |
| (I-8) | acetochlor + R-29148 |
| (I-8) | alachlor |
| (I-8) | amicarbazone |
| (I-8) | amidosulfuron |
| (I-8) | anilofos |
| (I-8) | anilofos + 2,4-D |
| (I-8) | anilofos + propanil |
| (I-8) | anilofos + quinoclamine |
| (I-8) | atrazine |
| (I-8) | azimsulfuron |
| (I-8) | azimsulfuron + dymron |
| (I-8) | azimsulfuron + anilofos |
| (I-8) | azimsulfuron + benfuresate |
| (I-8) | azimsulfuron + bensulfuron |
| (I-8) | azimsulfuron + butachlor |
| (I-8) | azimsulfuron + cafenstrole |
| (I-8) | azimsulfuron + cyhalofop-butyl |
| (I-8) | azimsulfuron + dimepiperate |
| (I-8) | azimsulfuron + esprocarb |
| (I-8) | azimsulfuron + mefenacet |
| (I-8) | azimsulfuron + indanofan |
| (I-8) | azimsulfuron + oxaziclomefone |
| (I-8) | azimsulfuron + pretilachlor |
| (I-8) | azimsulfuron + thenylchlor |
| (I-8) | azimsulfuron + anilofos + dymron |
| (I-8) | azimsulfuron + benfuresate + dymron |
| (I-8) | azimsulfuron + bensulfuron + cafenstrole |
| (I-8) | azimsulfuron + bensulfuron + cyhalofop-butyl |
| (I-8) | azimsulfuron + bensulfuron + dymron |
| (I-8) | azimsulfuron + bensulfuron + dimethametryn |
| (I-8) | azimsulfuron + bensulfuron + indanofan |
| (I-8) | azimsulfuron + bensulfuron + pretilachlor |
| (I-8) | azimsulfuron + bensulfuron + thenylchlor |
| (I-8) | azimsulfuron + butachlor + dymron |
| (I-8) | azimsulfuron + cafenstrole + dymron |
| (I-8) | azimsulfuron + cyhalofop-butyl + dymron |
| (I-8) | azimsulfuron + mefenacet + dymron |
| (I-8) | azimsulfuron + oxaziclomefone + dymron |
| (I-8) | azimsulfuron + pretilachlor + dymron |
| (I-8) | benfuresate |
| (I-8) | bensulfuron-methyl |
| (I-8) | bensulfuron-methyl + dymron |
| (I-8) | bensulfuron-methyl + anilofos |
| (I-8) | bensulfuron-methyl + benfuresate |
| (I-8) | bensulfuron-methyl + butachlor |
| (I-8) | bensulfuron-methyl + cafenstrole |
| (I-8) | bensulfuron-methyl + cyhalofop-butyl |
| (I-8) | bensulfuron-methyl + dimepiperate |
| (I-8) | bensulfuron-methyl + dithiopyr |
| (I-8) | bensulfuron-methyl + esprocarb |
| (I-8) | bensulfuron-methyl + indanofan |
| (I-8) | bensulfuron-methyl + mefenacet |
| (I-8) | bensulfuron-methyl + metsulfuron-methyl |
| (I-8) | bensulfuron-methyl + molinate |
| (I-8) | bensulfuron-methyl + oxaziclomefone |
| (I-8) | bensulfuron-methyl + pretilachlor |
| (I-8) | bensulfuron-methyl + pyributicarb |
| (I-8) | bensulfuron-methyl + quinclorac |
| (I-8) | bensulfuron-methyl + thenylchlor |
| (I-8) | bensulfuron-methyl + anilofos + dymron |
| (I-8) | bensulfuron-methyl + benfuresate + dymron |
| (I-8) | bensulfuron-methyl + butachlor + dymron |
| (I-8) | bensulfuron-methyl + benfuresate + dimepiperate |
| (I-8) | bensulfuron-methyl + benfuresate + pretilachlor |
| (I-8) | bensulfuron-methyl + cafenstrole + dymron |
| (I-8) | bensulfuron-methyl + cafenstrole + cyhalofop-butyl |
| (I-8) | bensulfuron-methyl + cyhalofop-butyl + dymron |
| (I-8) | bensulfuron-methyl + cyhalofop-butyl + thenylchlor |
| (I-8) | bensulfuron-methyl + dithiopyr + quinclorac |
| (I-8) | bensulfuron-methyl + mefenacet + dymron |
| (I-8) | bensulfuron-methyl + mefenacet + benthiocarb |
| (I-8) | bensulfuron-methyl + mefenacet + molinate |
| (I-8) | bensulfuron-methyl + oxaziclomefone + dymron |
| (I-8) | bensulfuron-methyl + pretilachlor + dymron |
| (I-8) | bensulfuron-methyl + pyributicarb + dymron |
| (I-8) | bentazone |
| (I-8) | bentazone + quinclorac |
| (I-8) | benthiocarb (thiobencarb) |
| (I-8) | benthiocarb + chlornitrofen |
| (I-8) | benthiocarb + propanil |
| (I-8) | benthiocarb + simetryn |
| (I-8) | benzobicyclon |
| (I-8) | benzofenap |
| (I-8) | benzofenap + thenylchlor + cumyluron |
| (I-8) | bifenox |
| (I-8) | bifenox + pretilachlor |
| (I-8) | bifenox + thenylchlor |
| (I-8) | bispyribac-sodium |
| (I-8) | bispyribac-sodium + benthiocarb |
| (I-8) | bromobutide |
| (I-8) | bromobutide + pyrazoxyfen |
| (I-8) | bromobutide + benzofenap + pyributicarb |
| (I-8) | bromobutide + bifenox + pyrazolate |
| (I-8) | bromobutide + pyrazoxyfen + thenylchlor |
| (I-8) | butachlor |
| (I-8) | butachlor + chlomethoxyfen |
| (I-8) | butachlor + oxadiazon |
| (I-8) | butachlor + propanil |
| (I-8) | butachlor + pyrazolate |
| (I-8) | butamifos |
| (I-8) | butamifos + bromobutide |
| (I-8) | butenachlor |
| (I-8) | cafenstrole |
| (I-8) | cafenstrole + dymron |
| (I-8) | cafenstrole + cyhalofop-butyl + dymron |
| (I-8) | carfentrazone-ethyl |
| (I-8) | chlomethoxyfen |
| (I-8) | chlornitrofen |
| (I-8) | chlornitrofen + dymron |
| (I-8) | cinmethylin |
| (I-8) | cinmethylin + 2,4-D |
| (I-8) | cinosulfuron |
| (I-8) | cinosulfuron + dymron |
| (I-8) | cinosulfuron + anilofos |
| (I-8) | cinosulfuron + benfuresate |
| (I-8) | cinosulfuron + butachlor |
| (I-8) | cinosulfuron + cafenstrole + dymron |
| (I-8) | cinosulfuron + cyhalofop-butyl |
| (I-8) | cinosulfuron + dimepiperate |
| (I-8) | cinosulfuron + esprocarb |
| (I-8) | cinosulfuron + mefenacet |
| (I-8) | cinosulfuron + mefenacet + dymron |
| (I-8) | cinosulfuron + molinate |
| (I-8) | cinosulfuron + oxaziclomefone |
| (I-8) | cinosulfuron + pretilachlor |
| (I-8) | cinosulfuron + pretilachlor + dymron |
| (I-8) | cinosulfuron + pretilachlor + fenclorim |
| (I-8) | cinosulfuron + pretilachlor + quinclorac |
| (I-8) | cinosulfuron + pyriftalid |
| (I-8) | clefoxydim |
| (I-8) | clodinafop-propargyl |
| (I-8) | clodinafop-propargyl + cloquintocet-mexyl |
| (I-8) | clomazone |
| (I-8) | clomazone + propanil |
| (I-8) | clomeprop |
| (I-8) | clomeprop + pretilachlor |
| (I-8) | cumyluron |
| (I-8) | cyanazine |
| (I-8) | cyclosulfamuron |
| (I-8) | cyclosulfamuron + dymron |
| (I-8) | cyclosulfamuron + anilofos |
| (I-8) | cyclosulfamuron + benfuresate |
| (I-8) | cyclosulfamuron + butachlor |
| (I-8) | cyclosulfamuron + cafenstrole + dymron |
| (I-8) | cyclosulfamuron + cyhalofop-butyl |
| (I-8) | cyclosulfamuron + dimepiperate |
| (I-8) | cyclosulfamuron + esprocarb |
| (I-8) | cyclosulfamuron + mefenacet |
| (I-8) | cyclosulfamuron + mefenacet + dymron |
| (I-8) | cyclosulfamuron + oxaziclomefone |
| (I-8) | cyclosulfamuron + pentoxazone |
| (I-8) | cyclosulfamuron + pretilachlor |
| (I-8) | cyclosulfamuron + quinclorac |
| (I-8) | cyhalofop-butyl |
| (I-8) | cyhalofop-butyl + bentazon |
| (I-8) | 2,4-D |
| (I-8) | dichlorprop-P |
| (I-8) | diethatyl-ethyl |
| (I-8) | dimepiperate |
| (I-8) | dimethametryn |
| (I-8) | dimethametryn + piperophos |
| (I-8) | dimethenamid |
| (I-8) | S-dimethenamid |
| (I-8) | dithiopyr |
| (I-8) | dymron |
| (I-8) | esprocarb |
| (I-8) | ethoxysulfuron |
| (I-8) | ethoxysulfuron + dymron |
| (I-8) | ethoxysulfuron + anilofos |
| (I-8) | ethoxysulfuron + anilofos + dymron |
| (I-8) | ethoxysulfuron + benfuresate |
| (I-8) | ethoxysulfuron + anilofos + benfuresate |
| (I-8) | ethoxysulfuron + benfuresate + dymron |
| (I-8) | ethoxysulfuron + butachlor |
| (I-8) | ethoxysulfuron + cafenstrole |
| (I-8) | ethoxysulfuron + cafenstrole + dymron |
| (I-8) | ethoxysulfuron + cyhalofop-butyl |
| (I-8) | ethoxysulfuron + dimepiperate |
| (I-8) | ethoxysulfuron + esprocarb |
| (I-8) | ethoxysulfuron + mefenacet |
| (I-8) | ethoxysulfuron + mefenacet + dymron |
| (I-8) | ethoxysulfuron + oxaziclomefone |
| (I-8) | ethoxysulfuron + pretilachlor + dymron |
| (I-8) | ethoxysulfuron + pretilachlor + pyrazolate |
| (I-8) | etobenzanid |
| (I-8) | fenoxaprop-(P)-ethyl |
| (I-8) | fenoxaprop-(P)-ethyl + fenclorim |
| (I-8) | fenoxaprop-(P)-ethyl + isoxadifen-ethyl |
| (I-8) | fenoxaprop-(P)-ethyl + mefenpyr-diethyl |
| (I-8) | fentrazamide |
| (I-8) | fentrazamide + pentoxazone |
| (I-8) | fentrazamide + bispyribac-sodium |
| (I-8) | fentrazamide + bromobutide |
| (I-8) | fentrazamide + benzofenap |
| (I-8) | fentrazamide + clomeprop |
| (I-8) | fentrazamide + dymron |
| (I-8) | fentrazamide + flufenacet |
| (I-8) | fentrazamide + oxaziclomefone |
| (I-8) | fentrazamide + propanil |
| (I-8) | fentrazamide + pyribenzoxim |
| (I-8) | fentrazamide + pyriminobac-methyl |
| (I-8) | fentrazamide + quinoclamine |
| (I-8) | fentrazamide + azimsulfuron |
| (I-8) | fentrazamide + azimsulfuron + dymron |
| (I-8) | fentrazamide + azimsulfuron + bensulfuron-methyl |
| (I-8) | fentrazamide + bensulfuron-methyl |
| (I-8) | fentrazamide + bensulfuron-methyl + dymron |
| (I-8) | fentrazamide + cinosulfuron |
| (I-8) | fentrazamide + cinosulfuron + dymron |
| (I-8) | fentrazamide + cyclosulfamuron |
| (I-8) | fentrazamide + cyclosulfamuron + dymron |
| (I-8) | fentrazamide + ethoxysulfuron |
| (I-8) | fentrazamide + ethoxysulfuron + dymron |
| (I-8) | fentrazamide + imazosulfuron |
| (I-8) | fentrazamide + imazosulfuron + dymron |
| (I-8) | fentrazamide + pyrazosulfuron-ethyl |
| (I-8) | fentrazamide + pyrazosulfuron-ethyl + dymron |
| (I-8) | fluazifop-P-butyl |
| (I-8) | flucarbazone-sodium |
| (I-8) | flucarbazone-sodium + fenclorim |
| (I-8) | flucarbazone-sodium + isoxadifen-ethyl |
| (I-8) | flucarbazone-sodium + mefenpyr-diethyl |
| (I-8) | flufenacet |
| (I-8) | flufenacet + 2,4-D |
| (I-8) | flufenacet + diflufenican |
| (I-8) | flufenacet + metosulam |
| (I-8) | flufenacet + propanil |
| (I-8) | flufenacet + dichlormid |
| (I-8) | flufenacet + furilazole |
| (I-8) | flufenacet + R-29148 |
| (I-8) | flufenacet + fenclorim |
| (I-8) | flufenacet + isoxadifen-ethyl |
| (I-8) | flufenacet + mefenpyr-diethyl |
| (I-8) | flumetsulam |
| (I-8) | halosulfuron-methyl |
| (I-8) | halosulfuron-methyl + cafenstrole + cyhalofop-butyl |
| (I-8) | halosulfuron-methyl + cafenstrole + dymron |
| (I-8) | halosulfuron-methyl + cyhalofop-butyl + dymron |
| (I-8) | haloxyfop-P-methyl |
| (I-8) | HOK-201 |
| (I-8) | imazamox |
| (I-8) | imazaquin |
| (I-8) | imazethapyr |
| (I-8) | imazosulfuron |
| (I-8) | imazosulfuron + dymron |
| (I-8) | imazosulfuron + anilofos |
| (I-8) | imazosulfuron + benfuresate |
| (I-8) | imazosulfuron + butachlor |
| (I-8) | imazosulfuron + cafenstrole + dymron |
| (I-8) | imazosulfuron + cyhalofop-butyl |
| (I-8) | imazosulfuron + dimepiperate |
| (I-8) | imazosulfuron + dimethametryn |
| (I-8) | imazosulfuron + dimethametryn + pretilachlor |
| (I-8) | imazosulfuron + esprocarb + dymron |
| (I-8) | imazosulfuron + etobenzanid + dymron |
| (I-8) | imazosulfuron + mefenacet + dymron |
| (I-8) | imazosulfuron + oxaziclomefone |
| (I-8) | imazosulfuron + pentoxazone + dymron |
| (I-8) | imazosulfuron + pretilachlor + dymron |
| (I-8) | imazosulfuron + pyributicarb + dymron |
| (I-8) | indanofan |
| (I-8) | isoxaflutole |
| (I-8) | MCPA |
| (I-8) | mefenacet |
| (I-8) | mefenacet + molinate |
| (I-8) | mefenacet + quinoclamine |
| (I-8) | mefenacet + bromobutide + naproanilide |
| (I-8) | mesosulfuron |
| (I-8) | mesosulfuron + dymron |
| (I-8) | mesosulfuron + anilofos |
| (I-8) | mesosulfuron + benfuresate |
| (I-8) | mesosulfuron + cafenstrole + dymron |
| (I-8) | mesosulfuron + cyhalofop-butyl |
| (I-8) | mesosulfuron + dimepiperate |
| (I-8) | mesosulfuron + esprocarb |
| (I-8) | mesosulfuron + mefenacet |
| (I-8) | mesosulfuron + mefenacet + dymron |
| (I-8) | mesosulfuron + oxaziclomefone |
| (I-8) | mesosulfuron + pretilachlor |
| (I-8) | mesosulfuron + pyributicarb |
| (I-8) | mesotrione |
| (I-8) | metolachlor |
| (I-8) | metolachlor + benoxacor |
| (I-8) | S-metolachlor |
| (I-8) | S-metolachlor + benoxacor |
| (I-8) | metosulam |
| (I-8) | metsulfuron-methyl |
| (I-8) | metribuzin |
| (I-8) | molinate |
| (I-8) | molinate + propanil |
| (I-8) | molinate + simetryn |
| (I-8) | naproanilide |
| (I-8) | nicosulfuron |
| (I-8) | OK-701 |
| (I-8) | oxadiargyl |
| (I-8) | oxadiargyl + propanil |
| (I-8) | oxadiazon |
| (I-8) | oxaziclomefone |
| (I-8) | oxyfluorfen |
| (I-8) | pendimethalin |
| (I-8) | pentoxazone |
| (I-8) | pentoxazone + cumyluron |
| (I-8) | piperophos |
| (I-8) | piperophos + 2,4-D |
| (I-8) | pretilachlor |
| (I-8) | pretilachlor + dimethametryn |
| (I-8) | pretilachlor + dymron |
| (I-8) | pretilachlor + dimethametryn + dymron |
| (I-8) | pretilachlor + fenclorim |
| (I-8) | profoxydim |
| (I-8) | propanil |
| (I-8) | propoxycarbazone-sodium |
| (I-8) | pyraclonil |
| (I-8) | pyrazolate |
| (I-8) | pyrazolate + butachlor |
| (I-8) | pyrazolate + pretilachlor |
| (I-8) | pyrazosulfuron-ethyl |
| (I-8) | pyrazosulfuron-ethyl + dymron |
| (I-8) | pyrazosulfuron-ethyl + indanofan |
| (I-8) | pyrazosulfuron-ethyl + etobenzanid |
| (I-8) | pyrazosulfuron-ethyl + esprocarb |
| (I-8) | pyrazosulfuron-ethyl + esprocarb + dimethametryn |
| (I-8) | pyrazosulfuron-ethyl + esprocarb + pretilachlor |
| (I-8) | pyrazosulfuron-ethyl + mefenacet |
| (I-8) | pyrazosulfuron-ethyl + molinate |
| (I-8) | pyrazosulfuron-ethyl + pentoxazone |
| (I-8) | pyrazosulfuron-ethyl + anilofos + dymron |
| (I-8) | pyrazosulfuron-ethyl + benfuresate + dymron |
| (I-8) | pyrazosulfuron-ethyl + butachlor + dymron |
| (I-8) | pyrazosulfuron-ethyl + cafenstrole |
| (I-8) | pyrazosulfuron-ethyl + cafenstrole + cyhalofop- |
| | butyl |
| (I-8) | pyrazosulfuron-ethyl + dimepiperate + dymron |
| (I-8) | pyrazosulfuron-ethyl + dithiopyr + esprocarb |
| (I-8) | pyrazosulfuron-ethyl + mefenacet + dymron |
| (I-8) | pyrazosulfuron-ethyl + oxaziclomefone + dymron |
| (I-8) | pyrazosulfuron-ethyl + pretilachlor |
| (I-8) | pyrazosulfuron-ethyl + pretilachlor + quinclorac |
| (I-8) | pyrazosulfuron-ethyl + thenylchlor |
| (I-8) | pyrazoxyfen |
| (I-8) | pyribenzoxim |
| (I-8) | pyributicarb |
| (I-8) | pyributicarb + pretilachlor |
| (I-8) | pyriftalid |
| (I-8) | pyriminobac-methyl |
| (I-8) | quinclorac |
| (I-8) | quinoclamine |
| (I-8) | simazine |
| (I-8) | simetryn |
| (I-8) | sulcotrione |
| (I-8) | terbuthylazine |
| (I-8) | thenylchlor |
| (I-8) | thifensulfuron-methyl |
| (I-8) | tiocarbazil |
| (I-8) | tritosulfuron |
| (I-65) | acetochlor |
| (I-65) | acetochlor + dichlormid |
| (I-65) | acetochlor + furilazole |
| (I-65) | acetochlor + R-29148 |
| (I-65) | alachlor |
| (I-65) | amicarbazone |
| (I-65) | amidosulfuron |
| (I-65) | anilofos |
| (I-65) | anilofos + 2,4-D |
| (I-65) | anilofos + propanil |
| (I-65) | anilofos + quinoclamine |
| (I-65) | atrazine |
| (I-65) | azimsulfuron |
| (I-65) | azimsulfuron + dymron |
| (I-65) | azimsulfuron + anilofos |
| (I-65) | azimsulfuron + benfuresate |
| (I-65) | azimsulfuron + bensulfuron |
| (I-65) | azimsulfuron + butachlor |
| (I-65) | azimsulfuron + cafenstrole |
| (I-65) | azimsulfuron + cyhalofop-butyl |
| (I-65) | azimsulfuron + dimepiperate |
| (I-65) | azimsulfuron + esprocarb |
| (I-65) | azimsulfuron + mefenacet |
| (I-65) | azimsulfuron + indanofan |
| (I-65) | azimsulfuron + oxaziclomefone |
| (I-65) | azimsulfuron + pretilachlor |
| (I-65) | azimsulfuron + thenylchlor |
| (I-65) | azimsulfuron + anilofos + dymron |
| (I-65) | azimsulfuron + benfuresate + dymron |
| (I-65) | azimsulfuron + bensulfuron + cafenstrole |
| (I-65) | azimsulfuron + bensulfuron + cyhalofop-butyl |
| (I-65) | azimsulfuron + bensulfuron + dymron |
| (I-65) | azimsulfuron + bensulfuron + dimethametryn |
| (I-65) | azimsulfuron + bensulfuron + indanofan |
| (I-65) | azimsulfuron + bensulfuron + pretilachlor |
| (I-65) | azimsulfuron + bensulfuron + thenylchlor |
| (I-65) | azimsulfuron + butachlor + dymron |
| (I-65) | azimsulfuron + cafenstrole + dymron |
| (I-65) | azimsulfuron + cyhalofop-butyl + dymron |
| (I-65) | azimsulfuron + mefenacet + dymron |
| (I-65) | azimsulfuron + oxaziclomefone + dymron |
| (I-65) | azimsulfuron + pretilachlor + dymron |
| (I-65) | benfuresate |
| (I-65) | bensulfuron-methyl |
| (I-65) | bensulfuron-methyl + dymron |
| (I-65) | bensulfuron-methyl + anilofos |
| (I-65) | bensulfuron-methyl + benfuresate |
| (I-65) | bensulfuron-methyl + butachlor |
| (I-65) | bensulfuron-methyl + cafenstrole |
| (I-65) | bensulfuron-methyl + cyhalofop-butyl |
| (I-65) | bensulfuron-methyl + dimepiperate |
| (I-65) | bensulfuron-methyl + dithiopyr |
| (I-65) | bensulfuron-methyl + esprocarb |
| (I-65) | bensulfuron-methyl + indanofan |
| (I-65) | bensulfuron-methyl + mefenacet |
| (I-65) | bensulfuron-methyl + metsulfuron-methyl |
| (I-65) | bensulfuron-methyl + molinate |
| (I-65) | bensulfuron-methyl + oxaziclomefone |
| (I-65) | bensulfuron-methyl + pretilachlor |
| (I-65) | bensulfuron-methyl + pyributicarb |
| (I-65) | bensulfuron-methyl + quinclorac |
| (I-65) | bensulfuron-methyl + thenylchlor |
| (I-65) | bensulfuron-methyl + anilofos + dymron |
| (I-65) | bensulfuron-methyl + benfuresate + dymron |
| (I-65) | bensulfuron-methyl + butachlor + dymron |
| (I-65) | bensulfuron-methyl + benfuresate + dimepiperate |
| (I-65) | bensulfuron-methyl + benfuresate + pretilachlor |
| (I-65) | bensulfuron-methyl + cafenstrole + dymron |
| (I-65) | bensulfuron-methyl + cafenstrole + cyhalofop-butyl |
| (I-65) | bensulfuron-methyl + cyhalofop-butyl + dymron |
| (I-65) | bensulfuron-methyl + cyhalofop-butyl + thenylchlor |
| (I-65) | bensulfuron-methyl + dithiopyr + quinclorac |
| (I-65) | bensulfuron-methyl + mefenacet + dymron |
| (I-65) | bensulfuron-methyl + mefenacet + benthiocarb |
| (I-65) | bensulfuron-methyl + mefenacet + molinate |
| (I-65) | bensulfuron-methyl + oxaziclomefone + dymron |
| (I-65) | bensulfuron-methyl + pretilachlor + dymron |
| (I-65) | bensulfuron-methyl + pyributicarb + dymron |
| (I-65) | bentazone |
| (I-65) | bentazone + quinclorac |
| (I-65) | benthiocarb (thiobencarb) |
| (I-65) | benthiocarb + chlornitrofen |
| (I-65) | benthiocarb + propanil |
| (I-65) | benthiocarb + simetryn |
| (I-65) | benzobicyclon |
| (I-65) | benzofenap |
| (I-65) | benzofenap + thenylchlor + cumyluron |
| (I-65) | bifenox |
| (I-65) | bifenox + pretilachlor |
| (I-65) | bifenox + thenylchlor |
| (I-65) | bispyribac-sodium |
| (I-65) | bispyribac-sodium + benthiocarb |
| (I-65) | bromobutide |
| (I-65) | bromobutide + pyrazoxyfen |
| (I-65) | bromobutide + benzofenap + pyributicarb |
| (I-65) | bromobutide + bifenox + pyrazolate |
| (I-65) | bromobutide + pyrazoxyfen + thenylchlor |
| (I-65) | butachlor |
| (I-65) | butachlor + chlomethoxyfen |
| (I-65) | butachlor + oxadiazon |
| (I-65) | butachlor + propanil |
| (I-65) | butachlor + pyrazolate |
| (I-65) | butamifos |
| (I-65) | butamifos + bromobutide |
| (I-65) | butenachlor |
| (I-65) | cafenstrole |
| (I-65) | cafenstrole + dymron |
| (I-65) | cafenstrole + cyhalofop-butyl + dymron |
| (I-65) | carfentrazone-ethyl |
| (I-65) | chlomethoxyfen |
| (I-65) | chlornitrofen |
| (I-65) | chlornitrofen + dymron |
| (I-65) | cinmethylin |
| (I-65) | cinmethylin + 65,4-D |
| (I-65) | cinosulfuron |
| (I-65) | cinosulfuron + dymron |
| (I-65) | cinosulfuron + anilofos |
| (I-65) | cinosulfuron + benfuresate |
| (I-65) | cinosulfuron + butachlor |
| (I-65) | cinosulfuron + cafenstrole + dymron |
| (I-65) | cinosulfuron + cyhalofop-butyl |
| (I-65) | cinosulfuron + dimepiperate |
| (I-65) | cinosulfuron + esprocarb |
| (I-65) | cinosulfuron + mefenacet |
| (I-65) | cinosulfuron + mefenacet + dymron |
| (I-65) | cinosulfuron + molinate |
| (I-65) | cinosulfuron + oxaziclomefone |
| (I-65) | cinosulfuron + pretilachlor |
| (I-65) | cinosulfuron + pretilachlor + dymron |
| (I-65) | cinosulfuron + pretilachlor + fenclorim |
| (I-65) | cinosulfuron + pretilachlor + quinclorac |
| (I-65) | cinosulfuron + pyriftalid |
| (I-65) | clefoxydim |
| (I-65) | clodinafop-propargyl |
| (I-65) | clodinafop-propargyl + cloquintocet-mexyl |
| (I-65) | clomazone |
| (I-65) | clomazone + propanil |
| (I-65) | clomeprop |
| (I-65) | clomeprop + pretilachlor |
| (I-65) | cumyluron |
| (I-65) | cyanazine |
| (I-65) | cyclosulfamuron |
| (I-65) | cyclosulfamuron + dymron |
| (I-65) | cyclosulfamuron + anilofos |
| (I-65) | cyclosulfamuron + benfuresate |
| (I-65) | cyclosulfamuron + butachlor |
| (I-65) | cyclosulfamuron + cafenstrole + dymron |
| (I-65) | cyclosulfamuron + cyhalofop-butyl |
| (I-65) | cyclosulfamuron + dimepiperate |
| (I-65) | cyclosulfamuron + esprocarb |
| (I-65) | cyclosulfamuron + mefenacet |
| (I-65) | cyclosulfamuron + mefenacet + dymron |
| (I-65) | cyclosulfamuron + oxaziclomefone |
| (I-65) | cyclosulfamuron + pentoxazone |
| (I-65) | cyclosulfamuron + pretilachlor |
| (I-65) | cyclosulfamuron + quinclorac |
| (I-65) | cyhalofop-butyl |
| (I-65) | cyhalofop-butyl + bentazon |
| (I-65) | 65,4-D |
| (I-65) | dichlorprop-P |
| (I-65) | diethatyl-ethyl |
| (I-65) | dimepiperate |
| (I-65) | dimethametryn |
| (I-65) | dimethametryn + piperophos |
| (I-65) | dimethenamid |
| (I-65) | S-dimethenamid |
| (I-65) | dithiopyr |
| (I-65) | dymron |
| (I-65) | esprocarb |
| (I-65) | ethoxysulfuron |
| (I-65) | ethoxysulfuron + dymron |
| (I-65) | ethoxysulfuron + anilofos |
| (I-65) | ethoxysulfuron + anilofos + dymron |
| (I-65) | ethoxysulfuron + benfuresate |
| (I-65) | ethoxysulfuron + anilofos + benfuresate |
| (I-65) | ethoxysulfuron + benfuresate + dymron |
| (I-65) | ethoxysulfuron + butachlor |
| (I-65) | ethoxysulfuron + cafenstrole |
| (I-65) | ethoxysulfuron + cafenstrole + dymron |
| (I-65) | ethoxysulfuron + cyhalofop-butyl |
| (I-65) | ethoxysulfuron + dimepiperate |
| (I-65) | ethoxysulfuron + esprocarb |
| (I-65) | ethoxysulfuron + mefenacet |
| (I-65) | ethoxysulfuron + mefenacet + dymron |
| (I-65) | ethoxysulfuron + oxaziclomefone |
| (I-65) | ethoxysulfuron + pretilachlor + dymron |
| (I-65) | ethoxysulfuron + pretilachlor + pyrazolate |
| (I-65) | etobenzanid |
| (I-65) | fenoxaprop-(P)-ethyl |
| (I-65) | fenoxaprop-(P)-ethyl + fenclorim |
| (I-65) | fenoxaprop-(P)-ethyl + isoxadifen-ethyl |
| (I-65) | fenoxaprop-(P)-ethyl + mefenpyr-diethyl |
| (I-65) | fentrazamide |
| (I-65) | fentrazamide + pentoxazone |
| (I-65) | fentrazamide + bispyribac-sodium |
| (I-65) | fentrazamide + bromobutide |
| (I-65) | fentrazamide + benzofenap |
| (I-65) | fentrazamide + clomeprop |
| (I-65) | fentrazamide + dymron |
| (I-65) | fentrazamide + flufenacet |
| (I-65) | fentrazamide + oxaziclomefone |
| (I-65) | fentrazamide + propanil |
| (I-65) | fentrazamide + pyribenzoxim |
| (I-65) | fentrazamide + pyriminobac-methyl |
| (I-65) | fentrazamide + quinoclamine |
| (I-65) | fentrazamide + azimsulfuron |
| (I-65) | fentrazamide + azimsulfuron + dymron |
| (I-65) | fentrazamide + azimsulfuron + bensulfuron-methyl |
| (I-65) | fentrazamide + bensulfuron-methyl |
| (I-65) | fentrazamide + bensulfuron-methyl + dymron |
| (I-65) | fentrazamide + cinosulfuron |
| (I-65) | fentrazamide + cinosulfuron + dymron |
| (I-65) | fentrazamide + cyclosulfamuron |
| (I-65) | fentrazamide + cyclosulfamuron + dymron |
| (I-65) | fentrazamide + ethoxysulfuron |
| (I-65) | fentrazamide + ethoxysulfuron + dymron |
| (I-65) | fentrazamide + imazosulfuron |
| (I-65) | fentrazamide + imazosulfuron + dymron |
| (I-65) | fentrazamide + pyrazosulfuron-ethyl |
| (I-65) | fentrazamide + pyrazosulfuron-ethyl + dymron |
| (I-65) | fluazifop-P-butyl |
| (I-65) | flucarbazone-sodium |
| (I-65) | flucarbazone-sodium + fenclorim |
| (I-65) | flucarbazone-sodium + isoxadifen-ethyl |
| (I-65) | flucarbazone-sodium + mefenpyr-diethyl |
| (I-65) | flufenacet |
| (I-65) | flufenacet + 65,4-D |
| (I-65) | flufenacet + diflufenican |
| (I-65) | flufenacet + metosulam |
| (I-65) | flufenacet + propanil |
| (I-65) | flufenacet + dichlormid |
| (I-65) | flufenacet + furilazole |
| (I-65) | flufenacet + R-659148 |
| (I-65) | flufenacet + fenclorim |
| (I-65) | flufenacet + isoxadifen-ethyl |
| (I-65) | flufenacet + mefenpyr-diethyl |
| (I-65) | flumetsulam |
| (I-65) | halosulfuron-methyl |
| (I-65) | halosulfuron-methyl + cafenstrole + cyhalofop-butyl |
| (I-65) | halosulfuron-methyl + cafenstrole + dymron |
| (I-65) | halosulfuron-methyl + cyhalofop-butyl + dymron |
| (I-65) | haloxyfop-P-methyl |
| (I-65) | HOK-6501 |
| (I-65) | imazamox |
| (I-65) | imazaquin |
| (I-65) | imazethapyr |
| (I-65) | imazosulfuron |
| (I-65) | imazosulfuron + dymron |
| (I-65) | imazosulfuron + anilofos |
| (I-65) | imazosulfuron + benfuresate |
| (I-65) | imazosulfuron + butachlor |
| (I-65) | imazosulfuron + cafenstrole + dymron |
| (I-65) | imazosulfuron + cyhalofop-butyl |
| (I-65) | imazosulfuron + dimepiperate |
| (I-65) | imazosulfuron + dimethametryn |
| (I-65) | imazosulfuron + dimethametryn + pretilachlor |
| (I-65) | imazosulfuron + esprocarb + dymron |
| (I-65) | imazosulfuron + etobenzanid + dymron |
| (I-65) | imazosulfuron + mefenacet + dymron |
| (I-65) | imazosulfuron + oxaziclomefone |
| (I-65) | imazosulfuron + pentoxazone + dymron |
| (I-65) | imazosulfuron + pretilachlor + dymron |
| (I-65) | imazosulfuron + pyributicarb + dymron |
| (I-65) | indanofan |
| (I-65) | isoxaflutole |
| (I-65) | MCPA |
| (I-65) | mefenacet |
| (I-65) | mefenacet + molinate |
| (I-65) | mefenacet + quinoclamine |
| (I-65) | mefenacet + bromobutide + naproanilide |
| (I-65) | mesosulfuron |
| (I-65) | mesosulfuron + dymron |
| (I-65) | mesosulfuron + anilofos |
| (I-65) | mesosulfuron + benfuresate |
| (I-65) | mesosulfuron + cafenstrole + dymron |
| (I-65) | mesosulfuron + cyhalofop-butyl |
| (I-65) | mesosulfuron + dimepiperate |
| (I-65) | mesosulfuron + esprocarb |
| (I-65) | mesosulfuron + mefenacet |
| (I-65) | mesosulfuron + mefenacet + dymron |
| (I-65) | mesosulfuron + oxaziclomefone |
| (I-65) | mesosulfuron + pretilachlor |
| (I-65) | mesosulfuron + pyributicarb |
| (I-65) | mesotrione |
| (I-65) | metolachlor |
| (I-65) | metolachlor + benoxacor |
| (I-65) | S-metolachlor |
| (I-65) | S-metolachlor + benoxacor |
| (I-65) | metosulam |
| (I-65) | metsulfuron-methyl |
| (I-65) | metribuzin |
| (I-65) | molinate |
| (I-65) | molinate + propanil |
| (I-65) | molinate + simetryn |
| (I-65) | naproanilide |
| (I-65) | nicosulfuron |
| (I-65) | OK-701 |
| (I-65) | oxadiargyl |
| (I-65) | oxadiargyl + propanil |
| (I-65) | oxadiazon |
| (I-65) | oxaziclomefone |
| (I-65) | oxyfluorfen |
| (I-65) | pendimethalin |
| (I-65) | pentoxazone |
| (I-65) | pentoxazone + cumyluron |
| (I-65) | piperophos |
| (I-65) | piperophos + 65,4-D |
| (I-65) | pretilachlor |
| (I-65) | pretilachlor + dimethametryn |
| (I-65) | pretilachlor + dymron |
| (I-65) | pretilachlor + dimethametryn + dymron |
| (I-65) | pretilachlor + fenclorim |
| (I-65) | profoxydim |
| (I-65) | propanil |
| (I-65) | propoxycarbazone-sodium |
| (I-65) | pyraclonil |
| (I-65) | pyrazolate |
| (I-65) | pyrazolate + butachlor |
| (I-65) | pyrazolate + pretilachlor |
| (I-65) | pyrazosulfuron-ethyl |
| (I-65) | pyrazosulfuron-ethyl + dymron |
| (I-65) | pyrazosulfuron-ethyl + indanofan |
| (I-65) | pyrazosulfuron-ethyl + etobenzanid |
| (I-65) | pyrazosulfuron-ethyl + esprocarb |
| (I-65) | pyrazosulfuron-ethyl + esprocarb + dimethametryn |
| (I-65) | pyrazosulfuron-ethyl + esprocarb + pretilachlor |
| (I-65) | pyrazosulfuron-ethyl + mefenacet |
| (I-65) | pyrazosulfuron-ethyl + molinate |
| (I-65) | pyrazosulfuron-ethyl + pentoxazone |
| (I-65) | pyrazosulfuron-ethyl + anilofos + dymron |
| (I-65) | pyrazosulfuron-ethyl + benfuresate + dymron |
| (I-65) | pyrazosulfuron-ethyl + butachlor + dymron |
| (I-65) | pyrazosulfuron-ethyl + cafenstrole |
| (I-65) | pyrazosulfuron-ethyl + cafenstrole + cyhalofop-butyl |
| (I-65) | pyrazosulfuron-ethyl + dimepiperate + dymron |
| (I-65) | pyrazosulfuron-ethyl + dithiopyr + esprocarb |
| (I-65) | pyrazosulfuron-ethyl + mefenacet + dymron |
| (I-65) | pyrazosulfuron-ethyl + oxaziclomefone + dymron |
| (I-65) | pyrazosulfuron-ethyl + pretilachlor |
| (I-65) | pyrazosulfuron-ethyl + pretilachlor + quinclorac |
| (I-65) | pyrazosulfuron-ethyl + thenylchlor |
| (I-65) | pyrazoxyfen |
| (I-65) | pyribenzoxim |
| (I-65) | pyributicarb |
| (I-65) | pyributicarb + pretilachlor |
| (I-65) | pyriftalid |
| (I-65) | pyriminobac-methyl |
| (I-65) | quinclorac |
| (I-65) | quinoclamine |
| (I-65) | simazine |
| (I-65) | simetryn |
| (I-65) | sulcotrione |
| (I-65) | terbuthylazine |
| (I-65) | thenylchlor |
| (I-65) | thifensulfuron-methyl |
| (I-65) | tiocarbazil |
| (I-65) | tritosulfuron |

Surprisingly, it has now been found that the above-defined active compound combinations of the substituted aryl ketones of the formula (I) and the above-mentioned active compounds of group 2 exhibit a particularly high herbicidal activity combined with very good crop plant compatibility and can be used for the selective control of monocotyledonous and dicotyledonous weeds in a variety of crops, especially in cotton, barley, potatoes, maize, rice, soybeans, sunflower, wheat and sugar cane, in particular in barley, maize, rice and wheat, very particularly in rice, and additionally also for controlling monocotyledonous and dicotyledonous weeds in the semi- and nonselective field.

Surprisingly, the herbicidal activity of the active compound combinations according to the invention, of compounds of the abovementioned groups 1 and 2 exceeds the total of the actions of the individual active compounds considerably.

Thus, not just a complementation of actions but a synergistic effect is present which could not have been predicted. The novel active compound combinations are well tolerated in a variety of crops, also effecting good control of weeds which are otherwise difficult to control. Thus, the novel active compound combinations are a valuable addition to the herbicides.

The synergistic effect of the active compound combinations according to the invention is particularly strongly pronounced in certain concentration ratios. However, the weight ratios of the active compounds in the active compound combinations may be varied within relatively wide ranges. In general, from 0.01 to 1000 parts by weight, preferably from 0.02 to 500 parts by weight and particularly preferably from 0.05 to 100 parts by weight of active compound of group 2 are used per part by weight of active compound of the formula (I).

The following may be particularly emphasized as mixing components from amongst the active compounds of group 3:
1-methyl-hexyl 5-chloro-quinoxalin-8-oxy-acetate (cloquintocet-mexyl), ethyl 4,5-dihydro-5,5-diphenyl-3-isoxazolecarboxylate (isoxadifen-ethyl) and diethyl-1-(2,4-dichloro-phenyl)-4,5-dihydro-5-methyl-1H-pyrazole-3,5-dicarboxylate (mefenpyr-diethyl) particularly suitable to improve tolerance in cereals, and 4-dichloroacetyl-1-oxa-4-aza-spiro[4.5]-decane (AD-67), 1-dichloro-acetyl-hexahydro-3,3,8a-trimethylpyrrolo[1,2-a]-pyrimidin-6(2H)-one (BAS-145138), 4-dichloroacetyl-3,4-dihydro-3-methyl-2H-1,4-benzoxazin (benoxacor), 2,2-dichloro-N,N-di-2-propenyl-acetamide (dichlormid), 3-dichloroacetyl-5-(2-furanyl)-2,2-dimethyl-oxazolidine (furilazole, MON-13900), and 3-dichloroacetyl-2,2,5-trimethyl-oxazolidine (R-29148) particularly suitable to improve tolerance in maize.

It must be considered as surprising that, from amongst a large number of known safeners or antidotes capable of antagonizing the harmful effect of a herbicide on the crop plants, it is precisely the abovementioned compounds of group 3 which are capable of almost completely compensating the harmful effect, on the crop plants, of active compounds of the formula (I) and their salts, if appropriate also in combination with one or more of the abovementioned active compounds of group 2, without adversely affecting the herbicidal efficacy towards the weeds.

Surprisingly, it has furthermore been found that the herbicidally active substance 2,3-dichlorophenoxy-acetic acid (2,4-D) and its derivatives can also play the safener role described above.

Accordingly, another preferred embodiment is a mixture comprising a compound of the formula (I) and/or its salts and 2,4-D and/or its salts, optionally in combination with one or more of the abovementioned active compounds of group 2. Typical derivatives of 2,4-D are, for example, its esters.

Surprisingly, it has also been found that the herbicidally active substances (4-chloro-2-methylphenoxy)acetic acid (MCPA) and (+−)-2-(4-chloro-2-methylphenoxy)-propanoic acid (mecoprop) can likewise act as safeners. The compounds mentioned are described in the following patent applications: JP 63 072 605 and GB 00 820 180.

The compounds diethyl 1-(2,4-dichlorophenyl)-4,5-dihydro-5-methyl-1H-pyrazole-3,5-dicarboxylate (mefenpyr-diethyl), 1-methyl-hexyl [(5-chloro-8-quinolinyl)-oxy]acetate (cloquintocet-mexyl) and ethyl 1-(2,4-dichlorophenyl)-5-(trichloro-methyl)-1H-1,2,4-triazole-3-carboxylate (fenchlorazole-ethyl) are described in the following patent applications: DE-A-39 39 503, EP-A-191 736 and DE-A-35 25 205, respectively. 2,4-D is a known herbicide.

The advantageous effect of the crop plant compatibility of the active compound combinations according to the invention is likewise particularly strongly pronounced at certain concentration ratios. However, the weight ratios of the active compounds in the active combinations can be varied within relatively wide ranges. In general, from 0.001 to 1000 parts by weight, preferably from 0.01 to 100 parts by weight and particularly preferably from 0.1 to 10 parts by weight of one of the crop-plant-compatibility-improving compounds (antidotes/safeners) mentioned above under (c) are used per part by weight of active compound of the formula (1) or its mixtures with active compounds of group 2.

All plants and plant parts can be treated in accordance with the invention. Plants are to be understood as meaning in the present context all plants and plant populations such as desired and undesired wild plants or crop plants (inclusive of naturally occurring crop plants). Crop plants can be plants which can be obtained by conventional plant breeding and optimization methods or by biotechnological and recombinant methods or by combinations of these methods, inclusive of the transgenic plants and inclusive of the plant varieties protectable or not protectable by plant breeders' rights. Plant parts are to be understood as meaning all aerial and subterranean plant parts and organs of the plants such as shoot, leaf, flower and root, examples which may be mentioned being leaves, needles, stalks, trunks, flowers, fruiting bodies, fruits, and seeds, and also roots, tubers and rhiozomes. The plant parts also include vegetative and generative propagation material, for example cuttings, tubers, rhizomes, seedlings and seeds.

As already mentioned above, it is possible to treat all plants and their parts according to the invention. In a preferred embodiment, wild plant species and plant cultivars, or those obtained by conventional biological breeding, such as crossing or protoplast fusion, and parts thereof, are treated. In a further preferred embodiment, transgenic plants and plant cultivars obtained by genetic engineering, if appropriate in combination with conventional methods (Genetically Modified Organisms), and parts thereof are treated. The term “parts” or “parts of plants” or “plant parts” has been explained above.

Particularly preferably, plants of the plant cultivars which are in each case commercially available or in use are treated according to the invention. Plant cultivars are to be understood as meaning plants having novel properties (“traits”) which can be obtained by conventional breeding, by mutagenesis or by recombinant DNA techniques. This can be varieties, bio- and genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions to be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferred according to the invention include all plants which, in the genetic modification, received genetic material which imparted particularly advantageous useful traits to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapevines), and particular emphasis is given to maize, soya beans, potatoes, cotton and oilseed rape. Traits that are emphasized are in particular increased defence of the plants against insects by toxins formed in the plants, in particular those formed by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (hereinbelow referred to as “Bt plants”). Traits that are also particularly emphasized are the increased defence of the plants to fungi, bacteria and viruses by systemic acquired resistance (SAR), systemin, phytoalexius, elicitors and resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these or still to be developed genetic traits, which plants will be developed and/or marketed in the future.

The plants listed can be treated according to the invention in a particularly advantageous manner with the compounds of the general formula I or the active compound mixtures according to the invention. The preferred ranges stated above for the active compounds or mixtures also apply to the treatment of these plants. Particular emphasis is given to the treatment of plants with the compounds or the mixtures specifically mentioned in the present text.

The treatment according to the invention, of the plant and plant parts with the active compounds is carried out directly or by allowing the compounds to act on their surroundings, environment or storage space by the customary treatment methods, for example by immersion, spraying, evaporation, fogging, scattering, painting on and, in the case of propagation material, in particular in the case of seeds, also by applying one or more coats.

Amongst the plants obtained by biotechnological and recombinant methods, or by combining these methods, plants which are emphasized are those which tolerate so-called ALS, 4-HPPD, EPSP and/or PPO inhibitors, such as, for example, Acuron plants.

The active compounds according to the invention can be used, for example, in the following plants:

Dicotyledonous weeds of the genera: Abutilon, Amaranthus, Ambrosia, Anoda, Anthemis, Aphanes, Atriplex, Bellis, Bidens, Capsella, Carduus, Cassia, Centaurea, Chenopodium, Cirsium, Convolvulus, Datura, Desmodium, Emex, Erysimum, Euphorbia, Galeopsis, Galinsoga, Galium, Hibiscus, Ipomoea, Kochia, Lamium, Lepidium, Lindernia, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Solanum, Sonchus, Sphenoclea, Stellaria, Taraxacum, Thlaspi, Trifolium, Urtica, Veronica, Viola, Xanthium.

Dicotyledonous crops of the genera: Arachis, Beta, Brassica, Cucumis, Cucurbita, Helianthus, Daucus, Glycine, Gossypium, Ipomoea, Lactuca, Linum, Lycopersicon, Nicotiana, Phaseolus, Pisum, Solanum, Vicia.

Monocotyledonous weeds of the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria, Sorghum.

Monocotyledonous crops of the genera: Allium, Ananas, Asparagus, Avena, Hordeum, Oryza, Panicum, Saccharum, Secale, Sorghum, Triticale, Triticum, Zea.

However, the use of the active compound combinations according to the invention is in no way restricted to these genera, but also extends in the same manner to other plants.

The active compound combinations to be used in accordance with the invention can be employed not only in conventional cultivation methods (suitably spaced row crops), in plantation crops (for example grapevines, fruit, citrus) and in industrial plants and railtracks, on paths and squares, but also for stubble treatment and in the minimum tillage method. They are furthermore suitable as dessicants (haulm killing in, for example, potatoes) or as defoliants (for example in cotton). They are furthermore suitable for use on non-crop areas. Other fields of application are nurseries, forests, grassland and the production of ornamentals.

The active compound combinations can be converted into the customary formulations such as solutions, emulsions, wettable powders, suspensions, powders, dusts, pastes, soluble powders, granules, suspo-emulsion concentrates, natural and synthetic materials impregnated with active compound, and microencapsulations in polymeric materials.

These formulations are produced in a known manner, for example by mixing the active compounds with extenders, that is, liquid solvents and/or solid carriers, optionally with the use of surfactants, that is, emulsifiers and/or dispersants and/or foam formers.

If the extender used is water, it is also possible to employ, for example, organic solvents as cosolvents. The following are essentially suitable as liquid solvents: aromatics such as xylene, toluene, or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Solid carriers which are suitable are:
for example ammonium salts and ground natural minerals such as kaolins, clays, talc, chalk, quartz, attapulgite, montmorillonite or diatomaceous earth, and ground synthetic materials such as highly-dispersed silica, alumina and silicates; suitable solid carriers for granules are for example crushed and fractionated natural rocks such as calcite, marble, pumice, sepiolite and dolomite, or else synthetic granules of inorganic and organic meals, and granules of organic material such as sawdust, coconut shells, corn cobs and tobacco stalks; suitable emulsifiers and/or foam formers are for example nonionic and anionic emulsifiers such as polyoxyethylene fatty acid esters, polyoxyethylene fatty alcohol ethers, for example alkylaryl polyglycol ethers, alkylsulphonates, alkyl sulphates, arylsulphonates, or else protein hydrolyzates; suitable dispersants are for example lignosulphite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95 percent by weight of active compounds, preferably between 0.5 and 90%.

The active compound combinations according to the invention are generally applied in the form of ready mixes. However, the active compounds contained in the active compound combinations may also be applied in the form of individual formulations which are mixed upon use, that is, in the form of tank mixes.

The novel active compound combinations, as such or in their formulations, may furthermore also be used as a mixture with other known herbicides, again with ready mixes or tank mixes being possible. A mixture with other known active compounds such as fungicides, insecticides, acaricides, nematicides, bird repellents, growth substances, plant nutrients and soil conditioners is also possible. It may furthermore be advantageous for specific applications, in particular for the post-emergence method, to incorporate into the formulations plant-compatible mineral or vegetable oils (for example the commercial product “Rako Binol”) or ammonium salts such as, for example, ammonium sulphate or ammonium thiocyanate, as further additives.

The novel active compound combinations can be used as such, in the form of their formulations or the use forms which can be prepared from these formulations by further dilution, such as ready-to-use solutions, suspensions, emulsions, powders, pastes and granules. Application is effected in the customary manner, for example by pouring, spraying, atomizing, dusting or broadcasting.

The active compound combinations according to the invention can be applied before and after emergence of the plants, that is to say by the pre- and post-emergence method. They may also be incorporated into the soil prior to sowing.

The good herbicidal activity of the novel active compound combinations is demonstrated by the examples below. Whereas there are deficits in the herbicidal action of the individual active compounds, the combinations all have very good action against weeds which exceeds a simple addition of activities.

A synergistic effect in herbicides is always present when the herbicidal action of the active compound combination exceeds the action of the active compounds when applied individually.

The expected action for a given combination of two herbicides can be calculated as follows (cf. COLBY, S. R.: “Calculating synergistic and antagonistic responses of herbicide combinations”, Weeds 15, pages 20-22, 1967):

If

X=% damage by herbicide A (active compound of the formula I) at an application rate of p kg/ha
   and
Y=% damage by herbicide B (active compound of the formula II) at an application rate of q kg/ha
   and
E=the expected damage of herbicides A and B at an application rate of p and q kg/ha,
   then
   E=X+Y−(X*Y/100).

If the actual damage exceeds the calculated value, the combination has a superadditive effect, that is to say a synergistic effect.

The expected activity for a given combination of three herbicides can likewise be found in the literature cited above.

### USE EXAMPLES

### Example A

### Greenhouse

Test in transplanted paddy rice

| | |
|---|---|
| Solvent: | 5 parts by weight of acetone |
| Emulsifier: | 1 part by weight of benzyloxy polyglycol ether |

To produce a preparation of active compound, 1 part by weight of an active compound combination according to the invention is mixed with the stated amount of solvent and, after addition of the stated amount of the emulsifier, diluted with water to the desired concentration.

Vessels for planting (500 cm²) are filled with soil from a rice field, and in each case 3 rice plants (cultivar: Nipponbare, 2-3-leaf stage, height: about 15 cm) are planted into the middle of vessels for planting. Into the same vessels for planting, seeds are sown. The soil in the vessels is kept moist. After two days, each vessel for planting is flooded to a water depth of 2-3 cm.

Five days after the rice plants were transplanted, the amount of active compound is, in the preparation described above, applied to the surface of the water in the vessels for planting using a pipette. The water depth in the vessels for planting is maintained at 2-3 cm.

3 weeks after the application of active compound, the efficacy is rated in % damage in comparison to the untreated control.

The figure denotes

| | |
|---|---|
| 0% | no effect/damage (like untreated control) |
| 100% | total destruction |

Active compounds, application rates and results are shown in Table A1 below, the abbreviations used in the table having the following meanings:
(I-65) N-[2,6-dichloro-3-[2,6-dioxocyclohexyl)-carbonyl]-phenyl]pyrrolidone-1-carboxamide
(I-2) N′-[2,6-dichloro-3-[(2,6-dioxo-cyclohexyl)-carbonyl]-phenyl]-N-methoxy-N-methyl-urea
(A) fentrazamide

(B) indanofan

TABLE A1

| | | Damage to | Damage | |
|---|---|---|---|---|
| Active | Application | Lindernia | (calculated | |
| compound or | rate(s) | pyxidari | according | Damage to rice |
| combination | (g/ha) | (%) | to Colby) (%) | (%) |
| (I-2) | 200 | 60 | | 0 |
| (A) | 150 | 70 | | 0 |
| (I-2) + (A) | 125 + 150 | 97 | 88 | 0 |

TABLE B1

| Active compound | Application rate | Damage (to | Damage (calculated |
|---|---|---|---|
| or combination | (g/ha) | ROT/N) (%) | according to Colby) |
| (I-65) | 25 | 20 | — |
| A | 50 | 60 | — |
| (I-65) + A | 25 + 50 | 97 | 68 |

TABLE B2

| Active compound | Application rate | Damage (to | Damage (calculated |
|---|---|---|---|
| or combination | (g/ha) | DOPJU) (%) | according to Colby) |
| (I-65) | 25 | 60 | — |
| A | 50 | 50 | — |
| (I-65) + A | 25 + 50 | 100 | 80 |

TABLE B3

| Active compound | Application rate | Damage (to | Damage (calculated |
|---|---|---|---|
| or combination | (g/ha) | ROT/N) (%) | according to Colby) |
| (I-65) | 50 | 30 | — |
| B | 50 | 2 | — |
| (I-65) + B | 50 + 50 | 100 | 75.5 |

1-9. (canceled)

10. A composition comprising an effective amount of an active compound combination comprising
(a) at least one substituted aryl ketone of the formula (I) 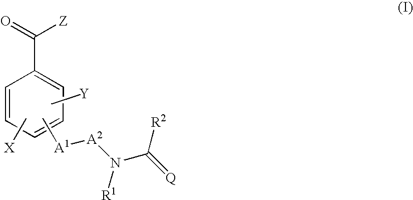
including any tautomeric forms thereof or a salt or an acid or base adduct of a compound of formula (I) including any tautomeric forms thereof, in which
A¹ represents a single bond or represents O,
A² represents a single bond or represents alkanediyl, alkenediyl, or alkynediyl,
Q represents O or S,
R¹ represents hydrogen or represents in each case optionally substituted alkyl, akylthio, alkylsulphinyl, alkylsulphonyl, alkenyl, alkynyl, cycloalkyl, cycloalkylalkyl, aryl, or arylalkyl; or represents the grouping —C(Q)-R²,
R² represents hydrogen, amino, cyanoamino, nitroamino, hydroxyamino, or hydrazine; or represents optionally substituted alkyl, alkylcarbonyl, alkoxy, alkoxycarbonyl, alkylthio, alkylamino, dialkylamino, alkoxyamino, N-alkyl-alkoxyamino, alkylhydrazino, dialkylhydrazino, alkenyl, alkenyloxy, alkenylamino, alkenyloxyamino, alkynyl, alkynyloxy, alkynylamino, cycloalkyl, cycloalkyloxy, cycloalkylamino, cycloalkylalkyl, cycloalkylalkoxy, cycloalkylalkylamino, aryl, arylcarbonyl, aryloxy, aryloxycarbonyl, arylthio, arylamino, arylhydrazino, arylalkyl, arylalkoxy, arylalkylthio, arylalkylamino, heterocyclyl, heterocyclyloxy, heterocyclylthio, heterocyclylamino, heterocyclylalkyl, heterocyclylalkoxy, heterocyclylalkylthio, or heterocyclylalkylamino,
X represents hydrogen, nitro, cyano, carboxy, carbamoyl, thiocarbamoyl, or halogen; or represents optionally substituted alkyl, alkoxy, alkylthio, alkylsulphinyl, alkylsulphonyl, alkylamino, dialkylamino, or dialkylaminosulphonyl,
Y represents hydrogen, nitro, cyano, carboxy, carbamoyl, thiocarbamoyl, or halogen; or represents optionally substituted alkyl, alkoxy, alkylthio, alkylsulphinyl, alkylsulphonyl, alkylamino, dialkylamino, or dialkylaminosulphonyl, and
Z represents one of the groups 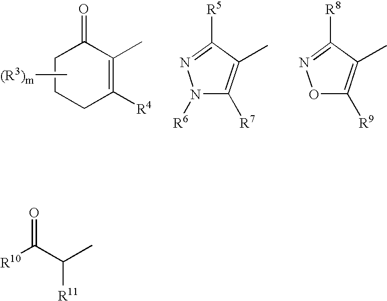
where
m represents the numbers 0 to 6,
R³ represents hydrogen or halogen; represents optionally substituted alkyl, alkylthio, or aryl; or when m represents 2, optionally together with a second radical R³ represents oxygen or alkanediyl,
R⁴ represents hydroxyl, formyloxy, or halogen; or represents optionally substituted alkoxy, alkylthio, alkylsulphinyl, alkylsulphonyl, alkylcarbonyloxy, alkoxycarbonyloxy, alkylaminocarbonyloxy, alkylsulphonyloxy, alkenyloxy, alkynyloxy, aryloxy, arylthio, arylsulphinyl, arylsulphonyl, arylcarbonyloxy, arylcarbonylalkoxy, arylsulphonyloxy, arylalkoxy, arylalkylthio, arylalkylsulphinyl, or arylalkylsulphonyl,
R⁵ represents hydrogen, cyano, carbamoyl, thiocarbamoyl, or halogen; or represents optionally substituted alkyl, alkoxy, alkylthio, alkylsulphinyl, alkylsulphonyl, alkoxycarbonyl, or cycloalkyl,
R⁶ represents hydrogen or represents optionally substituted alkyl, alkenyl, alkynyl, cycloalkyl, cycloalkylalkyl, aryl, or arylalkyl,
R⁷ represents hydroxyl or formyloxy; or represents optionally substituted alkoxy, alkylcarbonyloxy, alkoxycarbonyloxy, alkylaminocarbonyloxy, alkylsulphonyloxy, alkenyloxy, alkynyloxy, arylalkoxy, arylcarbonyloxy, arylcarbonylalkoxy, or arylsulphonyloxy,
R⁸ represents hydrogen, cyano, carbamoyl, thiocarbamoyl, or halogen; or represents optionally substituted alkyl, alkylcarbonyl, alkoxy, alkoxycarbonyl, alkylthio, alkylsulphinyl, or alkylsulphonyl,
R⁹ represents hydrogen or represents optionally substituted alkyl or cycloalkyl,
R¹⁰ represents hydrogen or represents optionally substituted alkyl or cycloalkyl, and
R¹¹ represents hydrogen, cyano, carbamoyl, or halogen; or represents optionally substituted alkyl, alkoxy, alkoxycarbonyl, alkylthio, alkylsulphinyl, or alkylsulphonyl,
and
(b) one or more compounds selected from a second group of herbicides consisting of the active compounds 4-(2-chloro-phenyl)-N-cyclohexyl-N-ethyl-4,5-dihydro-5-oxo-1H-tetrazol-1-carboxamide (fentrazamide), N-(4-fluoro-henyl)-N-i-propyl-2-(5-trifluoromethyl-1,3,4-thiadiazol-2-yl-oxy)-acetamide (flufenacet), 2-chloro-N-(ethoxymethyl)-N-(2-ethyl-6-methyl-phenyl)-acetamide (acetochlor), 5-(2-chloro-4-trifluoromethyl-phenoxy)-2-nitro-benzoic acid sodium salt (acifluorfen-sodium), 2-chloro-6-nitro-3-phenoxy-benzeneamine (aclonifen), 2-chloro-N-(methoxymethyl)-N-(2,6-diethyl-phenyl)-acetamide (alachlor), N-ethyl-N′-i-propyl-6-methylthio-1,3,5-triazine-2,4-diamine (ametryn), 4-amino-N-(1,1-dimethyl-ethyl)-4,5-dihydro-3-(1-methyl-ethyl)-5-oxo-1H-1,2,4-triazole-1-carboxamide (amicarbazone), N-(4,6-dimethoxy-pyrimidin-2-yl)-N′-(N-methyl-N-methylsulphonyl-sulphamoyl)-urea (amidosulfuron), 1H-1,2,4-triazol-3-amine (amitrole), S-[2-[(4-chloro-phenyl)-(1-isopropyl)-amino]-2-oxo-ethyl] O,O-dimethyl phosphorodithioate (anilofos), 6-chloro-4-ethylamino-2-isopropylamino-1,3,5-triazine (atrazin), 2-[2,4-dichloro-5-(2-propynyloxy)-phenyl]-5,6,7,8-tetrahydro-1,2,4-triazolo-[4,3-a]-pyridin-3(2H)-one (azafenidin), N-(4,6-dimethoxy-pyrimidin-2-yl)-N′-[1-methyl-4-(2-methyl-2H-tetrazol-5-yl)-1H-pyrazol-5-ylsulphonyl]-urea (azimsulfuron), N-benzyl-2-(4-fluoro-3-trifluoromethyl-phenoxy)-butanamide (beflubutamid), 4-chloro-2-oxo-3(2H)-benzothiazoleacetic acid (benazolin), N-butyl-N-ethyl-2,6-dinitro-4-trifluoromethyl-benzeneamine (benfluralin), 2,3-dihydro-3,3-dimethyl-5-benzofuranyl-ethanesulphonate (benfuresate), N-(4,6-dimethoxy-pyrimidin-2-yl)-N′-(2-methoxycarbonyl-phenylmethylsulphonyl)-urea (bensulfuron-methyl), S-[(4-chloro-phenyl)-methyl]diethylthiocarbamate (benthiocarb, thiobencarb), methyl 2-[2-[4-(3,6-dihydro-3-methyl-2,6-dioxo-4-trifluoromethyl-1(2H)-pyrimidinylphenoxymethyl]-5-ethyl-phenoxy-propanoate (benzfendizone), 3-(2-chloro-4-methylsulphonyl-benzoyl)-4-phenylthio-bicyclo-[3.2.1]-oct-3-en-2-one (benzobicyclon), 2-[[4-(2,4-dichloro-3-methyl-benzoyl)-1,3-dimethyl-1H-pyrazol-5-yl]-oxy]-1-(4-methyl-phenyl)-ethanone (benzofenap), ethyl N-benzoyl-N-(3,4-dichloro-phenyl)-DL-alaninate (benzoylpropethyl), 3-i-propyl-1H-2,1,3-benzothiadiazin-4(3H)-one (bentazon), methyl 5-(2,4-dichloro-phenoxy)-2-nitro-benzoate (bifenox), 2,6-bis-(4,6-dimethoxy-pyrimidin-2-yl-oxy)-benzoic acid sodium salt (bispyribac-sodium), 5-bromo-6-methyl-3-(1-methyl-propyl)-2,4(1H,3H)pyrimidinedione (bromacil), 2-bromo-3,3-dimethyl-N-(1-methyl-1-phenyl-ethyl)-butanamide (bromobutide), 3,5-dibromo-4-hydroxy-benzaldehyde O-(2,4-dinitro-phenyl)-oxime (bromo-fenoxim), 3,5-dibromo-4-hydroxy-benzonitrile (bromoxynil), N-butoxymethyl-2-chloro-N-(2,6-diethyl-phenyl)-acetamide (butachlor), [1,1-dimethyl-2-oxo-2-(2-propenyloxy)]-ethyl 2-chloro-5-(3,6-dihydro-3-methyl-2,6-dioxo-4-trifluoro-methyl-1 (2H)-pyrimidinyl)-benzoate (butafenacil-allyl), O-ethyl O-(5-methyl-2-nitrophenyl) N-s-butylphosphoramidothioate (butamifos), (Z)-2-chloro-N-[(2-butenyloxy)-methyl]-N-(2,6-diethyl-phenyl)-acetamide (butenachlor), 2-(1-ethoximino-propyl)-3-hydroxy-5-[2,4,6-trimethyl-3-(1-oxo-butyl)-phenyl]-2-cyclohexen-1-one (butroxydim), S-ethyl-bis-(2-methyl-propyl)-thiocarbamate (butylate), N,N-diethyl-3-(2,4,6-trimethyl-phenylsulphonyl)-1H-1,2,4-triazole-1-carboxamide (cafenstrole), 2-[1-[(3-chloro-2-propenyl)-oxy-imino]-propyl]-3-hydroxy-5-(tetrahydro-2H-pyran-4-yl)-2-cyclohexen-1-one (caloxydim, tepraloxydim), 2-(4-chloro-2-fluoro-5-(2-chloro-2-ethoxycarbonyl-ethyl)-phenyl)-4-difluoromethyl-5-methyl-2,4-dihydro-3H-1,2,4-triazol-3-one (carfentrazone-ethyl), 2,4-dichloro-1-(3-methoxy-4-nitro-phenoxy)-benzene (chlomethoxyfen), 3-amino-2,5-dichloro-benzoic acid (chloramben), N-(4-chloro-6-methoxy-pyrimidin-2-yl)-N′-(2-ethoxycarbonyl-phenylsulphonyl)-urea (chlorimuron-ethyl), 1,3,5-trichloro-2-(4-nitro-phenoxy)-benzene (chlornitrofen), N-(4-methoxy-6-methyl-1,3,5-triazin-2-yl)-N′-(2-chloro-phenyl-sulphonyl)-urea (chlorsulfuron), N′-(3-chloro-4-methyl-phenyl)-N,N-dimethyl-urea (chlortoluron), ethyl 2-chloro-3-[2-chloro-5-(1,3,4,5,6,7-hexahydro-1,3-dioxo-2H-isoindol-2-yl)-phenyl]-2-propanoate (cinidon-ethyl), exo-1-methyl-4-isopropyl-2-(2-methyl-phenyl-methoxy)-7-oxabicyclo-[2.2.1]-heptane (cinmethylin), N-(4,6-dimethoxy-1,3,5-triazin-2-yl)-N′-(2-(2-methoxy-ethoxy)-phenylsulphonyl)-urea (cinosulfuron), 2-[1-[2-(4-chloro-phenoxy)-propoxy-aminobutyl]-5-(tetrahydro-2H-thiopyran-3-yl)-1,3-cyclohexanedione (clefoxydim), (E,E)-(+)-2-[1-[[(3-chloro-2-propenyl)-oxy]-imino]-propyl]-3-hydroxy-2-cyclohexen-1-one (clethodim), (R)-(2-propynyl) 2-[4-(5-chloro-3-fluoro-pyridin-2-yl-oxy)-phenoxy-propanoate (clodinafop-propargyl), 2-[(2-chloro-phenyl)-methyl]-4,4-dimethyl-3-isoxazolidinone (clomazone), 2-(2,4-dichloro-3-methyl-phenoxy)-N-phenyl-propanamide (clomeprop), 3,6-dichloro-pyridine-2-carboxylic acid (clopyralid), methyl 3-chloro-2-[(5-ethoxy-7-fluoro[1,2,4]triazolo[1,5-c]pyrimidin-2-yl-sulphonyl)-amino]-benzoate (cloransulam-methyl), N-[(2-chloro-phenyl)-methyl]-N′-(1-methyl-1-phenyl-ethyl)-urea (cumyluron), 2-chloro-4-ethylamino-6-(1-cyano-1-methyl-ethyl-amino)-1,3,5-triazine (cyanazine), N-(4,6-dimethoxy-pyrimidin-2-yl)-N′-(2-cyclopropylcarbonyl-phenylsulphonyl)-urea (cyclosulfamuron), 2-(1-ethox-iminobutyl)-3-hydroxy-5-(tetrahydro-2H-thiopyran-3-yl)-2-cyclohexen-1-one (cycloxydim), (R)-2-butyl [4-(4-cyano-2-fluoro-phenoxy)-phenoxy]-propanoate (cyhalofop-butyl), 2,4-dichloro-phenoxyacetic acid (2,4-D), 3,6-dichloro-2-methoxy-benzoic acid (dicamba), (R)-2-(2,4-dichloro-phenoxy)-propanoic acid (dichlorprop-P), methyl 2-[4-(2,4-dichloro-phenoxy)-phenoxy]-propanoate (diclofop-methyl), N-(2,6-dichloro-phenyl)-5-ethoxy-7-fluoro-[1,2,4]-triazolo-[1,5-c]-pyrimidine-2-sulphonamide (diclosulam), ethyl N-(chloroacetyl)-N-2,6-(diethylphenyl)-glycinate (diethatyl-ethyl), 1,2-dimethyl-3,5-diphenyl-1H-pyrazolium methylsulphate (difenzoquat), N-(2,4-difluoro-phenyl)-2-(3-trifluoromethyl-phenoxy)-pyridine-3-carboxamide (diflufenican), 2-[1-[(3,5-difluoro-phenyl)-amino-carbonyl-hydrazono]-ethyl]-pyridine-3-carboxylic acid (diflufenzopyr), S-(1-methyl-1-phenyl-ethyl)-1-piperidine carbothioate (dimepiperate), 2-chloro-N-(2,6-dimethyl-phenyl)-N-(2-methoxy-ethyl)-acetamide (dimethachlor), N-(1,2-dimethyl-propyl)-N′-ethyl-6-methylthio-1,3,5-triazine-2,4-diamine (dimethametryn), (S—) 2-chloro-N-(2,4-dimethyl-3-thienyl)-N-(2-methoxy-1-methyl-ethyl)-acetamide (S—) (dimethenamid), 2-amino-4-(1-fluoro-1-methyl-ethyl)-6-(1-methyl-2-(3,5-dimethyl-phenoxy)-ethylamino)-1,3,5-triazine (dimexyflam), N3,N3-diethyl-2,4-dinitro-6-trifluoromethyl-1,3-diamino-benzene (dinitramine), 6,7-dihydro-dipyrido[1,2-a:2′,1′-c]pyrazine-diium (diquat), S,S-dimethyl-2-difluoromethyl-4-i-butyl-6-trifluoromethyl-pyridine-3,5-dicarbothioate (dithiopyr), N′-(3,4-dichloro-phenyl)-N,N-dimethyl-urea (diuron), N-(4-methyl-phenyl)-N′-(1-methyl-1-phenyl-ethyl)-urea (dymron, daimuron, dimuron), S-ethyl dipropylthiocarbamate (EPTC), S-(phenylmethyl)-N-ethyl-N-(1,2-dimethyl-propyl)-thiocarbamate (esprocarb), N-ethyl-N-(2-methyl-2-propenyl)-2,6-dinitro-4-trifluoromethyl-benzeneamine (ethalfluralin), (S)-(2-ethoxy-1-methyl-2-oxoethyl) 2-chloro-5-(2-chloro-4-trifluoromethyl-phenoxy)-benzoate (ethoxyfen), N-(4,6-dimethoxy-pyrimidin-2-yl)-N′-(2-ethoxy-phenoxysulphonyl)-urea (ethoxysulfuron), N-(2,3-dichloro-phenyl)-4-ethoxymethoxy-benzamide (etobenzanid), (R)-ethyl-2-[4-(6-chloro-benzoxazol-2-yl-oxy)-phenoxy]-propanoate (fenoxaprop-(P)-ethyl), isopropyl N-benzoyl-N-(3-chloro-4-fluro-phenyl)-DL-alaninate (flamprop-isopropyl), isopropyl N-benzoyl-N-(3-chloro-4-fluro-phenyl)-L-alaninate (flamprop-isopropyl-L), methyl N-benzoyl-N-(3-chloro-4-fluoro-phenoxy)-DL-alaninate (flamprop-methyl), N-(2,6-difluoro-phenyl)-8-fluoro-5-methoxy-[1,2,4]-triazolo-[1,5-c]-pyrimidine-2-sulphonamide (florasulam), butyl (R)-2-[4-(5-trifluoro-methyl-pyridin-2-yl-oxy)-phenoxy]-propanoate (fluazifop, -butyl, -P-butyl), i-propyl 5-(4-bromo-1-methyl-5-trifluoromethyl-1H-pyrazol-3-yl)-2-chloro-4-fluoro-benzoate (fluazolate), 4,5-dihydro-3-methoxy-4-methyl-5-oxo-N-[(2-trifluoromethoxy-phenyl)-sulphonyl]-1-H-1,2,4-triazole-1-carboxamide sodium salt (flucarbazone-sodium), ethyl [2-chloro-4-fluoro-5-(5-methyl-6-oxo-4-trifluoromethyl-1(6H)-pyriazinyl)-phenoxy]-acetate (flufenpyr), N-(2,6-difluoro-phenyl)-5-methyl-1,2,4-triazolo[1,5-a]-pyrimidine-2-sulphonamide (flumetsulam), pentyl [2-chloro-4-fluoro-5-(1,3,4,5,6,7-hexahydro-1,3-dioxo-2H-isoindol-2-yl)-phenoxy]-acetate (flumiclorac-pentyl), 2-[7-fluoro-3,4-dihydro-3-oxo-4-(2-propynyl)-2H-1,4-benzoxazin-6-yl]-4,5,6,7-tetrahydro-1H-isoindole-1,3-dione (flumioxazin), 2-[4-chloro-2-fluoro-5-[(1-methyl-2-propynyl)-oxy]-phenyl]-4,5,6,7-tetrahydro-1H-isoindole-1,3(2H)-dione (flumipropyn), 3-chloro-4-chloromethyl-1-(3-trifluoromethyl-phenyl)-2-pyrrolidinone (fluorochloridone), ethoxycarbonylmethyl 5-(2-chloro-4-trifluoromethyl-phenoxy)-2-nitro-benzoate (fluoroglycofen-ethyl), 1-(4-chloro-3-(2,2,3,3,3-pentafluoro-propoxymethyl)-phenyl)-5-phenyl-1H-1,2,4-triazol-3-carboxamide (flupoxam), 1-isopropyl-2-chloro-5-(3,6-dihydro-3-methyl-2,6-dioxo-4-trifluoromethyl-1(2H)-pyrimidyl)-benzoate (flupropacil), N-(4,6-dimethoxy-pyrimidin-2-yl)-N′-(3-methoxy-carbonyl-6-trifluoromethyl-pyridin-2-yl-sulphonyl)-urea sodium salt (flupyrsulfuron-methyl-sodium), 9-hydroxy-9H-fluorene-9-carboxylic acid (flurenol), (4-amino-3,5-dichloro-6-fluoro-pyridin-2-yl-oxy)-acetic acid (-2-butoxy-1-methyl-ethyl ester, -1-methyl-heptyl ester) (fluroxypyr, -butoxypropyl, -meptyl), 5-methylamino-2-phenyl-4-(3-trifluoromethyl-phenyl)-3(2H)-furanone (flurtamone), methyl-[(2-chloro-4-fluoro-5-(tetrahydro-3-oxo-1H,3H-[1,3,4]-thiadiazolo-[3,4-a]-pyridazin-1-ylidene)-amino-phenyl]-thio-acetate (fluthiacet-methyl), 5-(2-chloro-4-trifluoromethyl-phenoxy)-N-methylsulphonyl-2-nitro-benzamide (fomesafen), 2-[[[[(4,6-dimethoxy-2-pyrimidinyl)-amino]-carbonyl]-amino]-sulphonyl]-4-formylamino-N,N-dimethyl-benzamide (foramsulfuron), 2-amino-4-(hydroxymethylphosphinyl)-butanoic acid (-ammonium salt) (glufosinate (-ammonium)), N-phosphonomethyl-glycine (-isopropylammonium salt), (glyphosate, -isopropylammonium), methyl 3-chloro-5-[[[[(4,6-dimethoxy-2-pyrimidinyl)-amino]-carbonyl]-amino]-sulphonyl]-1-methyl-1H-pyrazole-4-carboxylate (halosulfuron-methyl), (R)-2-[4-(3-chloro-5-trifluoromethyl-pyridin-2-yl-oxy)-phenoxy]-propanoic acid (-methyl ester, -2-ethoxy-ethyl ester, -butyl ester) (haloxyfop, -methyl, -P-methyl, -ethoxyethyl, -butyl), 3-cyclohexyl-6-dimethylamino-1-methyl-1,3,5-triazine-2,4(1H,3H)-dione (hexazinone), N-(2,4-difluoro-phenyl-1,5-dihydro-N-i-propyl-5-oxo-1-[(tetrahydro-2H-pyran-2-yl)-methyl]-4H-1,2,4-triazol-4-carboxamide (HOK-201), methyl 2-(4,5-dihydro-4-methyl-4-isopropyl-5-oxo-1H-imidazol-2-yl)-4-methyl-benzoate (imazamethabenz-methyl), 2-(4,5-dihydro-4-methyl-4-isopropyl-5-oxo-1H-imidazol-2-yl)-5-methyl-pyridine-3-carboxylic acid (imazamethapyr), 2-(4,5-dihydro-4-methyl-4-isopropyl-5-oxo-1H-imidazol-2-yl)-5-methoxymethyl-pyridine-3-carboxylic acid (imazamox), 2-(4,5-dihydro-4-methyl-4-isopropyl-5-oxo-1H-imidazol-2-yl)-quinoline-3-carboxylic acid (imazaquin), 2-(4,5-dihydro-4-methyl-4-i-propyl-5-oxo-1H-imidazol-2-yl)-5-ethyl-pyridine-3-carboxylic acid (imazethapyr), N-(4,6-dimethoxy-pyrimidin-2-yl)-N′-(2-chloro-imidazo[1,2-a]-pyridin-3-yl-sulphonyl)-urea (imazosulfuron), 2-[2-(3-chloro-phenyl)-oxiranyl-methyl]-2-ethyl-1H-indene-1,3(2H)-dione (indanofan), N-(4-methoxy-6-methyl-1,3,5-triazin-2-yl)-N′-(5-iodo-2-methoxycarbonyl-phenylsulphonyl)-urea sodium salt (iodosulfuron-methyl-sodium), 4-hydroxy-3,5-diiodo-benzonitrile (ioxynil), N,N-dimethyl-N′-(4-isopropyl-phenyl)-urea (isoproturon), N-(3-(1-ethyl-1-methyl-propyl)-isoxazol-5-yl)-2,6-dimethoxy-benzamide (isoxaben), (4-chloro-2-methylsulphonyl-phenyl)-(5-cyclopropyl-isoxazol-4-yl)-methanone (isoxachlortole), (5-cyclopropyl-isoxazol-4-yl)-(2-methylsulphonyl-4-trifluoro-methyl-phenyl)-methanone (isoxaflutole), 2-[2-[4-[3,5-dichloro-2-pyridinyl)-oxy]-phenoxy]-1-oxo-propyl]-isoxazolidine (isoxapyrifop), 2-[(2,3-dihydro-5,8-dimethyl-1,1-dioxidospiro[4H-1-benzothiopyran-4,2′-[1,3]-dioxolan]-6-yl)-carbonyl]-1,3-cyclohexanedione potassium salt (ketospiradox), (2-ethoxy-1-methyl-2-oxo-ethyl) 5-(2-chloro-4-trifluoromethyl-phenoxy)-2-nitro-benzoate (lactofen), N′-(3,4-dichloro-phenyl)-N-methoxy-N-methyl-urea (linuron), (4-chloro-2-methyl-phenoxy)-acetic acid (MCPA), 4-(4-chloro-2-methyl-phenoxy)-butyric acid (MCPB), 2-(4-chloro-2-methyl-phenoxy)-propionic acid (mecoprop), 2-(2-benzothiazolyloxy)-N-methyl-N-phenyl-acetamide (mefenacet), methyl 2-[[[[(4,6-dimethoxy-2-pyrimidinyl)-amino]-carbonyl]-amino]-sulphonyl]-4-[[(methylsulphonyl)-amino]methyl]-benzoate (meso-sulfuron), 2-(4-methylsulphonyl-2-nitro-benzoyl)-1,3-cyclohexanedione (mesotrione), 4-amino-3-methyl-6-phenyl-1,2,4-triazin-5(4H)-one (metamitron), 2-chloro-N-(2,6-dimethyl-phenyl)-N-(1H-pyrazol-1-yl-methyl)-acetamide (metazachlor), N′-(4-(3,4-dihydro-2-methoxy-2,4,4-trimethyl-2H-1-benzopyran-7-yl-oxy)-phenyl)-N-methoxy-N-methyl-urea (metobenzuron), N′-(4-bromo-phenyl)-N-methoxy-N-methylurea (metobromuron), (S)-2-chloro-N-(2-ethyl-6-methyl-phenyl)-N-(2-methoxy-1-methyl-ethyl)-acet-amide (metolachlor, S-metolachlor), N-(2,6-dichloro-3-methyl-phenyl)-5,7-dimethoxy-1,2,4-triazolo[1,5-a]-pyrimidine-2-sulphonamide (metosulam), N′-(3-chloro-4-methoxy-phenyl)-N,N-dimethyl-urea (metoxuron), 4-amino-6-tert-butyl-3-methylthio-1,2,4-triazin-5(4H)-one (metribuzin), N-(4-methoxy-6-methyl-1,3,5-triazin-2-yl)-N′-(2-methoxycarbonyl-phenylsulphonyl)-urea (metsulfuron-methyl), S-ethyl hexahydro-1H-azepin-1-carbothioate (molinate), 2-(2-naphthyloxy)-N-phenyl-propanamide (naproanilide), N-butyl-N′-(3,4-dichloro-phenyl)-N-methyl-urea (neburon), N-(4,6-dimethoxy-pyrimidin-2-yl)-N′-(3-dimethylcarbamoyl-pyridin-2-yl-sulphonyl)-urea (nicosulfuron), 4-chloro-5-methylamino-2-(3-trifluoromethyl-phenyl)-3(2H)pyridazinone (norflurazon), 4-(7-chloro-2,4-dimethyl-5-benzofuranyl)-2,4-dihydro-2-methyl-5-trifluoromethyl-3H-1,2,4-triazole-3-thione (OK-701), S-(2-chloro-benzyl) N,N-diethyl-thiocarbamate (orbencarb), 4-dipropylamino-3,5-dinitro-benzene-sulphonamide (oryzalin), 3-[2,4-dichloro-5-(2-propynyloxy)-phenyl]-5-(t-butyl)-1,3,4-oxadiazol-2(3H)-one (oxadiargyl), 3-[2,4-dichloro-5-(1-methyl-ethoxy)-phenyl]-5-(t-butyl)-1,3,4-oxadiazol-2(3H)-one (oxadiazon), N-(4,6-dimethyl-pyrimidin-2-yl)-N′-(2-oxetan-3-yl-oxycarbonyl-phenylsulphonyl)-urea (oxasulfuron), 3-[1-(3,5-dichloro-phenyl)-1-i-propyl]-2,3-dihydro-6-methyl-5-phenyl-4H-1,3-oxazin-4-one (oxaziclomefone), 2-chloro-1-(3-ethoxy-4-nitro-phenoxy)-4-trifluoromethyl-benzene (oxyfluorfen), 1,1′-dimethyl-4,4′-bipyridinium (paraquat), 1-amino-N-(1-ethyl-propyl)-3,4-dimethyl-2,6-dinitro-benzene (pendimethalin), 4-(t-butyl)-N-(1-ethyl-propyl)-2,6-dinitro-benzene-amine (pendralin), 2-(2,2-difluoro-ethoxy)-N-(5,8-dimethoxy-[1,2,4]-triazolo-[1,5-c]-pyrimidin-2-yl)-6-trifluoromethyl-benzenesulfonamide (penoxsulam), 3-(4-chloro-5-cyclopentyloxy-2-fluoro-phenyl)-5-(1-methyl-ethylidene)-2,4-oxazolidine-dione (pentoxazone), 2-chloro-N-(2-ethoxy-ethyl)-N-(2-methyl-1-phenyl-1-propenyl)-acetamide (pethoxamide), 4-amino-3,5,6-trichloro-pyridine-2-carboxylic acid (picloram), N-(4-fluoro-phenyl)-6-(3-trifluoromethyl-phenoxy)-pyridine-2-carboxamide (picolinafen), S-[2-(2-methyl-1-piperidinyl)-2-oxo-ethyl] O,O-dipropyl phosphorodithioate (piperophos), 2-chloro-N-(2,6-diethyl-phenyl)-N-(2-propoxy-ethyl)-acetamide (pretilachlor), N-(4,6-bis-difluoromethoxy-pyrimidin-2-yl)-N′-(2-methoxycarbonyl-phenylsulphonyl)-urea (primisulfuron-methyl), 1-chloro-N-[2-chloro-4-fluoro-5-[(6S,7aR)-6-fluoro-tetrahydro-1,3-dioxo-1H-pyrrolo[1,2-c]imidazol-2(3H)-yl]-phenyl]-methane-sulphonamide (profluazol), 2-[1-[[2-4-(chloro-phenoxy)-propoxy]-imino]-butyl]-3-hydroxy-5-(tetrahydro-2H-thiopyran-3-yl)-2-cyclohexen-1-one (profoxydim), 2-chloro-N-isopropyl-N-phenyl-acetamide (propachlor), N-(3,4-dichloro-phenyl)-propanamide (propanil), (R)-[2-[[(1-methyl-ethylidene)-amino]-oxy]-ethyl] 2-[4-(6-chloro-2-quinoxalinyloxy)-phenoxy]-propanoate (propaquizafop), 2-chloro-N-(2-ethyl-6-methyl-phenyl)-N-[(1-methyl-ethoxy)-methyl]-acetamide (propisochlor), methyl 2-[[[(4,5-dihydro-4-methyl-5-oxo-3-propoxy-1H-1,2,4-triazol-1-yl)-carbonyl]-amino]-sulphonyl]-benzoate sodium salt (propoxy-carbazone-sodium), S-phenylmethyl-N,N-dipropyl-thiocarbamate (prosulfocarb), N-(4-methoxy-6-methyl-1,3,5-triazin-2-yl)-N′-(2-(3,3,3-trifluoro-propyl)-phenylsulphonyl)-urea (prosulfuron), ethyl [2-chloro-5-(4-chloro-5-difluoromethoxy-1-methyl-1H-pyrazol-3-yl)-4-fluoro-phenoxy]-acetate (pyraflufen-ethyl), 1-(3-chloro-4,5,6,7-tetrahydro-pyrazolo[1,5-a]pyridin-2-yl)-5-(methyl-2-propynylamino)-1H-pyrazole-4-carbonitrile (pyraclonil, pyrazogyl), 4-(2,4-dichloro-benzoyl)-1,3-dimethyl-5-(4-methyl-phenylsulphonyloxy)-pyrazole (pyrazolate), 4-(2,4-dichloro-benzoyl)-1,3-dimethyl-5-(phenyl-carbonylmethoxy)-pyrazole (pyrazoxyfen), N-(4,6-dimethoxy-pyrimidin-2-yl)-N′-(4-ethoxycarbonyl-1-methyl-pyrazol-5-yl-sulphonyl)-urea (pyrazosulfuron-ethyl), diphenylmethanone O-[2,6-bis-(4,6-dimethoxy-pyrimidin-2-yl-oxy)-benzoyl]-oxime (pyribenzoxim), O[3-(1,1-dimethyl-ethyl)-phenyl] (6-methoxy-2-pyridinyl)-methylthiocarbamate (pyributicarb), 6-chloro-3-phenyl-4-pyridazinol (pyridafol), O-(6-chloro-3-phenyl-pyridazin-4-yl) S-octyl-thio-carbonate (pyridate), 6-chloro-3-phenyl-pyridazin-4-ol (pyridatol), 7-[(4,6-dimethoxy-2-pyrimidinyl)-thio]-3-methyl-1(3H)-isobenzofuranone (pyriftalid), methyl 2-(4,6-dimethoxy-pyrimidin-2-yl-oxy)-benzoate (pyriminobac-methyl), 2-chloro-6-(4,6-dimethoxy-pyrimidin-2-ylthio)-benzoic acid sodium salt (pyrithiobac-sodium), 3,7-dichloro-quinoline-8-carboxylic acid (quinchlorac), 7-chloro-3-methyl-quinoline-8-carboxylic acid (quinmerac), 2-amino-3-chloro-1,4-naphthalenedione (quinoclamine), 2-[4-(6-chloro-2-quinoxalinyloxy)-phenoxy]-propanoic acid (-ethyl ester, -tetrahydro-2-furanyl-methyl ester) (quizalofop, -ethyl, -P-ethyl, -P-tefuryl), N-(4,6-dimethoxy-pyrimidin-2-yl)-N′-(3-ethylsulphonyl-pyridin-2-yl-sulphonyl)-urea (rimsulfuron), 2-(1-ethoximino-butyl)-5-(2-ethylthiopropyl)-3-hydroxy-2-cyclohexen-1-one (sethoxydim), 6-chloro-2,4-bis-ethylamino-1,3,5-triazine (simazin), 2-(2-chloro-4-methyl-sulphonyl-benzoyl)-cyclohexane-1,3-dione (sulcotrione), 2-(2,4-dichloro-5-methylsulphonylamino-phenyl)-4-difluoromethyl-5-methyl-2,4-dihydro-3H-1,2,4-triazol-3-one (sulfentrazone), methyl 2-[[[[(4,6-dimethyl-2-pyrimidinyl)-amino]-carbonyl]-amino]-sulphonyl]-benzoate (sulfometuron-methyl), N-phos-phonomethyl-glycine-trimethylsulphonium (sulfosate), N-(4,6-dimethoxy-pyrimidin-2-yl)-N′-(2-ethylsulphonyl-imidazo[1,2-a]pyridine-3-sulphonamide (sulfosulfuron), 6-chloro-4-ethylamino-2-tert-butylamino-1,3,5-triazine (terbuthylazine), 2-tert-butylamino-4-ethylamino-6-methylthio-1,3,5-triazine (terbutryn), 2-chloro-N-(2,6-dimethyl-phenyl)-N-(3-methoxy-2-thienyl-methyl)-acetamide (thenylchlor), methyl 2-difluoromethyl-5-(4,5-dihydro-thiazol-2-yl)-4-(2-methyl-propyl)-6-trifluoromethyl-pyridine-3-carboxylate (thiazopyr), 6-(6,7-dihydro-6,6-dimethyl-3H,5H-pyrrolo[2,1-c]-1,2,4-thiadiazol-3-ylideneamino)-7-fluoro-4-(2-propynyl)-2H-1,4-benzoxazin-3(4H)-one (thidiazimin), N-(4-methoxy-6-methyl-1,3,5-triazin-2-yl)-N′-(2-methoxycarbonyl-thien-3-yl-sulphonyl)-urea (thifensulfuron-methyl), S-(phenylmethyl) bis-(1-methyl-propyl)-carbamothioate (tiocarbazil), 2-(ethoximino-propyl)-3-hydroxy-5-(2,4,6-trimethyl-phenyl)-2-cyclohexen-1-one (tralkoxydim), S-(2,3,3-trichloro-2-propenyl) diisopropylcarbamothioate (triallate), N-(4-methoxy-6-methyl-1,3,5-triazin-2-yl)-N′-[2-(2-chloro-ethoxy)-phenylsulphonyl]-urea (triasulfuron), N-methyl-N-(4-methoxy-6-methyl-1,3,5-triazin-2-yl)-N′-(2-methoxycarbonyl-phenylsulphonyl)-urea (tribenuron-methyl), (3,5,6-trichloro)-pyridin-2-yl-oxy-acetic acid (triclopyr), 2-(3,5-dichloro-phenyl)-2-(2,2,2-trichloro-ethyl)-oxirane (tridiphane), N-[[(4,6-dimethoxy-2-pyrimidinyl)-amino]-carbonyl]-3-(2,2,2-trifluoro-ethoxy)-2-pyridinesulphonamide sodium salt (trifloxysulfuron), 1-amino-2,6-dinitro-N,N-dipropyl-4-trifluoromethyl-benzene (trifluralin), N-[4-dimethylamino-6-(2,2,2-trifluoro-ethoxy)-1,3,5-triazin-2-yl]-N′-(2-methoxy-carbonyl-phenylsulphonyl)-urea (triflusulfuron-methyl), N-(4-methoxy-6-trifluoromethoxy-1,3,5-triazin-2-yl)-N′-(2-trifluoromethyl-phenylsulphonyl)-urea (tritosulfuron), N-[[(4,6-dimethoxy-2-pyrimidinyl)-amino]-carbonyl]-3-(N-methyl-N-methylsulphonyl-amino])-2-pyridinesulphonamide, 4-[4,5-dihydro-4-methyl-5-oxo-(3-trifluoromethyl)-1H-1,2,4-triazol-1-yl]-2-(ethylsulphonylamino)-5-fluoro-benzenecarbothioamide (HWH4991), 2-chloro-N-[1-(2,6-dichloro-4-difluoromethyl-phenyl)-4-nitro-1H-pyrazol-5-yl]-propanecarboxamide (SLA5599), [2-chloro-3-(4,5-dihydro-3-isoxazolyl)-4-methylsulphonyl-phenyl]-(5-hydrox-1-methyl-1H-pyrazol-4-yl)-methanone, [3-(4,5-dihydro-3-isoxazolyl)-2-methyl-4-methylsulphonyl-phenyl]-(5-hydrox-1-methyl-1H-pyrazol-4-yl)-methanone, [3-[2-chloro-3-[2,6-dioxo-cyclohexyl)-carbonyl]-6-ethylsulphonyl-phenyl]-5-isoxazolyl]-acetonitrile, 2-[2-chloro-4-methylsulphonyl-3-[(2,2,2-trifluoro-ethoxy)-methyl]-benzoyl]-1,3-cyclohexanedione, and 2-[[5,8-dimethyl-1,1-dioxido-4-(2-pyrimidinyloxy)-3,4-dihydro-2H-thiochromen-6-y]-carbonyl]-1,3-cyclohexanedione
and/or
(c) one or more compounds selected from a third group of compounds that improve crop plant compatibility consisting of the active compounds 4-dichloroacetyl-1-oxa-4-aza-spiro[4.5]-decane (AD-67), 1-dichloroacetyl-hexahydro-3,3,8a-trimethylpyrrolo[1,2-a]-pyrimidin-6(2H)-one (BAS-145138), 4-dichloroacetyl-3,4-dihydro-3-methyl-2H-1,4-benzoxazine (benoxacor), 1-methyl-hexyl 5-chloro-quinoxalin-8-oxy-acetate (cloquintocet-mexyl, α-(cyanomethoximino)-phenylacetonitrile (cyometrinil), 2,4-dichlorophenoxy acetic acid (2,4-D), 2,2-dichloro-N-(2-oxo-2-(2-propenylamino)-ethyl)-N-(2-propenyl)-acetamide (DKA-24), 2,2-dichloro-N,N-di-2-propenyl acetamide (dichlormid), N-(4-methyl-phenyl)-N′-(1-methyl-1-phenyl-ethyl)-urea (dymron), 4,6-dichloro-2-phenyl-pyrimidine (fenclorim), ethyl 1-(2,4-dichloro-phenyl)-5-trichloro-methyl-1H-1,2,4-triazole-3-carboxylate (fenchlorazol-ethyl), phenyl-methyl 2-chloro-4-trifluoromethyl-thiazole-5-carboxylate (flurazole), 4-chloro-N-(1,3-dioxolan-2-yl-methoxy)-α-trifluoro-acetophenone oxime (fluxofenim), 3-dichloroacetyl-5-(2-furanyl)-2,2-dimethyl-oxazolidine (furilazole, MON-13900), ethyl-4,5-dihydro-5,5-diphenyl-3-isoxazolecarboxylate (isoxadifen-ethyl), (4-chloro-2-methyl-phenoxy)-acetic acid (MCPA), (+−)-2-(4-chloro-2-methylphenoxy)-propionic acid (mecoprop), diethyl 1-(2,4-dichlorophenyl)-4,5-dihydro-5-methyl-1H-pyrazole-3,5-dicarboxylate (mefenpyr-diethyl), 2-dichloromethyl-2-methyl-1,3-dioxolan (MG-191), 1,8-naphthalic anhydride, α-(1,3-dioxolan-2-yl-methoximino)-phenylacetonitrile (oxabetrinil), 2,2-dichloro-N-(1,3-dioxolan-2-yl-methyl)-N-(2-propenyl)-acetamide (PPG-1292), 3-dichloroacetyl-2,2,5-trimethyl-oxazolidine (R-29148), N-cyclopropyl-4-[[(2-methoxy-5-methyl-benzoyl)-amino]-sulphonyl]-benzamide, N-[[(4-methoxyacetylamino)-phenyl]-sulphonyl-2-methoxy-benzamide and N-[[(4-methylaminocarbonylamino)-phenyl]-sulphonyl-2-methoxy-benzamide, N-(phenylsulphamoyl)benzamide derivatives of formula (V) 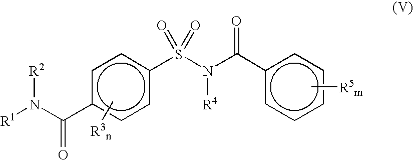
in which
R¹ represents hydrogen, (C₁-C₆)-alkyl, (C₃-C₆)-cycloalkyl, (C₂-C₆)-alkenyl, (C₅-C₆)-cycloalkenyl, phenyl, or 3- to 6-membered heterocyclyl having up to three heteroatoms selected from the group consisting of nitrogen, oxygen, and sulphur, where the radicals R¹ other than hydrogen are optionally substituted by one or more identical or different substituents selected from the group consisting of halogen, (C₁-C₆)-alkoxy, (C₁-C₆)-haloalkoxy, (C₁-C₂)-alkylsulphinyl, (C₁-C₂)-alkylsulphonyl, (C₃-C₆)-cyclo-alkyl, (C₁-C₄)-alkoxycarbonyl, (C₁-C₄)-alkylcarbonyl, and phenyl and the cyclic radicals are optionally also substituted by (C₁-C₄)-alkyl or (C₁-C₄)-haloalkyl;
R² represents hydrogen, (C₁-C₆)-alkyl, (C₂-C₆)-alkenyl, (C₂-C₆)-alkynyl, where the radicals R² other than hydrogen are optionally substituted by one or more identical or different substituents selected from the group consisting of halogen, hydroxyl, (C₁-C₄)-alkyl, (C₁-C₄)-alkoxy, and (C₁-C₄)-alkylthio;
R³ represents halogen, (C₁-C₄)-haloalkyl, (C₁-C₄)-haloalkoxy, nitro, (C₁-C₄)-alkyl, (C₁-C₄)-alkoxy, (C₁-C₄)-alkylsulphonyl, (C₁-C₄)-alkoxycarbonyl, or (C₁-C₄)-alkylcarbonyl;
R⁴ represents hydrogen or methyl;
R⁵ represents halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulphinyl, (C₁-C₄)-alkyl-sulphonyl, (C₁-C₄)-alkoxycarbonyl, or (C₁-C₄)-alkylcarbonyl;
n represents 0, 1, or 2; and
m represents 1 or 2,
or salts thereof, and
N-acylsulphonamide derivatives of the formula (VI) 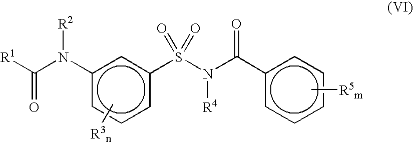
in which
R¹ represents hydrogen, (C₁-C₆)-alkyl, (C₃-C₆)-cycloalkyl, furanyl, or thienyl, where each of the radicals R¹ other than hydrogen is unsubstituted or substituted by one or more substituents from the group consisting of halogen (C₁-C₄)-alkyoxy, halogeno-(C₁-C₆)-alkoxy, and (C₁-C₄)-alkylthio and the cyclic radicals are optionally also substituted by (C₁-C₄)-alkyl or (C₁-C₄)-halogeno-alkyl;
R² is hydrogen or methyl;
R³ is halogen, halogeno-(C₁-C₄)-alkyl, halogeno-(C₁-C₄)-alkoxy, (C₁-C₄)-alkyl, (C₁-C₄)-alkoxy, (C₁-C₄)-alkylsulphonyl, (C₁-C₄)-alkoxycarbonyl, or (C₁-C₄)-alkylcarbonyl,
R⁴ is hydrogen or methyl;
R⁵ is halogen, (C₁-C₄)-alkyl, halogeno-(C₁-C₄)-alkyl, halogeno-(C₁-C₄)-alkoxy, (C₃-C₆)-cycloalkyl, phenyl, (C₁-C₄)-alkoxy, cyano, (C₁-C₄)-alkylthio, (C₁-C₄)-alkylsulphinyl, (C₁-C₄)-alkyl-sulphonyl, (C₁-C₄)-alkoxycarbonyl, or (C₁-C₄)-alkylcarbonyl,
n is 0, 1, or 2; and
m is 1 or 2,
or alkali metal salts thereof.

11. A composition according to claim 10 wherein, for the aryl ketone of the formula (I),
A¹ represents a single bond or O,
A² represents a single bond or represents alkanediyl, alkenediyl, or alkynediyl having in each case up to 6 carbon atoms,
Q represents O or S,
R¹ represents hydrogen; represents optionally cyano, halogen-, C₁-C₄-alkoxy-, C₁-C₄-alkylthio-, C₁-C₄-alkylsulphinyl-, or C₁-C₄-alkylsulphonyl-substituted alkyl, alkylthio, alkylsulphinyl, or alkylsulphonyl having in each case 1 to 6 carbon atoms in the alkyl groups; represents optionally cyano- or halogen-substituted alkenyl or alkynyl having in each case 2 to 6 carbon atoms; represents optionally cyano-, halogen-, or C₁-C₄-alkyl-substituted cycloalkyl or cycloalkylalkyl having in each case 3 to 6 carbon atoms in the cycloalkyl group and optionally 1 to 4 carbon atoms in the alkyl moiety; represents optionally nitro-, cyano-, halogen-, C₁-C₄-alkyl-, C₁-C₄-halogenoalkyl-, C₁-C₄-alkoxy-, or C₁-C₄-halogenoalkoxy-substituted aryl or arylalkyl having in each case 6 or 10 carbon atoms in the aryl group and optionally 1 to 4 carbon atoms in the alkyl moiety; or represents the group —C(O)R² or —C(S)R²,
R² represents hydrogen, amino, cyanoamino, nitroamino, hydroxyamino, or hydrazine; represents C₁-C₄-alkyl-carbonyl; represents C₁-C₄-alkoxy-carbonyl; represents optionally cyano-, halogen-, C₁-C₄-alkoxy-, C₁-C₄-alkylthio-, C₁-C₄-alkylsulphinyl-, or C₁-C₄-alkylsulphonyl-substituted alkyl, alkoxy, alkylthio, alkylamino, alkoxyamino, or alkylhydrazino having in each case 1 to 6 carbon atoms in the alkyl groups; represents dialkylamino, N-alkyl-alkoxyamino, or dialkylhydrazino having in each case 1 to 4 carbon atoms in the alkyl groups; represents optionally halogen-substituted alkenyl, alkenyloxy, alkenylamino, alkenyloxyamino, alkynyl, alkynyloxy, or alkynylamino having in each case 2 to 6 carbon atoms; represents optionally cyano-, halogen-, or C₁-C₄-alkyl-substituted cycloalkyl, cycloalkyloxy, cycloalkylamino, cycloalkylalkyl, cyclo-alkylalkoxy or cycloalkylalkylamino having in each case 3 to 6 carbon atoms in the cycloalkyl group and optionally 1 to 4 carbon atoms in the alkyl moiety; represents optionally nitro-, cyano-, halogen-, C₁-C₄-alkyl-, C₁-C₄-halogeno-alkyl-, C₁-C₄-alkoxy-, C₁-C₄-halogenoalkoxy-, or C₁-C₄-alkoxy-carbonyl-substituted aryl, arylcarbonyl, aryloxy, aryloxycarbonyl, arylthio, arylamino, arylhydrazino, arylalkyl, arylalkoxy, arylalkylthio, or arylalkylamino having in each case 6 or 10 carbon atoms in the aryl group and optionally 1 to 4 carbon atoms in the alkyl moiety; or represents optionally nitro-, cyano-, halogen-, C₁-C₄-alkyl-, C₁-C₄-halogenoalkyl-, C₁-C₄-alkoxy-, C₁-C₄-halogenoalkoxy-, C₁-C₄-alkylthio-, C₁-C₄-halogenoalkylthio-, C₁-C₄-alkoxy-carbonyl-, C₃-C₆-cycloalkyl-, or C₃-C₆-cycloalkyl-C₁-C₄-alkyl-substituted monocyclic or bicyclic heterocyclyl, heterocyclyloxy, heterocyclylthio, heterocyclylamino, hetero-cyclylalkyl, heterocyclylalkoxy, heterocyclylalkylthio, or heterocyclylalkylamino, where the heterocyclyl group contains in each case up to 10 carbon atoms and additionally at least one heteroatom selected from the group consisting of nitrogen (but at most 5 N atoms), oxygen (but at most 2 O atoms), sulphur (but at most 2 S atoms), SO, or SO₂ and optionally additionally a radical selected from the group consisting of oxo (C═O), thioxo (C═S), imino (C═NH), cyanoimino (C═N—CN), and nitroimino (C═N—NO₂),
X represents hydrogen, nitro, cyano, carboxyl, carbamoyl, thiocarbamoyl, or halogen; or represents optionally cyano-, halogen-, C₁-C₄-alkoxy-, C₁-C₄-alkylthio-, C₁-C₄-alkylsulphinyl-, or C₁-C₄-alkylsulphonyl-substituted alkyl, alkoxy, alkylthio, alkylsulphinyl, alkylsulphonyl, alkylamino, dialkylamino, or dialkylaminosulphonyl having in each case 1 to 6 carbon atoms in the alkyl groups,
Y represents hydrogen, nitro, cyano, carboxy, carbamoyl, thiocarbamoyl, or halogen; or represents optionally cyano-, halogen-, C₁-C₄-alkoxy-, C₁-C₄-alkylthio-, C₁-C₄-alkylsulphinyl-, or C₁-C₄-alkylsulphonyl-substituted alkyl, alkoxy, alkylthio, alkylsulphinyl, alkylsulphonyl, alkylamino, dialkylamino, or dialkylaminosulphonyl having in each case 1 to 6 carbon atoms in the alkyl groups, and
Z represents one of the groups 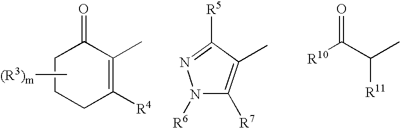
in which
m represents the numbers 0 to 3,
R³ represents hydrogen or halogen; represents optionally cyano-, halogen-, C₁-C₄-alkoxy-, C₁-C₄-alkylthio-, C₁-C₄-alkylsulphinyl-, or C₁-C₄-alkylsulphonyl-substituted alkyl or alkylthio having in each case 1 to 6 carbon atoms; represents phenyl; or when m represents 2, optionally together with a second radical R³ represents oxygen or alkanediyl having 3 to 5 carbon atoms,
R⁴ represents hydroxyl, formyloxy, or halogen; represents optionally cyano-, halogen-, C₁-C₄-alkoxy-, C₁-C₄-alkylthio-, C₁-C₄-alkylsulphinyl-, or C₁-C₄-alkylsulphonyl-substituted alkoxy, alkylthio, alkylsulphinyl, alkylsulphonyl, alkylcarbonyloxy, alkoxy-carbonyloxy, alkylaminocarbonyloxy, or alkylsulphonyloxy having in each case 1 to 6 carbon atoms; represents optionally halogen-substituted alkenyloxy or alkynyloxy having in each case 3 to 6 carbon atoms; represents optionally nitro-, cyano-, halogen-, C₁-C₄-alkyl-, C₁-C₄-halogenoalkyl-, C₁-C₄-alkoxy-, C₁-C₄-halogenoalkoxy-, C₁-C₄-alkylthio-, C₁-C₄-halogeno-alkylthio-, C₁-C₄-alkylsulphinyl-, C₁-C₄-halogenoalkylsulphinyl-, C₁-C₄-alkylsulphonyl-, or C₁-C₄-halogenoalkylsulphonyl-substituted aryloxy, arylthio, arylsulphinyl, arylsulphonyl, arylcarbonyloxy, arylcarbonylalkoxy, arylsulphonyloxy, arylalkoxy, arylalkylthio, arylalkylsulphinyl, or arylalkylsulphonyl having in each case 6 or 10 carbon atoms in the aryl group and optionally 1 to 4 carbon atoms in the alkyl moiety,
R⁵ represents hydrogen, cyano, carbamoyl, thiocarbamoyl, or halogen; represents optionally cyano-, halogen-, C₁-C₄-alkoxy-, C₁-C₄-alkylthio-, C₁-C₄-alkylsulphinyl-, or C₁-C₄-alkylsulphonyl-substituted alkyl, alkoxy, alkylthio, alkylsulphinyl, alkylsulphonyl, or alkoxycarbonyl having in each case 1 to 6 carbon atoms in the alkyl groups; or represents optionally cyano-, halogen-, or C₁-C₄-alkyl-substituted cycloalkyl having 3 to 6 carbon atoms,
R⁶ represents hydrogen; represents optionally cyano-, halogen-, C₁-C₄-alkoxy-, C₁-C₄-alkylthio-, C₁-C₄-alkylsulphinyl-, or C₁-C₄-alkylsulphonyl-substituted alkyl having 1 to 6 carbon atoms; represents optionally cyano- or halogen-substituted alkenyl or alkynyl having in each case 3 to 6 carbon atoms; represents optionally cyano-, halogen-, or C₁-C₄-alkyl-substituted cycloalkyl or cycloalkylalkyl having in each case 3 to 6 carbon atoms in the cycloalkyl group and optionally 1 to 4 carbon atoms in the alkyl moiety; or represents optionally nitro-, cyano-, halogen-, C₁-C₄-alkyl-, C₁-C₄-halogenoalkyl-, C₁-C₄-alkoxy-, C₁-C₄-halogeno-alkoxy-, C₁-C₄-alkylthio-, C₁-C₄-halogenoalkylthio-, C₁-C₄-alkyl-sulphinyl-, C₁-C₄-halogenoalkylsulphinyl-, C₁-C₄-alkylsulphonyl-, or C₁-C₄-halogenoalkylsulphonyl-substituted aryl or arylalkyl having in each case 6 or 10 carbon atoms in the aryl group and optionally 1 to 4 carbon atoms in the alkyl moiety,
R⁷ represents hydroxyl or formyloxy; represents optionally cyano-, halogen-, or C₁-C₄-alkoxy-substituted alkoxy, alkylcarbonyloxy, alkoxycarbonyloxy, alkylaminocarbonyloxy, or alkylsulphonyloxy having in each case 1 to 6 carbon atoms in the alkyl groups; represents optionally cyano- or halogen-substituted alkenyloxy or alkynyloxy having in each case 3 to 6 carbon atoms; or represents optionally nitro-, cyano-, halogen-, C₁-C₄-alkyl-, C₁-C₄-halogenoalkyl-, C₁-C₄-alkoxy-, C₁-C₄-halogenoalkoxy-, C₁-C₄-alkylthio-, C₁-C₄-halogenoalkylthio-, C₁-C₄-alkylsulphinyl-, C₁-C₄-halogenoalkylsulphinyl-, C₁-C₄-alkylsulphonyl, or C₁-C₄-halogenoalkylsulphonyl-substituted arylalkoxy, arylcarbonyloxy, arylcarbonylalkoxy, or arylsulphonyloxy having in each case 6 or 10 carbon atoms in the aryl group and optionally 1 to 4 carbon atoms in the alkyl moiety,
R¹⁰ represents hydrogen; represents optionally cyano-, halogen-, or C₁-C₄-alkoxy-substituted alkyl; or represents optionally cyano-, halogen-, or C₁-C₄-alkyl-substituted cycloalkyl having 3 to 6 carbon atoms,
R¹¹ represents hydrogen, cyano, carbamoyl, or halogen; or represents optionally cyano-, halogen-, or C₁-C₄-alkoxy-substituted alkyl, alkoxy, alkoxycarbonyl, alkylthio, alkylsulphinyl, or alkylsulphonyl having in each case 1 to 6 carbon atoms in the alkyl groups.

12. A composition according to claim 10 wherein, for the aryl ketone of the formula (I),
A¹ represents a single bond or O,
A² represents a single bond or represents methylene (—CH₂—), ethane-1,1-diyl (—CH(CH₃)—), ethane-1,2-diyl (—CH₂CH₂—), propane-1,1-diyl (—CH(C₂H₅)—), propane-1,2-diyl (—CH(CH₃)CH₂—), propane-1,3-diyl (—CH₂CH₂CH₂—), butane-1,3-diyl (—CH(CH₃)CH₂CH₂—), butane-1,4-diyl (—CH₂CH₂CH₂CH₂—), ethenediyl, propenediyl, butenediyl, ethynediyl, propynediyl, or butynediyl,
R¹ represents hydrogen; represents case optionally cyano-, fluorine-, chlorine-, bromine-, methoxy-, ethoxy-, n- or i-propoxy-, methylthio-, ethylthio-, n- or i-propylthio-, methylsulphinyl-, ethylsulphinyl-, n- or i-propylsulphinyl-, methyl-sulphonyl-, or ethylsulphonyl-substituted methyl, ethyl, n- or i-propyl, n-, i-, s-, or t-butyl, n-, i-, s-, or t-pentyl, methylthio, ethylthio, n- or i-propylthio, n-, i-, s-, or t-butylthio, methylsulphinyl, ethylsulphinyl, n- or i-propylsulphinyl, methyl-sulphonyl, or ethylsulphonyl; represents optionally fluorine-, chlorine-, and/or bromine-substituted ethenyl, propenyl, butenyl, pentenyl, ethynyl, propynyl, butynyl, or pentynyl; represents optionally cyano-, fluorine-, chlorine-, bromine-, methyl-, ethyl-, or propyl-substituted cyclopropyl, cyclobutyl, cyclopentyl, cyclohexyl, cyclopropylmethyl, cyclobutylmethyl, cyclopentylmethyl, or cyclohexylmethyl; represents optionally nitro-, cyano-, fluorine-, chlorine-, bromine-, methyl-, ethyl-, n- or i-propyl-, n-, i-, s-, or t-butyl-, trifluoromethyl-, methoxy-, ethoxy-, n- or i-propoxy-, difluoromethoxy-, or trifluoromethoxy-substituted phenyl, naphthyl, phenylmethyl, phenylethyl, naphthylmethyl, or naphthylethyl; or represents —C(O)—R² or —C(S)—R²,
R² represents hydrogen, amino, cyanoamino, nitroamino, hydroxyamino, or hydrazine; represents optionally cyano-, fluorine-, chlorine-, methoxy-, ethoxy-, n- or i-propoxy-, methylthio-, ethylthio-, n- or i-propylthio-, methylsulphinyl-, ethylsulphinyl-, n- or i-propylsulphinyl-, methylsulphonyl-, or ethyl-sulphonyl-substituted methyl, ethyl, n- or i-propyl, n-, i-, s-, or t-butyl, n-, i-, s-, or t-pentyl, methoxy, ethoxy, n- or i-propoxy, n-, i-, s-, or t-butoxy, methylthio, ethylthio, n- or i-propylthio, n-, i-, s-, or t-butylthio, methylamino, ethylamino, n- or i-propylamino, n-, i-, s-, or t-butylamino, methoxyamino, ethoxyamino, n- or i-propoxyamino, n-, i-, s-, or t-butoxyamino, methylhydrazino, ethylhydrazino, n- or i-propylhydrazino, or n-, i-, s-, or t-butylhydrazine; represents dimethylamino, diethylamino, N-methyl-methoxyamino, dimethylhydrazine, or diethyl-hydrazino; represents optionally fluorine, chlorine, and/or bromine-substituted ethenyl, propenyl, butenyl, pentenyl, ethynyl, propynyl, butynyl, pentynyl, propenyloxy, butenyloxy, pentenyloxy, propenylthio, butenylthio, pentenylthio, propenylamino, butenylamino, pentenylamino, propenyloxyamino, butenyloxyamino, pentenyloxyamino, ethynyl, propynyl, butynyl, pentynyl, propynyloxy, butynyloxy, pentynyloxy, propynylamino, butynylamino, or pentynylamino; represents optionally cyano-, fluorine-, chlorine-, bromine-, methyl-, ethyl-, or propyl-substituted cyclopropyl, cyclobutyl, cyclopentyl, cyclohexyl, cyclopropyloxy, cyclobutyloxy, cyclopentyloxy, cyclohexyloxy, cyclopropylamino, cyclobutylamino, cyclopentylamino, cyclohexylamino, cyclopropylmethyl, cyclobutylmethyl, cyclopentylmethyl, cyclohexylmethyl, cyclopropylmethoxy, cyclobutylmethoxy, cyclopentylmethoxy, cyclohexylmethoxy, cyclopropylmethylamino, cyclobuylmethylamino, cyclopentylmethylamino, or cyclohexylmethylamino; represents optionally nitro-, cyano-, fluorine-, chlorine-, bromine-, methyl-, ethyl-, n- or i-propyl, n-, i-, s-, or t-butyl-, trifluoromethyl-, methoxy-, ethoxy-, n- or i-propoxy-, difluoromethoxy-, trifluoromethoxy-, methoxycarbonyl-, ethoxycarbonyl-, n- or i-propoxycarbonyl-substituted phenyl, phenylcarbonyl, phenoxy, phenoxycarbonyl, phenylthio, phenylamino, phenylhydrazino, naphthyl, naphthyloxy, naphtylthio, naphthylamino, phenylmethyl, phenylethyl, phenylmethoxy, phenylethoxy, phenylmethylthio, phenylethylthio, phenylmethylamino, phenylethylamino, naphthylmethyl, naphthylethyl, naphthylmethoxy, naphthylethoxy, naphthylmethylamino, or naphthylethylamino; or represents optionally nitro-, cyano-, fluorine-, chlorine-, bromine-, methyl-, ethyl-, n- or i-propyl-, n-, i-, s-, or t-butyl-, difluoromethyl-, trifluoromethyl-, dichloromethyl-, trichloromethyl-, chlorodifluoromethyl-, fluorodichloromethyl-, methoxy-, ethoxy-, n- or i-propoxy-, n-, i-, s-, or t-butoxy-, difluoromethoxy-, trifluoromethoxy-, methylthio-, ethylthio-, n- or i-propylthio-, n-, i-, s-, or t-butylthio-, difluoromethylthio-, trifluoromethylthio-, methoxycarbonyl-, ethoxycarbonyl-, n- or i-propoxycarbonyl-, cyclopropyl-, cyclobutyl-, cyclopentyl-, cyclohexyl-, cyclopropylmethyl-, cyclobutylmethyl-, cyclopentylmethyl-, or cyclohexylmethyl-substituted monocyclic or bicyclic heterocyclyl, heterocyclyloxy, heterocyclylamino, heterocyclylalkyl, heterocyclylalkoxy, or heterocyclylalkylamino selected from the group consisting of furyl, tetrahydrofuryl, furyloxy, tetrahydrofuryloxy, furylamino, tetrahydrofurylamino, furylmethyl, tetrahydrofurylmethyl, furylmethoxy, tetrahydrofurylmethoxy, furylmethylamino, tetrahydrofurylmethylamino, thienyl, thienylmethyl, pyrrolidinyl, pyrrolidinylamino, oxopyrrolidinyl, pyrrolyl, indolyl, pyrrolylmethyl, pyrazolyl, pyrazolyloxy, pyrazolylamino, pyrazolylmethyl, imidazolyl, imidazolylmethyl, 2-oxo-1,3-diaza-cyclopentyl, oxazolyl, dihydrooxazolyl (oxazolinyl), isoxazolyl, dihydroisoxazolyl (isoxazolinyl), tetrahydroisoxazolyl (isoxazolidinyl), oxazolylmethyl, thiazolyl, dihydrothiazolyl (thiazolinyl), tetrahydrothiazolyl (thiazolidinyl), thiazolylmethyl, thiazolidinyl, oxothiazolidinyl, cyanoiminothiazolidinyl, oxotriazolinyl, oxotetrazolinyl, piperidinyl, piperidinylamino, oxopiperidinyl, 2-oxo-1,3-diaza-cyclohexyl, 2-oxo-1-aza-cycloheptyl, 2-oxo-1,3-diaza-cycloheptyl, morpholinyl, morpholinylamino, piperazinyl, pyridinyl, pyridinyloxy, pyridinylamino, pyridinylmethyl, pyridinylmethoxy, pyrimidinyl, pyrimidinyloxy, pyrimidinylmethyl, and pyrimidinylmethoxy,
X represents hydrogen, nitro, cyano, carboxyl, carbamoyl, thiocarbamoyl, fluorine, chlorine, bromine, or iodine; or represents optionally cyano-, fluorine-, chlorine-, methoxy-, ethoxy-, methylthio-, ethylthio-, methylsulphinyl-, ethylsulphinyl-, methylsulphonyl-, or ethylsulphonyl-substituted methyl, ethyl, n- or i-propyl, n-, i-, s-, or t-butyl, methoxy, ethoxy, n- or i-propoxy, n-, i-, s-, or t-butoxy, methylthio, ethylthio, n- or i-propylthio, n-, i-, s-, or t-butylthio, methylsulphinyl, ethylsulphinyl, n- or i-propylsulphinyl, methylsulphonyl, ethylsulphonyl, n- or i-propylsulphonyl, methylamino, ethylamino, n- or i-propylamino, n-, i-, s-, or t-butylamino, dimethylamino, diethylamino, dimethylaminosulphonyl, or diethylaminosulphonyl,
Y represents hydrogen, nitro, cyano, carboxyl, carbamoyl, thiocarbamoyl, fluorine, chlorine, bromine, or iodine; or represents optionally cyano-, fluorine-, chlorine-, methoxy-, ethoxy-, methylthio-, ethylthio-, methylsulphinyl-, ethylsulphinyl-, methylsulphonyl-, or ethylsulphonyl-substituted methyl, ethyl, n- or i-propyl, n-, i-, s-, or t-butyl, methoxy, ethoxy, n- or i-propoxy, n-, i-, s-, or t-butoxy, methylthio, ethylthio, n- or i-propylthio, n-, i-, s-, or t-butylthio, methylsulphinyl, ethylsulphinyl, n- or i-propylsulphinyl, methylsulphonyl, ethylsulphonyl, n- or i-propylsulphonyl, methylamino, ethylamino, n- or i-propylamino, n-, i-, s-, or t-butylamino, dimethylamino, diethylamino, dimethylaminosulphonyl, or diethylaminosulphonyl,
Z represents one of the groups 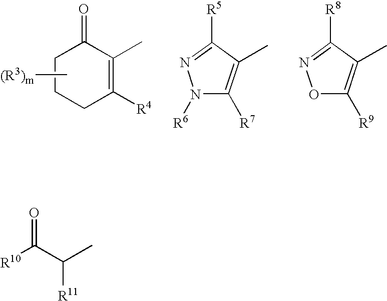
in which
m represents the numbers 0, 1, or 2,
R³ represents hydrogen, fluorine, chlorine, or bromine; represents in optionally cyano-, fluorine-, chlorine-, methoxy-, ethoxy-, n- or i-propoxy-, methylthio-, ethylthio-, n- or i-propylthio-, methylsulphinyl-, ethylsulphinyl-, methylsulphonyl-, or ethylsulphonyl-substituted methyl, ethyl, n- or i-propyl, n-, i-, s-, or t-butyl, methylthio, ethylthio, n- or i-propylthio, n-, i-, s-, or t-butylthio; represents phenyl; or when m represents 2, optionally together with a second radical R³ represents oxygen, propane-1,3-diyl, or butane-1,4-diyl,
R⁴ represents hydroxyl, formyloxy, fluorine, or chlorine; represents optionally cyano-, fluorine-, chlorine-, methoxy-, ethoxy-, n- or i-propoxy-, methylthio-, ethylthio-, n- or i-propylthio-, methylsulphinyl-, ethylsulphinyl-, methylsulphonyl-, or ethylsulphonyl-substituted methoxy, ethoxy, n- or i-propoxy, methylthio, ethylthio, n- or i-propylthio, methylsulphinyl, ethylsulphinyl, methylsulphonyl, ethylsulphonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulphonyloxy, ethylsulphonyloxy, or n- or i-propylsulphonyloxy; represents optionally fluorine-, chlorine-, and/or bromine-substituted propenyloxy, butenyloxy, propynyloxy, or butynyloxy; represents optionally nitro-, cyano-, fluorine-, chlorine-, bromine-, methyl-, ethyl-, n- or i-propyl-, n-, i-, s-, or t-butyl-, trifluoromethyl-, methoxy-, ethoxy-, n- or i-propoxy-, difluoromethoxy-, trifluoromethoxy-, methylthio-, ethylthio-, n- or i-propylthio-, difluoromethylthio-, trifluoromethylthio-, methylsulphinyl-, ethylsulphinyl-, trifluoromethylsulphinyl-, methylsulphonyl-, ethylsulphonyl-, or trifluoromethylsulphonyl-substituted phenyloxy, phenylthio, phenylsulphinyl, phenylsulphonyl, phenylcarbonyloxy, phenylcarbonylalkoxy, phenylsulphonyloxy, phenylmethoxy, phenylmethylthio, phenylmethylsulphinyl, or phenylmethylsulphonyl,
R⁵ represents hydrogen, cyano, carbamoyl, thiocarbamoyl, fluorine, chlorine, or bromine; represents optionally cyano-, fluorine-, chlorine-, methoxy-, ethoxy-, n- or i-propoxy-, methylthio-, ethylthio-, n- or i-propylthio-, methylsulphinyl-, ethylsulphinyl-, methylsulphonyl-, or ethylsulphonyl-substituted methyl, ethyl, n- or i-propyl, n-, i-, s-, or t-butyl, methoxy, ethoxy, n- or i-propoxy, methylthio, ethylthio, n- or i-propylthio, methylsulphinyl, ethylsulphinyl, methylsulphonyl, ethylsulphonyl, methoxycarbonyl, ethoxycarbonyl, or n- or i-propoxycarbonyl; or represents optionally cyano-, fluorine-, chlorine-, methyl-, or ethylsubstituted cyclopropyl, cyclobutyl, cyclopentyl, or cyclohexyl,
R⁶ represents hydrogen; represents optionally cyano-, fluorine-, chlorine-, methoxy-, ethoxy-, n- or i-propoxy-, methylthio-, ethylthio-, n- or i-propylthio-, methylsulphinyl-, ethylsulphinyl-, methylsulphonyl-, or ethylsulphonyl-substituted methyl, ethyl, n- or i-propyl, n-, i-, s-, or t-butyl; represents optionally cyano-, fluorine-, chlorine-, or bromine-substituted propenyl, butenyl, propynyl, or butynyl; represents optionally cyano-, fluorine-, chlorine-, methyl-, or ethyl-substituted cyclopropyl, cyclobutyl, cyclopentyl, cyclohexyl, cyclopropylmethyl, cyclobutylmethyl, cyclopentylmethyl, or cyclohexylmethyl; or represents optionally nitro-, cyano-, fluorine-, chlorine-, bromine-, methyl-, ethyl-, n- or i-propyl-, n-, i-, s-, or t-butyl-, trifluoromethyl-, methoxy-, ethoxy-, n- or i-propoxy-, difluoromethoxy-, trifluoromethoxy-, methylthio-, ethylthio-, n- or i-propylthio-, n-, i-, s-, or t-butylthiomethylthio-, ethylthio-, n- or i-propylthio-, difluoromethylthio-, trifluoromethylthio-, methylsulphinyl-, ethylsulphinyl-, trifluoromethylsulphinyl-, methylsulphonyl-, ethylsulphonyl-, or trifluoromethylsulphonyl-substituted phenyl or phenylmethyl,
R⁷ represents hydroxyl or formyloxy; represents optionally cyano-, fluorine-, chlorine-, methoxy-, ethoxy, or n- or i-propoxy-substituted methoxy, ethoxy, n- or i-propoxy, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulphonyloxy, ethylsulphonyloxy, or n- or i-propylsulphonyloxy; represents optionally cyano-, fluorine-, chlorine-, or bromine-substituted propenyloxy, butenyloxy, propynyloxy, or butynyloxy; or represents optionally nitro-, cyano-, fluorine-, chlorine-, bromine-, methyl-, ethyl-, n- or i-propyl-, n-, i-, s-, or t-butyl-, trifluoromethyl-, methoxy-, ethoxy-, n- or i-propoxy-, difluoromethoxy-, trifluoromethoxy-, methylthio-, ethylthio-, n- or i-propylthio-, difluoromethylthio-, trifluoromethylthio-, methylsulphinyl-, ethylsulphinyl-, trifluoromethylsulphinyl-, methylsulphonyl-, ethylsulphonyl-, or trifluoromethylsulphonyl-substituted phenylmethoxy, phenylcarbonyloxy, phenylcarbonylmethoxy, or phenylsulphonyloxy,
R⁸ represents hydrogen, cyano, carbamoyl, thiocarbamoyl, fluorine, chlorine, or bromine; or represents optionally cyano-, fluorine-, chlorine-, methoxy-, ethoxy-, or n- or i-propoxy-substituted methyl, ethyl, n- or i-propyl, n-, i-, s-, or t-butyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulphinyl, ethylsulphinyl, methylsulphonyl, or ethylsulphonyl,
R⁹ represents hydrogen; represents optionally cyano-, fluorine-, chlorine-, methoxy-, ethoxy-, or n- or i-propoxy-substituted methyl, ethyl, n- or i-propyl, or n-, i-, s-, or t-butyl; or represents optionally cyano-, fluorine-, chlorine-, methyl-, or ethyl-substituted cyclopropyl, cyclobutyl, cyclopentyl, or cyclohexyl,
R¹⁰ represents hydrogen; represents optionally cyano-, fluorine-, chlorine-, methoxy-, ethoxy-, or n- or i-propoxy-substituted methyl, ethyl, n- or i-propyl, or n-, i-, s-, or t-butyl; or represents optionally cyano-, fluorine-, chlorine-, methyl-, or ethyl-substituted cyclopropyl, cyclobutyl, cyclopentyl, or cyclohexyl, and
R¹¹ represents hydrogen, cyano, carbamoyl, fluorine, chlorine, or bromine;
or represents optionally cyano-, fluorine-, chlorine-, methoxy-, ethoxy-, or n- or i-propoxy-substituted methyl, ethyl, n- or i-propyl, n-, i-, s-, or t-butyl, methoxy, ethoxy, n- or i-propoxy, methoxycarbonyl, ethoxycarbonyl, n- or i-propoxycarbonyl, methylthio, ethylthio, n- or i-propylthio, methylsulphinyl, ethylsulphinyl, methylsulphonyl, or ethylsulphonyl.

13. A composition according to claim 10 wherein, for the aryl ketone of the formula (I),
A² represents a single bond or represents methylene (—CH₂—) or ethane-1,2-diyl (dimethylene, —CH₂CH₂—),
R¹ represents hydrogen; represents optionally cyano-, fluorine-, chlorine-, methoxy-, ethoxy-, methylthio-, ethylthio-, methylsulphinyl-, ethylsulphinyl-, methylsulphonyl-, or ethylsulphonyl-substituted methyl, ethyl, n- or i-propyl, n- or i-butyl, methylthio, ethylthio, or n- or i-propylthio; represents optionally fluorine- and/or chlorine-substituted propenyl, butenyl, ethynyl, propynyl, or butynyl; represents optionally cyano-, fluorine-, chlorine-, or methyl-substituted cyclopropyl, cyclobutyl, cyclopentyl, cyclohexyl, cyclopropylmethyl, cyclobutylmethyl, cyclopentylmethyl, or cyclohexylmethyl; represents optionally nitro-, cyano-, fluorine-, chlorine-, bromine-, methyl-, ethyl-, n- or i-propyl, n-, i-, s-, or t-butyl-, trifluoromethyl-, methoxy-, ethoxy-, n- or i-propoxy-, difluoromethoxy-, or trifluoromethoxy-substituted phenyl, phenylmethyl, or phenylethyl; or represents —C(O)—R² or —C(S)—R²,
R² represents hydrogen, amino, hydroxyamino, or hydrazine; represents optionally cyano-, fluorine-, chlorine-, methoxy-, ethoxy-, n- or i-propoxy-, methylthio-, ethylthio-, n- or i-propylthio-, methylsulphinyl-, ethylsulphinyl-, methylsulphonyl-, or ethylsulphonyl-substituted methyl, ethyl, n- or i-propyl, n-, i-, s-, or t-butyl, methoxy, ethoxy, n- or i-propoxy, methylthio, ethylthio, n- or i-propylthio, methylamino, ethylamino, n- or i-propylamino, methoxyamino, ethoxyamino, or n- or i-propoxyamino; represents dimethylamino; represents N-methyl-methoxyamino; represents dimethylhydrazine; represents optionally fluorine-, and/or chlorine-substituted ethenyl, propenyl, butenyl, propenyloxy, butenyloxy, propenylthio, butenylthio, propenylamino, butenylamino, ethynyl, propynyl, butynyl, propynyloxy, butynyloxy, propynylamino, or butynylamino; represents optionally cyano-, fluorine-, chlorine-, or methyl-substituted cyclopropyl, cyclobutyl, cyclopentyl, cyclohexyl, cyclopropylmethyl, cyclobutylmethyl, cyclopentylmethyl, or cyclohexylmethyl; represents optionally nitro-, cyano-, fluorine-, chlorine-, bromine-, methyl-, ethyl-, n- or i-propyl-, n-, i-, s-, or t-butyl, trifluoromethyl-, methoxy-, ethoxy-, n- or i-propoxy-, difluoromethoxy-, trifluoromethoxy-, methoxycarbonyl-, ethoxycarbonyl-, or n- or i-propoxycarbonyl-substituted phenyl, phenylamino, phenylmethyl, or phenylethyl; or represents optionally nitro-, cyano-, fluorine-, chlorine-, bromine-, methyl-, ethyl-, n- or i-propyl-, n-, i-, s-, or t-butyl-, difluoromethyl-, trifluoromethyl-, dichloromethyl-, trichloromethyl-, chlorodifluoromethyl-, fluorodichloromethyl-, methoxy-, ethoxy-, n- or i-propoxy-, difluoromethoxy-, trifluoromethoxy-, methylthio-, ethylthio-, n- or i-propylthio-, difluoromethylthio-, trifluoromethylthio-, methoxycarbonyl-, ethoxycarbonyl-, n- or i-propoxycarbonyl-, cyclopropyl-, cyclobutyl-, cyclopentyl-, cyclohexyl-, cyclopropylmethyl-, cyclobutylmethyl-, cyclopentylmethyl-, or cyclohexylmethyl-substituted monocyclic or bicyclic heterocyclyl or heterocyclylalkyl selected from the group consisting of furyl, tetrahydrofuryl, furyloxy, tetrahydrofuryloxy, furylamino, tetrahydrofurylamino, furylmethyl, tetrahydrofurylmethyl, furylmethoxy, tetrahydrofurylmethoxy, furylmethylamino, tetrahydrofurylmethylamino, thienyl, thienylmethyl, pyrrolidinyl, pyrrolidinylamino, oxopyrrolidinyl, pyrrolyl, indolyl, pyrrolylmethyl, pyrazolyl, pyrazolyloxy, pyrazolylamino, pyrazolylmethyl, imidazolyl, imidazolylmethyl, 2-oxo-1,3-diaza-cyclopentyl, oxazolyl, dihydrooxazolyl (oxazolinyl), isoxazolyl, dihydroisoxazolyl (isoxazolinyl), tetrahydroisoxazolyl (isoxazolidinyl), oxazolylmethyl, thiazolyl, dihydrothiazolyl (thiazolinyl), tetrahydrothiazolyl (thiazolidinyl), thiazolylmethyl, thiazolidinyl, oxothiazolidinyl, cyanoiminothiazolidinyl, oxotriazolinyl, oxotetrazolinyl, piperidinyl, piperidinylamino, oxopiperidinyl, 2-oxo-1,3-diazacyclohexyl, 2-oxo-1-aza-cycloheptyl, 2-oxo-1,3-diaza-cycloheptyl, morpholinyl, morpholinylamino, piperazinyl, pyridinyl, pyridinyloxy, pyridinylamino, pyridinylmethyl, pyridinylmethoxy, pyrimidinyl, pyrimidinyloxy, pyrimidinylmethyl, and pyrimidinylmethoxy,
X represents hydrogen, nitro, cyano, fluorine, chlorine, bromine, iodine, methyl, ethyl, n- or i-propyl, difluoromethyl, trifluoromethyl, dichloromethyl, trichloromethyl, methoxymethyl, methylthiomethyl, methylsulphinylmethyl, methylsulphonylmethyl, methoxy, ethoxy, difluoromethoxy, trifluoromethoxy, methylthio, ethylthio, methylsulphinyl, ethylsulphinyl, methylsulphonyl, ethylsulphonyl, or dimethylaminosulphonyl,
Y represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulphinylmethyl, methylsulphonylmethyl, methoxy, ethoxy, difluoromethoxy, trifluoromethoxy, methylthio, ethylthio, methylsulphinyl, ethylsulphinyl, methylsulphonyl, ethylsulphonyl, or dimethylaminosulphonyl, and
Z represents one of the groups 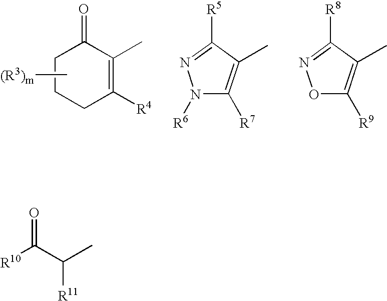
in which
m represents the numbers 0 or 1,
R³ represents hydrogen; represents optionally fluorine- and/or chlorine-substituted methyl, ethyl, n- or i-propyl, methylthio, ethylthio, or n- or i-propylthio; represents phenyl; or when m represents 2, optionally together with a second radical R³ represents oxygen, propane-1,3-diyl, or butane-1,4-diyl,
R⁴ represents hydroxyl; represents formyloxy; represents optionally fluorine- and/or chlorine-substituted methoxy, ethoxy, n- or i-propoxy, methylthio, ethylthio, n- or i-propylthio, methylsulphinyl, ethylsulphinyl, methylsulphonyl, ethylsulphonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulphonyloxy, ethylsulphonyloxy, or n- or i-propylsulphonyloxy; represents optionally fluorine- and/or chlorine-substituted propenyloxy, butenyloxy, propynyloxy, or butynyloxy; represents optionally nitro-, cyano-, fluorine-, chlorine-, bromine-, methyl-, ethyl-, n- or i-propyl-, trifluoromethyl-, methoxy-, ethoxy-, n- or i-propoxy-, difluoromethoxy-, or trifluoromethoxy-substituted phenyloxy, phenylthio, phenylsulphinyl, phenylsulphonyl, phenylcarbonyloxy, phenylcarbonylmethoxy, phenylsulphonyloxy, phenylmethoxy, phenylmethylthio, phenylmethylsulphinyl, or phenylmethylsulphonyl,
R⁵ represents hydrogen, cyano, fluorine, or chlorine; represents optionally fluorine- and/or chlorine-substituted methyl, ethyl, n- or i-propyl, methoxy, ethoxy, n- or i-propoxy, methylthio, ethylthio, n- or i-propylthio, methylsulphinyl, ethylsulphinyl, methylsulphonyl, ethylsulphonyl, methoxycarbonyl, ethoxycarbonyl, or n- or i-propoxycarbonyl; or represents optionally cyano-, fluorine-, chlorine-, or methyl-substituted cyclopropyl,
R⁶ represents hydrogen; represents optionally cyano-, fluorine-, chlorine-, methoxy-, or ethoxy-substituted methyl, ethyl, n- or i-propyl, or n-, i-, s-, or t-butyl; represents optionally fluorine- or chlorine-substituted propenyl, butenyl, propynyl, or butynyl; represents optionally fluorine-, chlorine-, or methyl-substituted cyclopropyl, cyclobutyl, cyclopentyl, or cyclohexyl; or represents optionally fluorine-, chlorine-, bromine-, methyl-, ethyl-, n- or i-propyl-, trifluoromethyl-, methoxy-, ethoxy-, n- or i-propoxy-, difluoromethoxy-, or trifluoromethoxy-substituted phenyl or phenylmethyl,
R⁷ represents hydroxyl; represents formyloxy; represents optionally cyano-, fluorine-, chlorine-, methoxy-, ethoxy-, or n- or i-propoxy-substituted methoxy, ethoxy, n- or i-propoxy, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulphonyloxy, ethylsulphonyloxy, or n- or i-propylsulphonyloxy; represents optionally fluorine- and/or chlorine-substituted propenyloxy, butenyloxy, propynyloxy, or butynyloxy; or represents optionally nitro-, cyano-, fluorine-, chlorine-, bromine-, methyl-, ethyl-, n- or i-propyl-, trifluoromethyl-, methoxy-, ethoxy-, n- or i-propoxy-, difluoromethoxy-, or trifluoromethoxy-substituted phenylmethoxy, phenylcarbonyloxy, phenylcarbonylmethoxy, or phenylsulphonyloxy,
R⁸ represents hydrogen, cyano, fluorine, chlorine, or bromine; or represents optionally fluorine-, chlorine-, methoxy-, or ethoxy-substituted methyl, ethyl, n- or i-propyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulphinyl, ethylsulphinyl, methylsulphonyl, or ethylsulphonyl,
R⁹ represents hydrogen; represents optionally fluorine-, chlorine-, methoxy-, or ethoxy-substituted methyl, ethyl, or n- or i-propyl; or represents optionally fluorine-, chlorine-, or methyl-substituted cyclopropyl,
R¹⁰ represents hydrogen; represents optionally fluorine-, chlorine-, methoxy-, or ethoxy-substituted methyl, ethyl, or n- or i-propyl; or represents optionally fluorine-, chlorine-, or methyl-substituted cyclopropyl, and
R¹¹ represents hydrogen, cyano, fluorine, chlorine, or bromine; or represents optionally fluorine-, chlorine-, methoxy-, or ethoxy-substituted methyl, ethyl, n- or i-propyl, methoxy, ethoxy, n- or i-propoxy, methoxycarbonyl, ethoxycarbonyl, n- or i-propoxycarbonyl, methylthio, ethylthio, n- or i-propylthio, methylsulphinyl, ethylsulphinyl, methylsulphonyl, or ethylsulphonyl.

14. A composition according to claim 10 wherein, for the aryl ketone of the formula (I),
-A¹-A² represents —O—CH₂—CH₂—, —CH₂— or a single bond,
R¹ represents H, and
R² represents N-methyl-methoxyamino.

15. A composition according to claim 10 wherein component (b) comprises at least one of the active compounds acetochlor, alachlor, amicarbazone, amidosulfuron, anilofos, atrazine, azimsulfuron, benfuresate, bensulfuron-methyl, bentazone, benthiocarb (thiobencarb), benzobicyclon, benzofenap, bifenox, bispyribac-sodium, bromobutide, butachlor, butamifos, butenachlor, cafenstrole, carfentrazone-ethyl, chlomethoxyfen, chlornitrofen, cinmethylin, cinosulfuron, clefoxydim, clodinafop-propargyl, clomazone, clomeprop, cumyluron, cyanazine, cyclosulfamuron, cyhalofop-butyl, 2,4-D, dichlorprop-P, diethatyl-ethyl, dimepiperate, dimethametryn, dimethenamid, S-dimethenamid, dithiopyr, dymron (daimuron, dimuron), esprocarb, ethoxysulfuron, etobenzanid, fenoxaprop-(P)-ethyl, fentrazamide, fluazifop-P-butyl, flucarbazone-sodium, flufenacet, flumetsulam, halosulfuron-methyl, haloxyfop-P-methyl, HOK-201, imazamox, imazaquin, imazethapyr, imazosulfuron, indanofan, isoxaflutole, MCPA, mefenacet, mesosulfuron, mesotrione, metolachlor, S-metolachlor, metosulam, metsulfuron-methyl, metribuzin, molinate, naproanilide, nicosulfuron, OK-701, oxadiargyl, oxadiazon, oxaziclomefone, oxyfluorfen, pendimethalin, pentoxazone, piperophos, pretilachlor, profoxydim, propanil, propoxycarbazone-sodium, pyraclonil, pyrazolate, pyrazosulfuron-ethyl, pyrazoxyfen, pyribenzoxim, pyributicarb, pyriftalid, pyriminobac-methyl, qinclorac, quinoclamine, simazin, simetryn, sulcotrione, terbuthylazine, thenylchlor, thifensulfuron-methyl, tiocarbazil, or tritosulfuron.

16. A method for controlling weeds comprising allowing an effective amount of a composition according to claim 10 to act on one or more undesirable plants and/or their habitat.

17. A process for preparing a herbicidal composition comprising mixing a composition according to claim 10 with one or more surfactants and/or extenders.
